(19) United States
(12) Patent Application Publication
(10) Pub. No.: US 2026/0120390 A1
(43) Pub. Date: Apr. 30, 2026

(54) SERVER DEVICE

(71) Applicant: Preferred Networks, Inc., Tokyo (JP)

(72) Inventors: Eiichi MATSUMOTO, Tokyo (JP); Sosuke KOBAYASHI, Tokyo (JP); Toru MATSUOKA, Tokyo (JP); Hiroharu KATO, Tokyo (JP); Tsukasa TAKAGI, Tokyo (JP)

(21) Appl. No.: 19/414,857

(22) Filed: Dec. 10, 2025

Related U.S. Application Data
(63) Continuation of application No. PCT/JP2024/020293, filed on Jun. 4, 2024.

(30) Foreign Application Priority Data
Jun. 13, 2023 (JP) 2023-097349

(51) Int. Cl. G06T 15/10; G06T 13/20

(52) U.S. Cl. CPC G06T 15/10; G06T 13/20

(57) ABSTRACT

A server device includes one or more memories and processors. The one or more memories hold one or more reconstruction models for generating a time series of free-viewpoint images, having been trained in advance to reconstruct a scene by using a time series of captured images from a plurality of viewpoints, obtained by capturing the scene from each of the plurality of viewpoints continuously in time. The one or more processors receive a request including viewpoint and time information for the scene from a dedicated application or a browser; generate, by using the one or more reconstruction models, the time series of free-viewpoint images corresponding to the viewpoint and time information included in the received request; and transmit, to the dedicated application or the browser having transmitted the request, the generated time series of free-viewpoint images in a video format that is supported by the dedicated application or the browser.

### CROSS-REFERENCE TO RELATED APPLICATIONS

This application is a continuation application of International Application No.

PCT/JP2024/020293 filed on Jun. 4, 2024, and designating the U.S., which is based upon and claims priority to Japanese Application No. 2023-097349 filed on Jun. 13, 2023, the entire contents of which are incorporated herein by reference.

### BACKGROUND

### 1. Technical Field

The present disclosure relates to a server device.

### 2. Description of the Related Art

A technique called Neural Radiance Fields (NeRF) is known as an image generation technique for reconstructing a three-dimensional scene by using two-dimensional captured images obtained by capturing the three-dimensional scene from different viewpoints, using a plurality of imaging devices. According to the technique, a free-viewpoint image can be generated for a three-dimensional scene.

With respect to the above, currently, a free-viewpoint image generated by using the technology is a still image, and in order to apply the technology to a moving image to render a free-viewpoint moving image, a mechanism for a moving image is required.

### Related Art Document

### Non-Patent Document

Non-Patent Document 1: Ben Mildenhall, Pratul P. Srinivasan, Matthew Tancik, Jonathan T. Barron, Ravi Ramamoorthi, Ren Ng, “NeRF: Representing Scenes as Neural Radiance Fields for View Synthesis,” [online], [searched on Mar. 31, 2023]

### SUMMARY

According to one embodiment of the present disclosure, a server device includes one or more memories; and one or more processors. The one or more memories are configured to hold one or more reconstruction models for generating a time series of free-viewpoint images, the one or more reconstruction models having been trained in advance to reconstruct a scene from a first time to a second time by using a time series of captured images from a plurality of viewpoints, and the time series of captured images from the plurality of viewpoints being obtained by capturing the scene from each of the plurality of viewpoints continuously in time. The one or more processors are configured to receive a request including viewpoint information and time information for the scene from a dedicated application or a browser; generate, by using the one or more reconstruction models, the time series of free-viewpoint images corresponding to the viewpoint information and the time information included in the received request; and transmit, to the dedicated application or the browser having transmitted the request, the generated time series of free-viewpoint images in a video format that is supported by the dedicated application or the browser.

### BRIEF DESCRIPTION OF THE DRAWINGS

FIG. 1 is a first diagram for explaining an outline of a training process of a reconstruction model;

FIG. 2 is a first diagram for explaining an outline of an image generation process by a trained reconstruction model;

FIG. 3 is a first diagram illustrating an example of trained reconstruction models applied to a server device;

FIG. 4 is a first diagram illustrating an example of a system configuration of a free-viewpoint moving image rendering system;

FIG. 5 is a diagram illustrating an example of a hardware configuration of the server device and a client terminal;

FIG. 6 is a first diagram illustrating an example of a functional configuration of the server device;

FIG. 7 is a diagram illustrating an example of trained reconstruction models held in a model storage unit of a server device according to a first embodiment;

FIG. 8A is a first diagram illustrating a specific example of a process performed by the server device according to the first embodiment;

FIG. 8B is a second diagram illustrating a specific example of the process performed by the server device according to the first embodiment;

FIG. 8C is a third diagram illustrating a specific example of the process performed by the server device according to the first embodiment;

FIG. 8D is a fourth diagram illustrating a specific example of the process performed by the server device according to the first embodiment;

FIG. 9 is a first diagram illustrating an example of a functional configuration of the client terminal;

FIG. 10 is a diagram illustrating an example of a moving image designation screen of the client terminal;

FIGS. 11A and 11B are first diagrams illustrating an example of a moving image playback screen of the client terminal;

FIGS. 12A and 12B are second diagrams illustrating an example of the moving image playback screen of the client terminal;

FIGS. 13A and 13B are third diagrams illustrating an example of the moving image playback screen of the client terminal;

FIG. 14 is a first sequence diagram illustrating a flow of a free-viewpoint moving image rendering process by the free-viewpoint moving image rendering system;

FIG. 15 is a second diagram for explaining an outline of a training process of a reconstruction model;

FIG. 16 is a second diagram for explaining an outline of an image generation process by the trained reconstruction model;

FIG. 17 is a second diagram illustrating an example of trained reconstruction models applied to the server device;

FIG. 18 is a diagram illustrating an example of the trained reconstruction models held in a model storage unit of a server device according to a second embodiment;

FIG. 19A is a first diagram illustrating a specific example of a process performed by the server device according to the second embodiment;

FIG. 19B is a second diagram illustrating a specific example of the process performed by the server device according to the second embodiment;

FIG. 20 is a third diagram for explaining an outline of a training process of a reconstruction model;

FIG. 21 is a third diagram for explaining an outline of an image generation process by the trained reconstruction model;

FIG. 22 is a third diagram illustrating an example of a trained reconstruction model applied to the server device;

FIG. 23 is a diagram illustrating an example of the trained reconstruction model held in a model storage unit of a server device according to a third embodiment;

FIG. 24A is a first diagram illustrating a specific example of a process performed by the server device according to the third embodiment;

FIG. 24B is a second diagram illustrating a specific example of the process performed by the server device according to the third embodiment;

FIG. 25 is a fourth diagram for explaining an outline of a training process of a reconstruction model;

FIG. 26 is a fourth diagram for explaining an outline of an image generation process by the trained reconstruction model;

FIG. 27 is a fourth diagram illustrating an example of trained reconstruction models applied to the server device;

FIG. 28 is a diagram illustrating an example of the trained reconstruction models held in a model storage unit of a server device according to a fourth embodiment;

FIG. 29A is a first diagram illustrating a specific example of a process performed by the server device according to the fourth embodiment;

FIG. 29B is a second diagram illustrating a specific example of the process performed by the server device according to the fourth embodiment;

FIG. 30 is a fifth diagram for explaining an outline of a training process of a reconstruction model;

FIG. 31 is a fifth diagram for explaining an outline of an image generation process by the trained reconstruction model;

FIG. 32 is a fifth diagram illustrating an example of trained reconstruction models applied to the server device;

FIG. 33 is a diagram illustrating the trained reconstruction models held in a model storage unit of a server device according to a fifth embodiment;

FIG. 34A is a first diagram illustrating a specific example of a process performed by the server device according to the fifth embodiment;

FIG. 34B is a second diagram illustrating a specific example of the process performed by the server device according to the fifth embodiment;

FIG. 35 is a second sequence diagram illustrating a flow of a free-viewpoint moving image rendering process by a free-viewpoint moving image rendering system;

FIG. 36 is a second diagram illustrating an example of a system configuration of the free-viewpoint moving image rendering system;

FIG. 37 is a second diagram illustrating an example of a functional configuration of the server device;

FIG. 38 is a diagram illustrating trained reconstruction models held in a model storage unit of a server device according to a sixth embodiment;

FIG. 39A is a first diagram illustrating a specific example of a process performed by the server device according to the sixth embodiment;

FIG. 39B is a second diagram illustrating a specific example of the process performed by the server device according to the sixth embodiment;

FIG. 39C is a third diagram illustrating a specific example of the process performed by the server device according to the sixth embodiment;

FIG. 40 is a second diagram illustrating an example of a functional configuration of the client terminal;

FIG. 41 is a third sequence diagram illustrating a flow of a free-viewpoint moving image rendering process by a free-viewpoint moving image rendering system;

FIG. 42 is a diagram illustrating trained reconstruction models held in a model storage unit of a server device according to a seventh embodiment;

FIG. 43A is a first diagram illustrating a specific example of a process performed by the server device according to the seventh embodiment;

FIG. 43B is a second diagram illustrating a specific example of the process performed by the server device according to the seventh embodiment;

FIG. 44 is a fourth sequence diagram illustrating a flow of a free-viewpoint moving image rendering process by a free-viewpoint moving image rendering system;

FIG. 45 is a diagram illustrating a trained reconstruction model held in a model storage unit of a server device according to an eighth embodiment;

FIG. 46A is a first diagram illustrating a specific example of a process performed by the server device according to the eighth embodiment;

FIG. 46B is a second diagram illustrating a specific example of the process performed by the server device according to the eighth embodiment;

FIG. 47 is a fifth sequence diagram illustrating a flow of a free-viewpoint moving image rendering process by a free-viewpoint moving image rendering system;

FIG. 48 is a diagram illustrating trained reconstruction models held in a model storage unit of a server device according to a ninth embodiment;

FIG. 49A is a first diagram illustrating a specific example of a process performed by the server device according to the ninth embodiment;

FIG. 49B is a second diagram illustrating a specific example of the process performed by the server device according to the ninth embodiment;

FIG. 50 is a sixth sequence diagram illustrating a flow of a free-viewpoint moving image rendering process by a free-viewpoint moving image rendering system;

FIG. 51 is a third diagram illustrating an example of a functional configuration of the server device;

FIG. 52 is a third diagram illustrating an example of a functional configuration of the client terminal;

FIG. 53 is a diagram illustrating trained reconstruction models held in a model storage unit of a server device according to a tenth embodiment;

FIG. 54A is a first diagram illustrating a specific example of a process performed by the server device according to the tenth embodiment;

FIG. 54B is a second diagram illustrating a specific example of the process performed by the server device according to the tenth embodiment; and

FIG. 55 is a seventh sequence diagram illustrating a flow of a free-viewpoint moving image rendering process by a free-viewpoint moving image rendering system.

### DETAILED DESCRIPTION

Hereinafter, embodiments will be described with reference to the accompanying drawings. In the present specification and the accompanying drawings, components having substantially the same functional configuration are denoted by the same reference numerals and duplicated descriptions thereof will be omitted.

### First Embodiment

### Outline of Training Process of Reconstruction Model

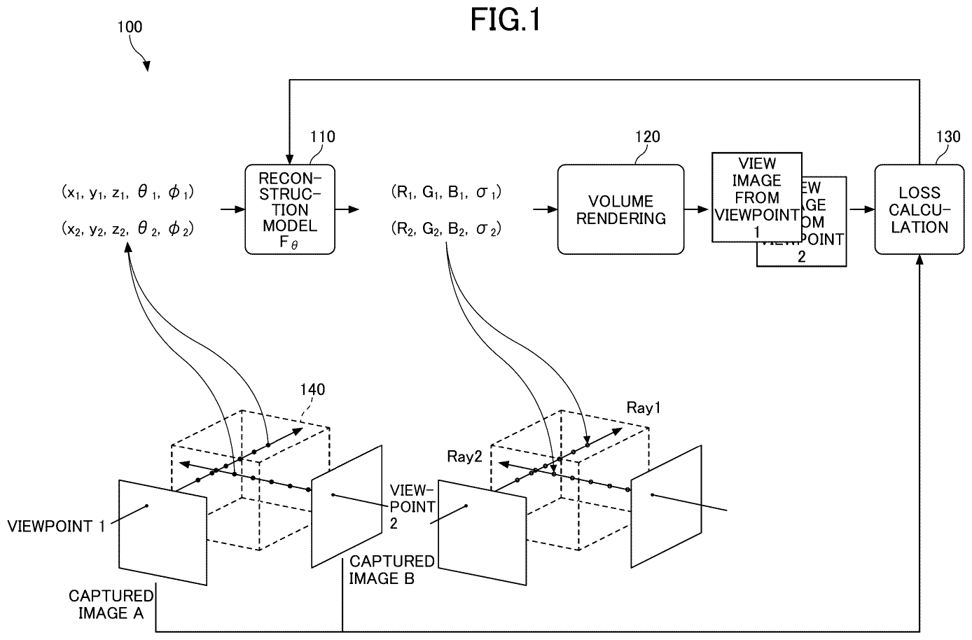

First, an outline of a training process of a reconstruction model will be described, using, as an example, a reconstruction model to which the NeRF technique is applied as a reconstruction model configured to reconstruct a three-dimensional scene (hereafter also referred to as a scene). FIG. 1 is a first diagram for explaining the outline of the training process of the reconstruction model.

In FIG. 1, a reconstruction model 110, which is an example of the reconstruction model configured to reconstruct a three-dimensional scene, is a neural network (NN) to which the NeRF technique is applied, and is referred to as “F_{θ}” in the present embodiment. In a training process 100, the following information is input into the reconstruction model 110 (F_{θ}):
coordinate information for specifying coordinates of a three-dimensional point in a three-dimensional scene 140 (for example, (x₁, y₁, z₁)), and
viewpoint information for specifying a direction vector representing a line of sight (for example, a ray 1) from a viewpoint (for example, a viewpoint 1) with respect to the three-dimensional point (for example, viewpoint information (θ₁, φ₁)).
   With this, with respect to the input combination of the coordinate information of the three-dimensional point and the viewpoint information, the reconstruction model 110 (F_{θ}) outputs a combination of:
the color of the three-dimensional point (for example, the color specified by (R₁, G₁, B₁)); and
the opacity of the three-dimensional point (for example, the opacity specified by σ₁).
   That is, the reconstruction model 110 (F_{θ}) calculates the color and opacity of the three-dimensional point from a certain viewpoint. Hereinafter, the coordinate information of the three-dimensional point and the viewpoint information may be referred to as a three-dimensional point and a viewpoint, respectively.

In the training process 100, substantially the same processing is performed on the reconstruction model 110 (F_{θ}) for a plurality of viewpoints. The example of FIG. 1 illustrates that substantially the same processing is performed for two viewpoints (the viewpoint 1 and the viewpoint 2).

Specifically, in the training process 100, the following information is further input into the reconstruction model 110 (F_{θ}):
a three-dimensional point in the three-dimensional scene 140 (for example, a point identified by (x₂, y₂, z₂)), and
viewpoint information for specifying a direction vector representing a line of sight (for example, a ray 2) from the viewpoint 2 with respect to the three-dimensional point (for example, viewpoint information (θ₂, φ₂)).
   With this, with respect to the input combination of the three-dimensional point and viewpoint information, the reconstruction model 110 (F_{θ}) outputs a combination of:
the color of the three-dimensional point (for example, the color specified by (R₂, G₂, B₂)); and
the opacity of the three-dimensional point (for example, the opacity specified by σ₂).

Additionally, in the training process 100 illustrated in FIG. 1, a volume rendering process 120 is performed on a plurality of combinations of colors and opacities output from the reconstruction model 110 (F_{θ}) for a plurality of three-dimensional points on lines of sight for the viewpoints (for example, the viewpoints 1 and 2).

The volume rendering process 120 calculates the color of each pixel of an image seen from a certain viewpoint by using a volume rendering method. Specifically, the volume rendering process 120 calculates the color of each pixel by performing volume rendering using a predetermined sum-of-products operation based on the color and opacity output from the reconstruction model 110 (F_{θ}) for each of a plurality of three-dimensional points on a line of sight connecting the pixel to the viewpoint. As a result, the volume rendering process 120 generates a view image from the certain viewpoint. Here, the view image refers to an image of a scene that is seen from a specific viewpoint (that is, an image based on specific viewpoint information) among free-viewpoint images that are images of the scene seen from various viewpoints (that is, images based on various viewpoint information).

Additionally, in the training process 100 illustrated in FIG. 1, a loss calculation process 130 is performed on the generated view image from the viewpoint 1 and the view image from the viewpoint 2. For example, the view image from the viewpoint 1 is compared with a captured image A captured by an imaging device having the viewpoint 1 to calculate the error. The view image from the viewpoint 2 is compared with a captured image B captured by an imaging device having the viewpoint 2 to calculate the error.

The error calculated in the loss calculation process 130 is backpropagated through the reconstruction model 110 (F_{θ}) by an error backpropagation method in an update process of the reconstruction model 110 (F_{θ}). With this, model parameters of the reconstruction model 110 (F_{θ}) are updated. The model parameters of the reconstruction model 110 (F_{θ}) are updated by the training process for the reconstruction model 110 (F_{θ}), thereby generating the trained reconstruction model (F_{θ}) according to the training process 100 illustrated in FIG. 1.

Here, in order to simplify the description, the case in which the training process is performed using a captured image captured by an imaging device having a viewpoint other than the viewpoints 1 and 2 is omitted here, but a captured image captured by an imaging device having a viewpoint other than the viewpoints 1 and 2 may be used in the training process.

### Outline of Image Generation Process Using Trained Reconstruction Model

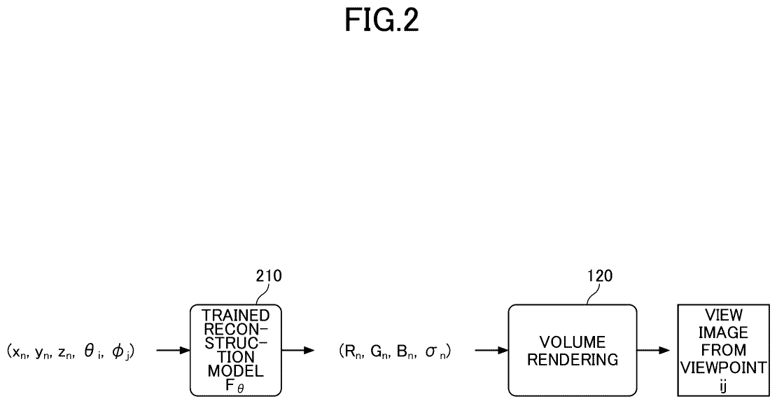

Next, an outline of an image generation process using the trained reconstruction model will be described. FIG. 2 is a first diagram for explaining the outline of the image generation process using the trained reconstruction model.

As illustrated in FIG. 2, in the image generation process for generating a view image from a viewpoint ij, a three-dimensional point (xₙ, yₙ, zₙ) and viewpoint information (θᵢ, φⱼ) related to the viewpoint ij are input into a trained reconstruction model 210 (F_{θ}), and the color and opacity of each three-dimensional point are calculated as the output. In the image generation process, the volume rendering process 120 based on the calculated color and opacity of the three-dimensional point is performed for each pixel of a view image, thereby generating a view image from the viewpoint ij.

### Relationship Between Captured Image and Trained Reconstruction Model

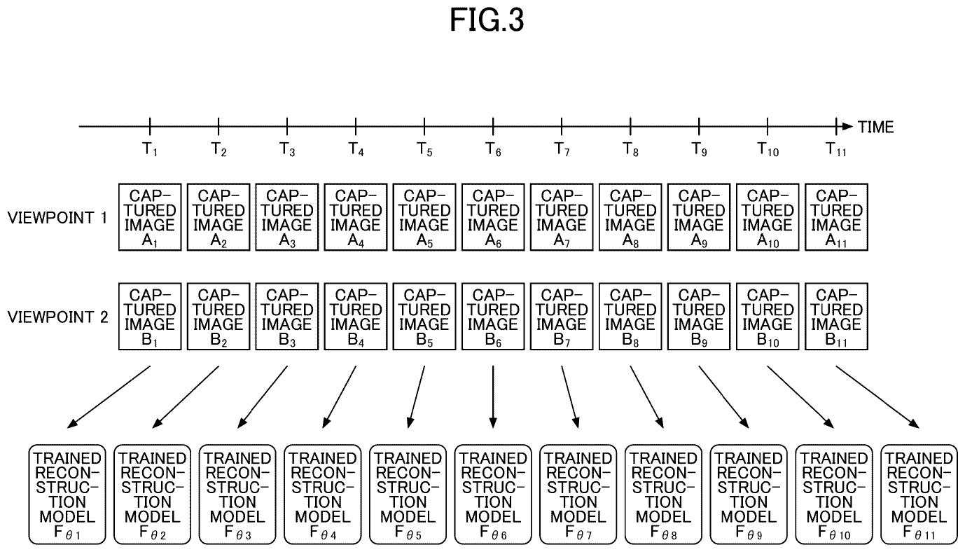

Next, trained reconstruction models applied to a server device according to a first embodiment will be described. FIG. 3 is a first diagram illustrating an example of the trained reconstruction models applied to the server device. Here, FIG. 3 also illustrates the case where two viewpoints, which are the viewpoint 1 and the viewpoint 2, are used for the sake of simplification of explanation, but as described above, a captured image captured by an imaging device having a viewpoint other than the viewpoint 1 and the viewpoint 2 may be used in the training process.

As illustrated in FIG. 3, a group of the trained reconstruction models is applied to the server device. The group of the trained reconstruction models is trained in advance so as to reconstruct a scene from a first time to a second time by using a time series of captured images obtained by capturing the scene from each of the plurality of viewpoints continuously in time.

Specifically, a trained reconstruction model (F_{θ1}) on which a training process has been performed using the following captured images is applied to the server device:
a captured image A₁ captured by the imaging device having the viewpoint 1 at time information T₁; and
a captured image B₁ captured by the imaging device having the viewpoint 2 at time information T₁.

Similarly, a trained reconstruction model (F_{θ2}) on which a training process has been performed using the following captured images is applied to the server device:
a captured image A₂ captured by the imaging device having the viewpoint 1 at time information T₂; and
a captured image B₂ captured by the imaging device having the viewpoint 2 at time information T₂.

Hereinafter, in the example of FIG. 3, the trained reconstruction models up to the trained reconstruction model F_{θ11} of the time information T₁₁ are illustrated for the sake of space, but the number of trained reconstruction models applied to the server device is not limited to 11. However, it is assumed that all of the trained reconstruction models are associated with the time information and are managed as trained reconstruction models for the time series.

Here, in FIG. 3, the time information T₁, T₂, T₃, . . . corresponds to a frame period (an example of a first time interval, e.g., a time interval corresponding to 30 fps) of the captured images A₁, A₂, . . . or the captured images B₁, B₂, . . . captured by the imaging device during the training process. That is, the trained reconstruction models for the time series of the frame period (an example of first reconstruction models) configured to generate view images of the time series of the frame period are applied to the server device.

### System Configuration of Free-Viewpoint Moving Image Rendering System

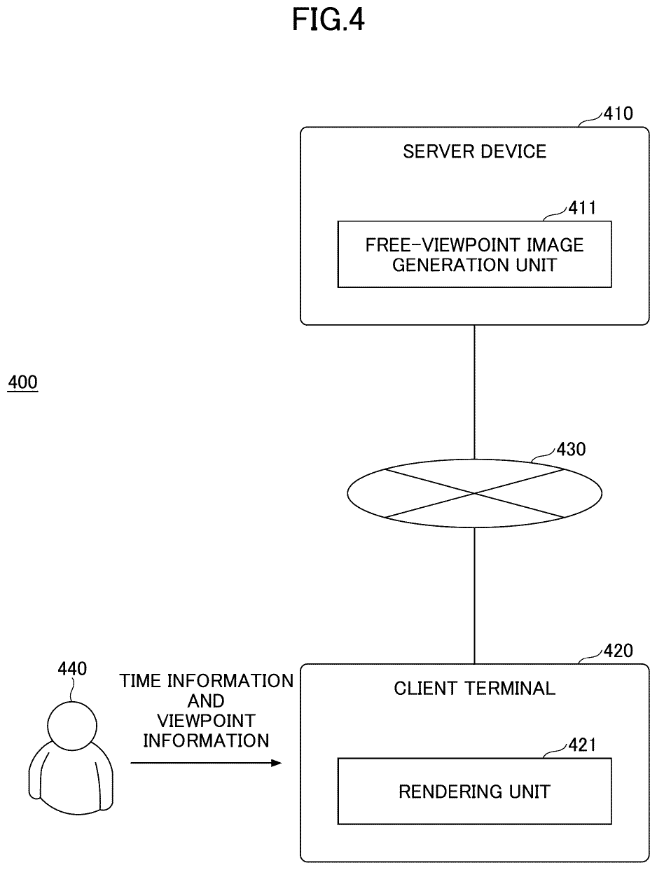

Next, a system configuration of a free-viewpoint moving image rendering system including the server device according to the first embodiment will be described. FIG. 4 is a first diagram illustrating an example of the system configuration of the free-viewpoint moving image rendering system.

As illustrated in FIG. 4, a free-viewpoint moving image rendering system 400 includes a server device 410 according to the first embodiment and a client terminal 420. In the free-viewpoint moving image rendering system, the server device 410 and the client terminal 420 are communicatively connected via a communication network 430.

A free-viewpoint image generation program is installed in the server device 410, and by executing the program, the server device 410 functions as the free-viewpoint image generation unit 411.

The free-viewpoint image generation unit 411 receives a request from the client terminal 420 via the communication network 430, and reads and executes a trained reconstruction model held by a model storage unit 606 described later based on time information and viewpoint information included in the received request.

With this, the free-viewpoint image generation unit 411 transmits view images in respective time information generated by executing the trained reconstruction models corresponding to the respective time information in a transmission format that can be played back as a moving image.

A rendering program is installed in the client terminal 420, and by executing the program, the client terminal 420 functions as a rendering unit 421. Here, the rendering program may be a dedicated application or a predetermined browser.

The rendering unit 421 transmits, to the server device 410 via the communication network 430, a request including time information and viewpoint information input by a user 440.

Additionally, the rendering unit 421 receives a time series of view images transmitted from the server device 410 in response to the transmission of the request to the server device 410, and plays back a free-viewpoint moving image using the received time series of view images as images of respective frames (frame images) of the moving image.

### Hardware Configuration of Server Device and Client Terminal

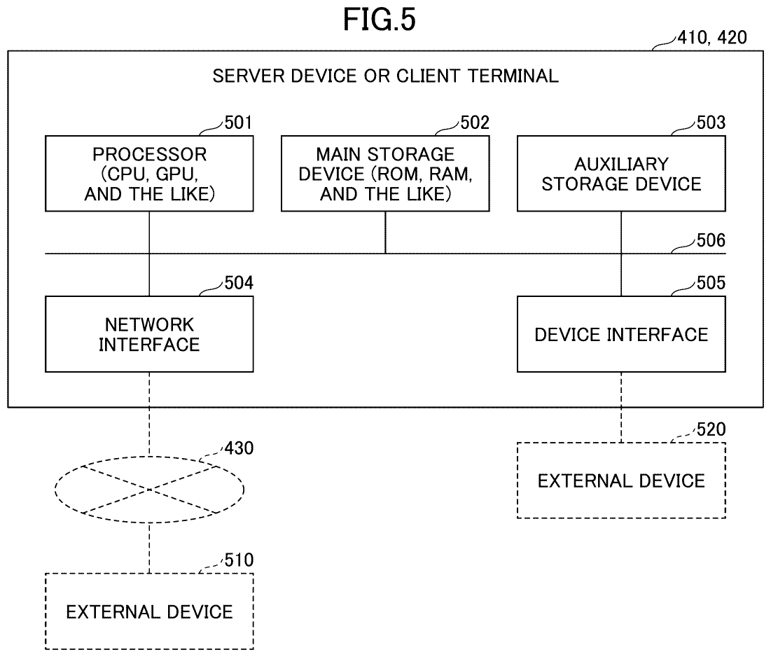

Next, a hardware configuration of the server device 410 and the client terminal 420 will be described. FIG. 5 is a diagram illustrating an example of the hardware configuration of the server device and the client terminal. Here, the server device 410 and the client terminal 420 have substantially the same hardware configurations, and thus the hardware configuration of the server device 410 will be described here.

The server device 410 includes, as constituent elements, a processor 501, a main storage device 502 (memory), an auxiliary storage device 503 (memory), a network interface 504, and a device interface 505. The server device 410 may be realized as a computer in which these constituent elements are connected via a bus 506. Here, in the example of FIG. 5, the server device 410 is illustrated as having one of each constituent element, but the server device 410 may include a plurality of the same constituent elements.

Various operations of the server device 410 may be executed in parallel processing using one or more processors. Various operations may be distributed to a plurality of operation cores in the processor 501 and executed in parallel processing.

Additionally, some or all of the processes, means, and the like of the present disclosure may be performed by an external device 510 (at least one of a processor or a storage device) provided on a cloud that can communicate with the server device 410 via the network interface 504.

The processor 501 may be an electronic circuit (a processing circuit, processing circuitry, a central processing unit (CPU), a graphics processing unit (GPU), a field-programmable gate array (FPGA), an application-specific integrated circuit (ASIC), or the like). Additionally, the processor 501 may be a semiconductor device or the like including a dedicated processing circuit. Here, the processor 501 is not limited to an electronic circuit using an electronic logic element, and may be realized by an optical circuit using an optical logic element. The processor 501 may include an arithmetic function based on quantum computing.

The processor 501 performs various arithmetic operations based on various data and instructions input from a device of the internal components of the server device 410 or the like, and outputs arithmetic results and control signals to the device or the like. The processor 501 controls each component of the server device 410 by executing an operating system (OS), an application, or the like.

Additionally, the processor 501 may refer to one or more electronic circuits arranged on one chip, or one or more electronic circuits arranged on two or more chips or devices. When a plurality of electronic circuits are used, each electronic circuit may communicate by wire or wirelessly.

The main storage device 502 is a storage device for storing instructions and various data to be executed by the processor 501, and various data stored in the main storage device 502 are read out by the processor 501. The auxiliary storage device 503 is a storage device other than the main storage device 502, and realizes, for example, the model storage unit 606 described later. Here, these storage devices indicate any electronic component capable of storing various data, and may be a semiconductor memory. The semiconductor memory may be either a volatile memory or a nonvolatile memory. The storage device for storing various data in the server device 410 may be realized by the main storage device 502 or the auxiliary storage device 503, or may be realized by a built-in memory built in the processor 501.

Additionally, a plurality of processors 501 may be connected (coupled) to a single main storage device 502, or a single processor 501 may be connected. Alternatively, a plurality of main storage devices 502 may be connected (coupled) to a single processor 501. When the server device 410 includes at least one main storage device 502 and a plurality of processors 501 connected (coupled) to the at least one main storage device 502, at least one processor among the plurality of processors 501 may be connected (coupled) to the at least one main storage device 502.

The network interface 504 is an interface for connecting to the communication network 430 by wire or wirelessly.

The device interface 505 is an interface such as USB for directly connecting to an external device 520.

The external device 520 may be, for example, an input device. In the present embodiment, the input device is, for example, a keyboard, a mouse, a touch panel, or the like, and provides acquired information to the server device 410.

Additionally, the external device 520 may be, for example, an output device. In the present embodiment, the output device may be, for example, a display device, such as a liquid crystal display (LCD), a cathode ray tube (CRT), a plasma display panel (PDP), or an organic electro luminescence (EL) panel, or a speaker for outputting sound or the like.

Additionally, the external device 520 may be a storage device (memory). For example, the external device 520 may be a network storage device or the like, and the external device 520 may be a storage device such as an HDD.

Additionally, the external device 520 may be a device having a function of a part of the components of the server device 410. That is, the server device 410 may transmit and receive processing results to and from the external device 520.

### Functional Configuration of Server Device

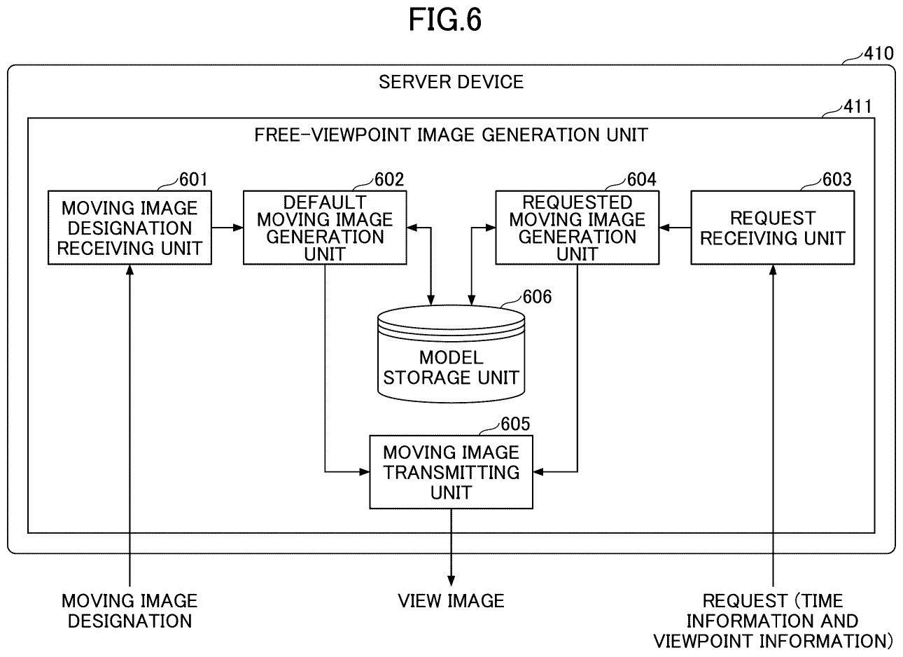

Next, a functional configuration of the server device 410 will be described. FIG. 6 is a first diagram illustrating an example of the functional configuration of the server device. As described above, the server device 410 functions as the free-viewpoint image generation unit 411. As illustrated in FIG. 6, the free-viewpoint image generation unit 411 further includes a moving image designation receiving unit 601, a default moving image generation unit 602, a request receiving unit 603, a requested moving image generation unit 604, and a moving image transmitting unit 605.

The moving image designation receiving unit 601 receives a designation of a free-viewpoint moving image from the client terminal 420. In the present embodiment, it is assumed that a plurality of free-viewpoint moving images can be rendered by the client terminal 420, and the server device 410 is configured such that the moving image designation receiving unit 601 receives a designation of one of the free-viewpoint moving images. The moving image designation receiving unit 601 notifies the default moving image generation unit 602 of identification information for uniquely identifying the free-viewpoint moving image for which the designation has been received (for example, identifier (ID) of the free-viewpoint moving image).

The default moving image generation unit 602 reads, from the model storage unit 606, a group of trained reconstruction models configured to generate view images included in the free-viewpoint moving image identified by the identification information notified by the moving image designation receiving unit 601.

Additionally, the default moving image generation unit 602 inputs default viewpoint information into the read group of the trained reconstruction models, and generates view images at respective times (respective time points) corresponding to the default viewpoint information. The view images corresponding to the default viewpoint information generated by the default moving image generation unit 602 are notified to the moving image transmitting unit 605.

The request receiving unit 603 receives a request from the client terminal 420. In the present embodiment, the request transmitted from the client terminal 420 includes time information and viewpoint information. The request received by the request receiving unit 603 is notified to the requested moving image generation unit 604.

The requested moving image generation unit 604 performs processing corresponding to the type of the time information included in the request notified by the request receiving unit 603. For example, it is assumed that the time information included in the request is time information based on a rendering instruction in the client terminal 420. This time information may be, for example, a time point at which the user 440 issues a rendering instruction to the moving image regardless of whether the rendering is being performed or stopped in the client terminal 420. In this case, the requested moving image generation unit 604 sequentially inputs the viewpoint information included in the request into the trained reconstruction model corresponding to the time information notified by the request receiving unit 603 among the trained reconstruction models that are already read. With this, the requested moving image generation unit 604 sequentially generates a view image corresponding to the time information and viewpoint information included in the request and notifies the moving image transmitting unit 605.

Additionally, for example, it is assumed that the time information included in the request is time information based on a stop instruction in the client terminal 420 (an example of time information corresponding to an end condition). This time information may be, for example, a time point at which the user 440 issues a stop instruction to the moving image being rendered in the client terminal 420. In this case, the requested moving image generation unit 604 identifies, among the trained reconstruction models that have already been read, a trained reconstruction model corresponding to the time information notified by the request receiving unit 603 as the last trained reconstruction model during the rendering, and inputs the viewpoint information included in the request. Then, the requested moving image generation unit 604 generates the last view image corresponding to the time information and the viewpoint information included in the request, notifies the moving image transmitting unit 605 of the generated view image, and stops the process.

Additionally, for example, it is assumed that the time information included in the request is time information based on an operation instruction during a stopped state in the client terminal 420. This time information may be, for example, time information based on an operation instruction (for example, an operation instruction to an indicator of a seek bar described later) performed by the user 440 for a scene to be displayed in a stopped state on the moving image being stopped in the client terminal 420. In this case, the requested moving image generation unit 604 generates a view image by inputting the viewpoint information included in the request into the trained reconstruction model corresponding to the time information every time the time information is notified by the request receiving unit 603, and notifies the moving image transmitting unit 605 of the generated view image.

The moving image transmitting unit 605 transmits the view image corresponding to the default viewpoint information notified by the default moving image generation unit 602 in a transmission format that can be played back as a moving image by the client terminal 420.

Additionally, the moving image transmitting unit 605 transmits the view image corresponding to the time information and viewpoint information included in the request notified by the requested moving image generation unit 604 in a transmission format that can be played back as a moving image by the client terminal 420.

Here, the transmitting in the transmission format that can be played back as a moving image includes, for example, transmitting the view image to the client terminal 420 as it is. Additionally, the transmitting in the transmission format that can be played back as a moving image includes, for example, performing a moving image encoding process on the view images and transmitting it to the client terminal 420. In the case of performing a moving image encoding process on the view images and transmitting it to the client terminal 420, the encoding method is suitably selected, and the moving image encoding process may be performed by using, for example, H.264/MPEG 4. Further, in the case of performing a moving image encoding process on the view images and transmitting it to the client terminal 420, the view images on which the moving image encoding process is performed are restored by the client terminal 420. With this, the client terminal 420 plays back a free-viewpoint moving image using the restored view images as frame images.

### Example of Trained Reconstruction Model

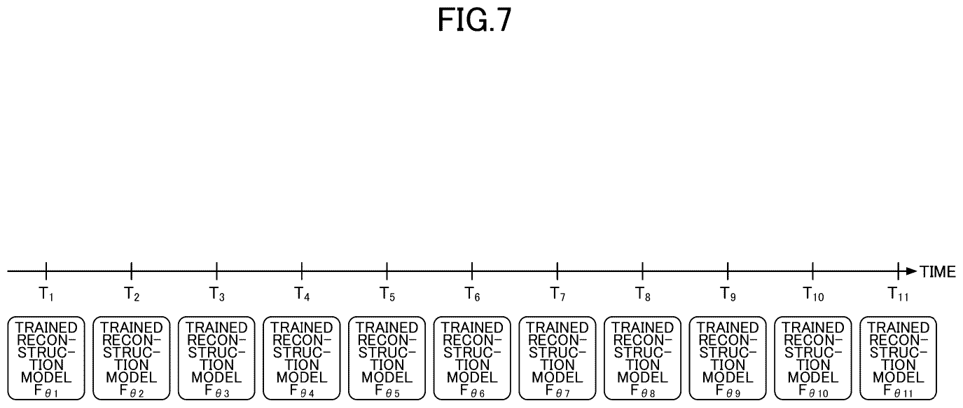

Next, the trained reconstruction model held by the model storage unit 606 in the server device 410 according to the first embodiment will be described. FIG. 7 is a diagram illustrating an example of the trained reconstruction models held by the model storage unit of the server device according to the first embodiment.

As illustrated in FIG. 7, the trained reconstruction models held by the model storage unit 606 are associated with the time information. Specifically, the trained reconstruction model F_{θ1} is associated with the time information T₁, and the trained reconstruction model F_{θ2} is associated with the time information T₂. Similarly, the example of FIG. 7 illustrates that the trained reconstruction models F_{θ3} to F_{θ11} are associated with the time information T₃ to T₁₁, respectively. The association between the time information and the trained reconstruction model may be made by directly associating the time information with the trained reconstruction model, or by indirectly associating the time information with the trained reconstruction model through other data.

The server device 410 generates a time series of view images corresponding to the viewpoint information and the time information included in the request received from the client terminal 420 by using the trained reconstruction models held by the model storage unit 606.

Here, in FIG. 7, as described above, the time information T₁, T₂, T₃, . . . corresponds to the frame period of the captured images captured by the imaging device during the training process. Therefore, the time information T₁, T₂, T₃, . . . corresponds to a frame period when a free-viewpoint moving image is rendered in the free-viewpoint moving image rendering system 400.

Additionally, as illustrated in FIG. 7, the trained reconstruction models associated with the respective time information are mutually different trained reconstruction models. The mutually different trained reconstruction models herein are configured by NNs to which the NeRF technique is applied, and are trained with mutually different training data (captured images). The architectures of the NNs may be the same or partially different.

Here, each of the trained reconstruction models illustrated in FIG. 7 can generate a view image (a free-viewpoint image) from an arbitrary viewpoint for the scene in the time information.

Additionally, as illustrated in FIG. 7, the model storage unit 606 holds at least a group of trained reconstruction models configured to generate view images for a series of scenes for one single object. However, the group of trained reconstruction models held by the model storage unit 606 is not limited to one, and another group of trained reconstruction models configured to generate view images for a series of scenes for another single object may be held.

Additionally, as illustrated in FIG. 7, for the sake of space, the group of trained reconstruction models held by the model storage unit 606 includes 11 trained reconstruction models for the time information T₁ to T₁₁. However, the number of trained reconstruction models included in the group of trained reconstruction models held by the model storage unit 606 is not limited to this.

### Specific Example of Processing by Server Device

Next, a specific example of processing by each unit (here, the default moving image generation unit 602 and the requested moving image generation unit 604) of the server device 410 according to the first embodiment will be described.

### (1) Specific Example of Processing by Default Moving Image Generation Unit

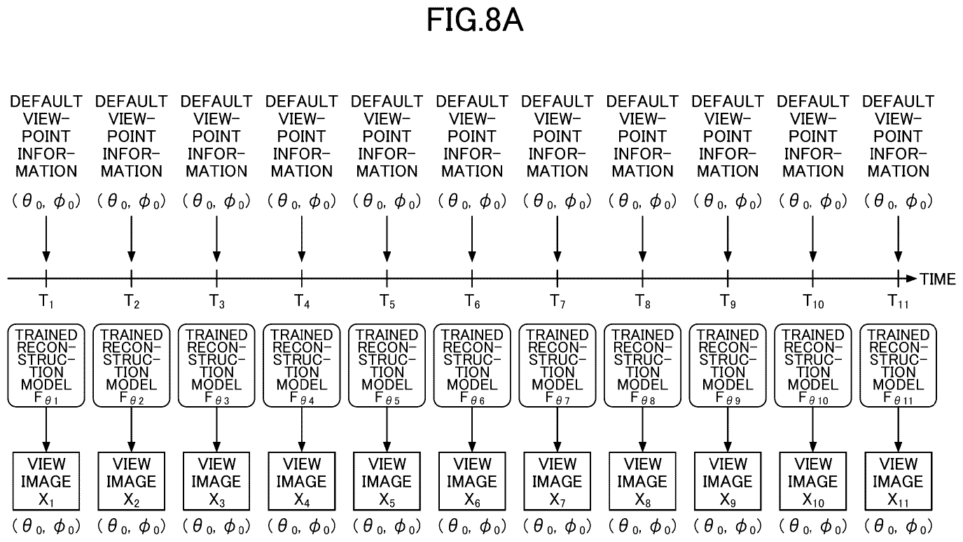

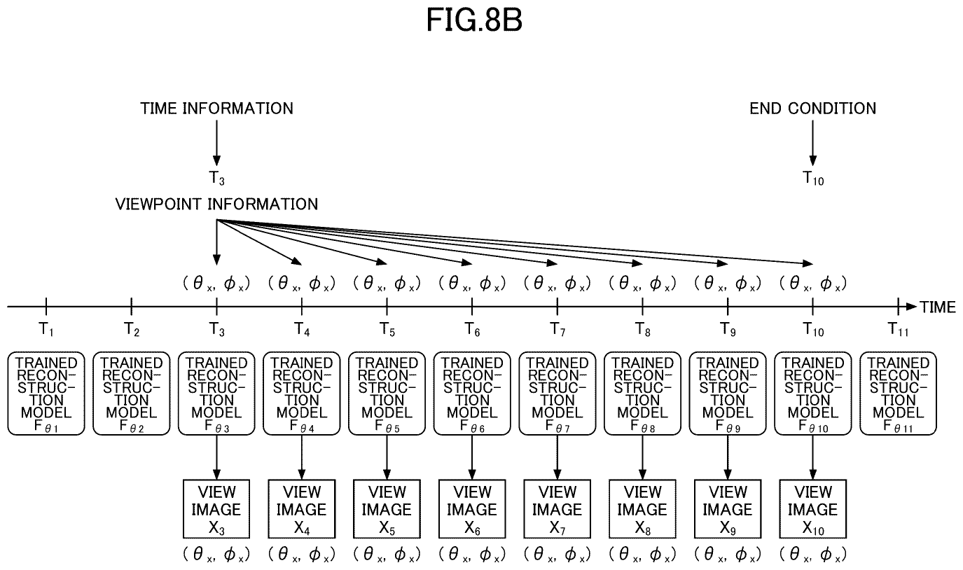

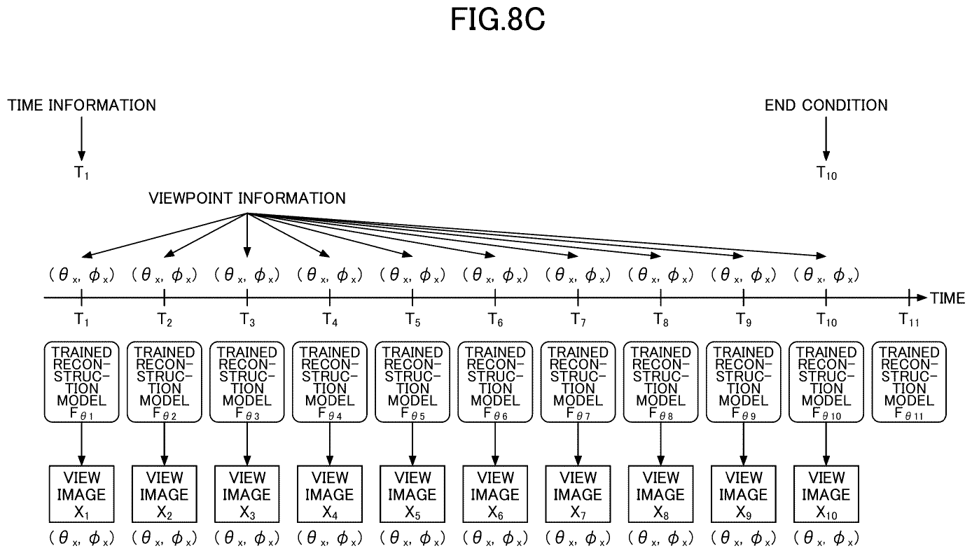

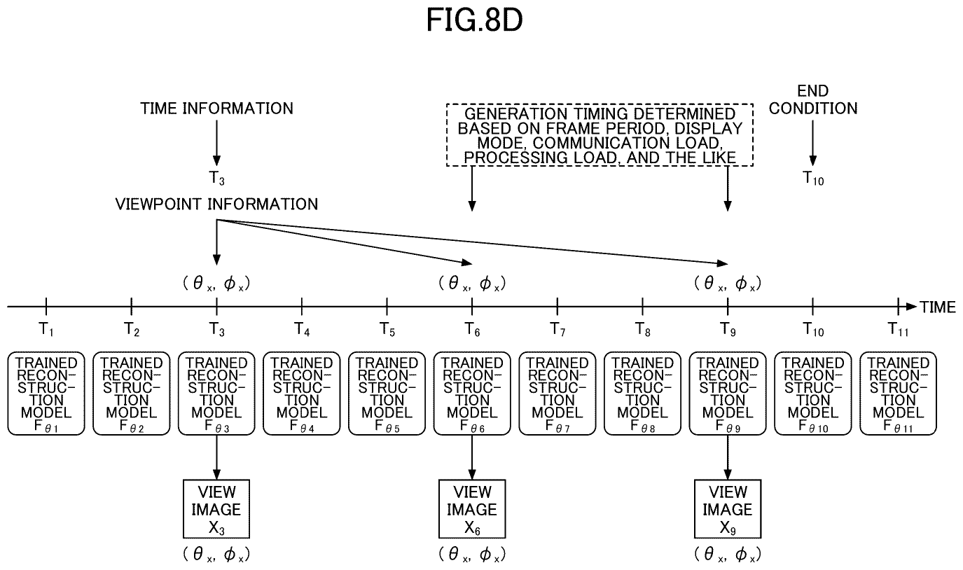

First, a specific example of processing by the default moving image generation unit 602 will be described. FIG. 8A is a first diagram illustrating a specific example of the processing by the server device according to the first embodiment. FIG. 8A illustrates a specific example of processing when the moving image designation receiving unit 601 receives a designation of a free-viewpoint moving image and the default moving image generation unit 602 receives notification of identification information of the designated free-viewpoint moving image from the moving image designation receiving unit 601.

As illustrated in FIG. 8A, the default moving image generation unit 602, having received notification of identification information of the designated free-viewpoint moving image, reads the trained reconstruction models F_{θ1} to F_{θ11} configured to generate view images included in the designated free-viewpoint moving image from the model storage unit 606.

Additionally, the default moving image generation unit 602 inputs default viewpoint information (θ₀, φ₀) into each of the read trained reconstruction models F_{θ1} to F_{θ11}. With this, the trained reconstruction models F_{θ1} to F_{θ11} generate view images X₁ to X₁₁ of a scene viewed from a viewpoint based on the default viewpoint information (θ₀, φ₀) in respective time information.

Additionally, the default moving image generation unit 602 notifies the moving image transmitting unit 605 of the generated view images X₁ to X₁₁ in association with the time information T₁ to T₁₁. With this, the moving image transmitting unit 605 transmits the view images X₁ to X₁₁ in a transmission format that can be played back as a moving image by the client terminal 420.

### (2) Specific Example 1 of Processing by Requested Moving Image Generation Unit

It is assumed that the client terminal 420 plays back a free-viewpoint moving image using the view images X₁ to X₁₁ as frame images of the scene viewed from the viewpoint based on the default viewpoint information (θ₀, φ₀) in the respective time information. Additionally, it is assumed that the request including the time information and the viewpoint information is transmitted from the client terminal 420 in response to the client terminal 420 playing back the free-viewpoint moving image. In this case, the request receiving unit 603 receives the request and notifies the requested moving image generation unit 604.

Here, a specific example of processing by the requested moving image generation unit 604 when the request (time information and viewpoint information) is notified by the request receiving unit 603 will be described. FIG. 8B is a second diagram illustrating a specific example of the processing by the server device according to the first embodiment, and illustrates a specific example of the processing by the requested moving image generation unit 604 when the request is notified by the request receiving unit 603.

As illustrated in FIG. 8B, the requested moving image generation unit 604 identifies a trained reconstruction model F_{θ3} corresponding to the time information (in the example of FIG. 8B, T₃) included in the request among the trained reconstruction models F_{θ1} to F_{θ11} that are already read.

Additionally, the requested moving image generation unit 604 inputs the viewpoint information (in the example of FIG. 8B, (θₓ, φₓ)) included in the request into the identified trained reconstruction model F_{θ3}. With this, the trained reconstruction model F_{θ3} generates the view image X₃ of the scene viewed from the viewpoint based on the viewpoint information (θₓ, φₓ) included in the request in the time information T₃.

Subsequently, the requested moving image generation unit 604 identifies a trained reconstruction model F_{θ4} corresponding to the next time information (the next time point) as the next trained reconstruction model. Additionally, the requested moving image generation unit 604 inputs the viewpoint information (in the example of FIG. 8B, (θₓ, φₓ)) included in the request into the identified trained reconstruction model F_{θ4}. With this, the trained reconstruction model F_{θ4} generates the view image X₄ of the scene viewed from the viewpoint based on the viewpoint information (θₓ, φₓ) included in the request in the time information T₄.

Hereinafter, the requested moving image generation unit 604 repeats substantially the same processing until an end condition is transmitted from the client terminal 420. The example of FIG. 8B indicates a state in which the time information T₁₀ is transmitted as the end condition from the client terminal 420.

When the time information T₁₀ is transmitted as the end condition from the client terminal 420, the requested moving image generation unit 604 identifies, as the last trained reconstruction model, the trained reconstruction model F_{θ10} corresponding to the time information T₁₀ transmitted as the end condition. Additionally, the requested moving image generation unit 604 inputs the viewpoint information (in the example of FIG. 8B, (θₓ, φₓ)) included in the request into the identified trained reconstruction model F_{θ10}. With this, the trained reconstruction model F_{θ10} generates the view image X₁₀ of the scene viewed from the viewpoint based on the viewpoint information (θₓ, φₓ) included in the request in the time information T₁₀.

As described above, the requested moving image generation unit 604 generates the time series of view images corresponding to the viewpoint information by using the trained reconstruction models for the time series from the trained reconstruction model corresponding to the time information included in the request to the trained reconstruction model corresponding to the predetermined end condition.

Here, the end condition refers to time information based on a stop instruction for stopping the rendering of the free-viewpoint moving image corresponding to the request. When a stop button for stopping the free-viewpoint moving image that is being rendered is pressed, the client terminal 420 transmits, to the server device 410, time information corresponding to the pressed timing as the end condition. However, the end condition transmitted by the client terminal 420 is not limited to this. For example, when a designation of a time range is received when the free-viewpoint moving image is rendered, the client terminal 420 transmits time information corresponding to the end timing of the time range to the server device 410 as the end condition.

Additionally, the end condition is not necessarily transmitted by the client terminal 420. For example, when the stop button is not pressed for the free-viewpoint moving image being rendered, the trained reconstruction model corresponding to the last time information among the trained reconstruction models for the time series becomes the trained reconstruction model corresponding to the predetermined end condition.

The requested moving image generation unit 604 sequentially notifies the moving image transmitting unit 605 of the generated view images X₃ to X₁₀ in association with the time information T₃ to T₁₀. With this, the moving image transmitting unit 605 can transmit the view images X₃ to X₁₀ in a transmission format that can be played back as a moving image by the client terminal 420.

### (3) Specific Example 2 of Processing by Requested Moving Image Generation Unit

It is assumed that a request including time information is transmitted from the client terminal 420 in response to the client terminal 420 playing back a free-viewpoint moving image using the view images X₃ to X₁₀ as frame images of the scene viewed from the viewpoint based on viewpoint information (θₓ, φₓ) included in the request. In this case, the request receiving unit 603 receives the request and notifies the requested moving image generation unit 604.

Here, a specific example of processing by the requested moving image generation unit 604 when the request (time information) is notified by the request receiving unit 603 will be described. FIG. 8C is a third diagram illustrating a specific example of the processing by the server device according to the first embodiment, and illustrates the specific example of the processing by the requested moving image generation unit 604 when a request is notified by the request receiving unit 603.

As illustrated in FIG. 8C, the requested moving image generation unit 604 identifies the trained reconstruction model F_{θ1} corresponding to the time information (in the example of FIG. 8C, T₁) included in the request among the trained reconstruction models F_{θ1} to F_{θ11} that are already read from the model storage unit 606.

Additionally, the requested moving image generation unit 604 inputs the viewpoint information into the identified trained reconstruction model F_{θ1}. In the example of FIG. 8C, because the viewpoint information is not included in the request, the requested moving image generation unit 604 reuses and inputs the viewpoint information (in the example of FIG. 8C, (θₓ, φₓ)) included in the most recent request. With this, the trained reconstruction model F_{θ1} generates the view image X₁ of the scene viewed from the viewpoint based on the current viewpoint information (θₓ, φₓ) in the time information T₁.

Subsequently, the requested moving image generation unit 604 identifies the trained reconstruction model F_{θ2} corresponding to the next time information (the next time point) as the next trained reconstruction model. Additionally, the requested moving image generation unit 604 inputs the viewpoint information (in the example of FIG. 8C, (θₓ, φₓ)) included in the most recent request into the identified trained reconstruction model F_{θ2}. With this, the trained reconstruction model _{θ2} generates the view image X₂ in the time information T₂ of the scene viewed from the viewpoint based on the current viewpoint information (θₓ, φₓ).

Hereinafter, the requested moving image generation unit 604 repeats substantially the same processing until an end condition is transmitted from the client terminal 420. The example of FIG. 8C indicates a state in which the time information T₁₀ is transmitted as the end condition from the client terminal 420.

When the time information T₁₀ is transmitted as the end condition from the client terminal 420, the requested moving image generation unit 604 identifies, as the last trained reconstruction model, the trained reconstruction model F_{θ10} corresponding to the time information T₁₀ transmitted as the end condition. Additionally, the requested moving image generation unit 604 inputs the current viewpoint information (in the example of FIG. 8C, (θₓ, φₓ)) into the identified trained reconstruction model F_{θ10}. With this, the trained reconstruction model F_{θ10} generates the view image X₁₀ of the scene viewed from the viewpoint based on the current viewpoint information (θₓ, φₓ) in the time information T₁₀.

The requested moving image generation unit 604 sequentially notifies the moving image transmitting unit 605 of the generated view images X₁ to X₁₀ in association with the time information T₁ to T₁₀. With this, the moving image transmitting unit 605 can transmit the view images X₁ to X₁₀ corresponding to the time information and the current viewpoint information (θₓ, φₓ) included in the request in a transmission format that can be played back as a moving image by the client terminal 420.

### (4) Specific Example 3 of Processing by Requested Moving Image Generation Unit

Next, another specific example (a specific example different from Specific Example 2) of processing by the requested moving image generation unit 604 when the request (time information and viewpoint information) is notified by the request receiving unit 603 will be described. In Specific Example 2, the requested moving image generation unit 604 identifies the next trained reconstruction model at a time interval corresponding to a frame period.

With respect to the above, in the free-viewpoint moving image rendering system 400, it is not always possible to play back all view images generated by the identified trained reconstruction models as frame images in the client terminal 420. For example, it is not always possible to play back all the view images as frame images in the client terminal 420:
when the frame period in the client terminal 420 is longer than the time interval of the view images generated by the requested moving image generation unit 604,
when the display mode in the client terminal 420 is a double-speed mode or a 10-second skip mode,
when the communication load between the server device 410 and the client terminal 420 is high and the communication speed is reduced,
when the processing load of the server device 410 or the client terminal 420 is increased, or the like.
   Here, a specific example of the processing (frame skipping processing) performed by the requested moving image generation unit 604 in a case where all the view images cannot be played back as frame images in the client terminal 420 will be described. FIG. 8D is a fourth diagram illustrating a specific example of the processing performed by the server device according to the first embodiment.

As illustrated in FIG. 8D, the requested moving image generation unit 604 identifies the trained reconstruction model F_{θ3} corresponding to the time information (in the example of FIG. 8D, T₃) included in the request among the trained reconstruction models F_{θ1} to F_{θ11} that are already read from the model storage unit 606.

Additionally, the requested moving image generation unit 604 inputs the viewpoint information (in the example of FIG. 8D, (θₓ, φₓ)) included in the request into the identified trained reconstruction model F_{θ3}. With this, the trained reconstruction model F_{θ3} generates a view image X₃ of the scene viewed from the viewpoint based on the viewpoint information (θₓ, φₓ) included in the request in the time information T₃.

Subsequently, the requested moving image generation unit 604 determines the generation timing of the view image when identifying the next trained reconstruction model. The requested moving image generation unit 604 acquires information related to:
a frame period in the client terminal 420;
a display mode in the client terminal 420;
the communication load between the server device 410 and the client terminal 420; and
the processing load of the server device 410 and the client terminal 420, and determines the generation timing of the view image based on the acquired information.

In the example of FIG. 8D, the requested moving image generation unit 604 determines that the generation timing of the view image is time information=T₆ and identifies the trained reconstruction model F_{θ6} as the next trained reconstruction model. Additionally, in the example of FIG. 8D, the requested moving image generation unit 604 inputs the viewpoint information (in the example of FIG. 8D, (θₓ, φₓ)) included in the request into the identified trained reconstruction model F_{θ6}. With this, the trained reconstruction model F_{θ6} generates the view image X₆ of the scene viewed from the viewpoint based on the viewpoint information (θₓ, φₓ) included in the request in the time information T₆.

As illustrated in FIG. 8D, the requested moving image generation unit 604 repeats substantially the same processing (frame skipping processing) until an end condition is transmitted from the client terminal 420. In the example of FIG. 8D, the time information T₁₀ is transmitted as the end condition from the client terminal 420.

When the time information T₁₀ is transmitted as the end condition from the client terminal 420, the requested moving image generation unit 604 determines that it is not the generation timing of the view image, and stops the processing without generating the view image X₁₀.

The requested moving image generation unit 604 sequentially notifies the moving image transmitting unit 605 of the generated view images X₃, X₆, and X₉ in association with the time information T₃, T₆, and T₉. With this, the moving image transmitting unit 605 can transmit the view images X₃, X₆, and X₉ in a transmission format that can be played back as a moving image by the client terminal 420.

### Functional Configuration of Client Terminal

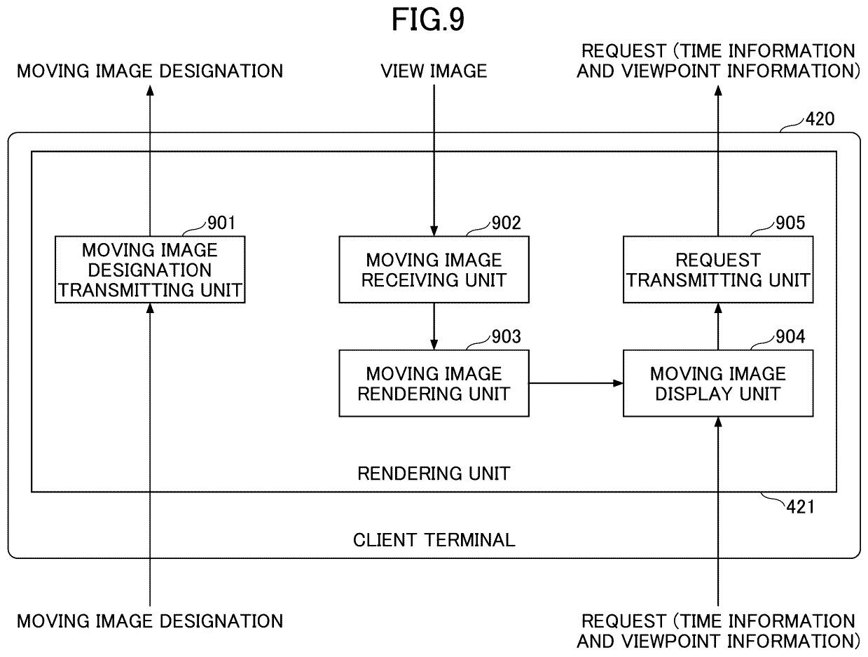

Next, a functional configuration of the client terminal 420 will be described. FIG. 9 is a first diagram illustrating an example of the functional configuration of the client terminal. As described above, the client terminal 420 functions as the rendering unit 421. As illustrated in FIG. 9, the rendering unit 421 further includes a moving image designation transmitting unit 901, a moving image receiving unit 902, a moving image rendering unit 903, a moving image display unit 904, and a request transmitting unit 905.

The moving image designation transmitting unit 901 receives a designation of a free-viewpoint moving image from the user 440 via a moving image designation screen (which will be described in detail later). The moving image designation transmitting unit 901 transmits, to the server device 410, identification information for uniquely identifying the free-viewpoint moving image for which the designation has been received.

The moving image receiving unit 902 receives the view image transmitted from the server device 410 and notifies the moving image rendering unit 903. Alternatively, the moving image receiving unit 902 receives view images that have been subjected to the moving image encoding process and that are transmitted from the server device 410, restores the view images that have been subjected to the moving image encoding process, and notifies the moving image rendering unit 903.

The moving image rendering unit 903 notifies the moving image display unit 904 of the notified view images at a predetermined frame period.

The moving image display unit 904 plays back, on a moving image playback screen (which will be described in detail later), a free-viewpoint moving image using the view images notified at a predetermined frame period as frame images. Additionally, the moving image display unit 904 also receives a request (either or both of the time information and the viewpoint information) from the user 440 on the moving image playback screen on which the free-viewpoint moving image is rendered, and notifies the request transmitting unit 905.

Here, as described above, the time information included in the request notified to the request transmitting unit 905 includes:
time information based on a rendering instruction;
time information based on a stop instruction;
time information based on various operations during a stopped state; and the like.

The request transmitting unit 905 transmits, to the server device 410, the request (the time information and the viewpoint information) notified by the moving image display unit 904.

### Display Screen of Client Terminal

Next, a display screen (a moving image designation screen and a moving image playback screen) of the client terminal 420 will be described.

(1) Moving image Designation Screen

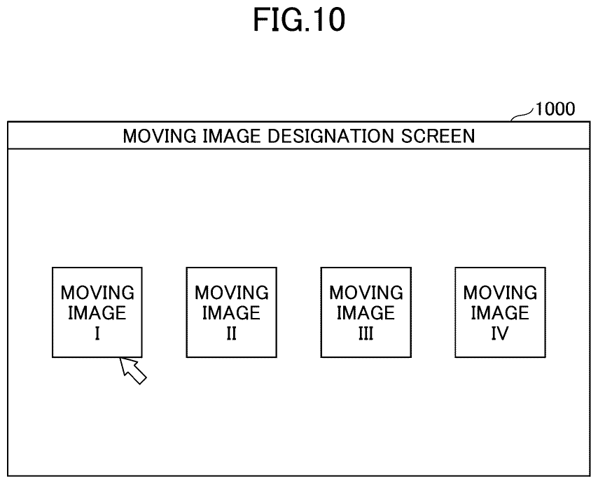

First, a moving image designation screen will be described. FIG. 10 is a diagram illustrating an example of the moving image designation screen of the client terminal.

As illustrated in FIG. 10, by accessing the server device 410, a list of free-viewpoint moving images that can be provided by the server device 410 is displayed on a moving image designation screen 1000 of the client terminal 420. The example of FIG. 10 illustrates a state in which four free-viewpoint moving images are displayed as the free-viewpoint moving images that can be provided by the server device 410.

The user 440 designates a free-viewpoint moving image to be rendered from among the free-viewpoint moving images displayed on the moving image designation screen 1000. With this, the moving image designation transmitting unit 901 transmits identification information for uniquely identifying the designated free-viewpoint moving image to the server device 410. The example of FIG. 10 indicates a state in which “moving image I” is designated as the free-viewpoint moving image by the user 440.

### (2) Moving Image Playback Screen 1

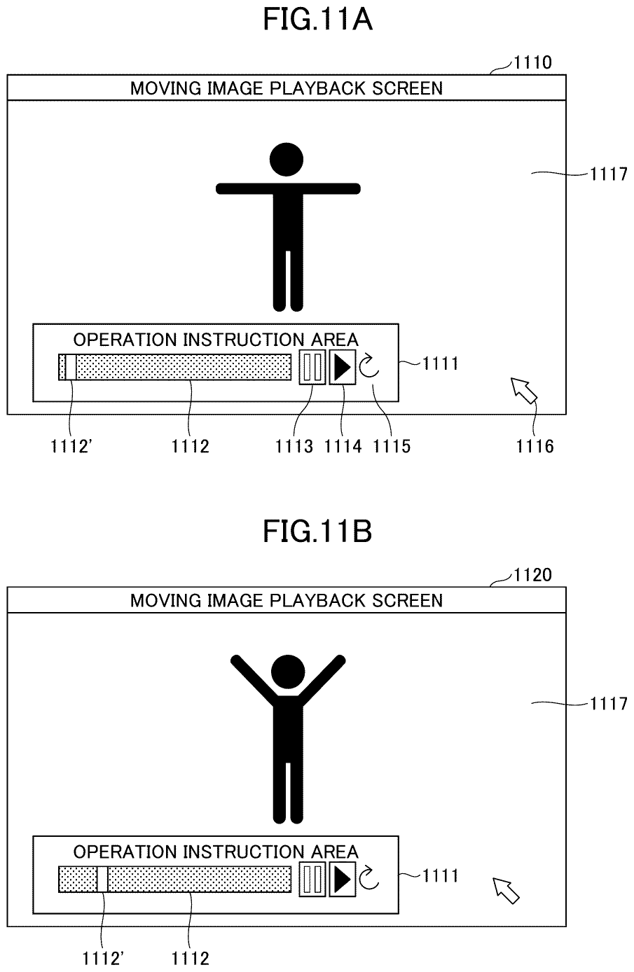

Next, a specific example of the moving image playback screen will be described. FIGS. 11A and 11B are first diagrams illustrating an example of the display screen of the client terminal.

When “moving image I” is designated by the user 440, the moving image playback screen of the client terminal 420 is switched to a moving image playback screen 1110, and the free-viewpoint moving image of “moving image I” is played back. As illustrated in FIGS. 11A and 11B, the moving image playback screen includes a moving image display area 1117 and an operation instruction area 1111. The operation instruction area 1111 includes:
a seek bar 1112;
a stop button 1113;
a play button 1114;
a ten-second skip button 1115; and the like.

The seek bar 1112 is a bar representing the current rendering position of the free-viewpoint moving image being rendered in the moving image display area 1117 by an indicator 1112′. During rendering of the free-viewpoint moving image, the indicator 1112′ of the seek bar 1112 moves from the left side to the right side in the drawing in synchronization with the passage of time in the moving image. Here, the user 440 can move the indicator 1112′ to the left side of the drawing or to the right side of the drawing by using the mouse pointer 1116.

With this, the user 440 can move the indicator 1112′ to a desired position and renders the free-viewpoint moving image corresponding to the time information of the position. That is, in FIGS. 11A and 11B, moving the indicator 1112′ is equivalent to sending, to the server device 410, a request including time information of the destination to which the indicator 1112′ is moved.

The stop button 1113 stops the rendering of the free-viewpoint moving image when pressed by the user 440 while the free-viewpoint moving image is being rendered in the moving image display area 1117. That is, in FIGS. 11A and 11B, pressing the stop button 1113 is equivalent to inputting the end condition to the server device 410.

The play button 1114 renders the free-viewpoint moving image from the current stop position (the current position of the indicator 1112′) when pressed by the user 440 while the free-viewpoint moving image is stopped in the moving image display area 1117. That is, in FIGS. 11A and 11B, pressing the play button 1114 is equivalent to transmitting, to the server device 410, a request including time information of the current stop position.

The ten-second skip button 1115 moves the rendering position 10 seconds forward or 10 seconds backward from the current rendering position (the current position of the indicator 1112′) when pressed by the user 440 while the free-viewpoint moving image is being rendered. In FIGS. 11A and 11B, pressing the ten-second skip button is equivalent to sending, to the server device 410, a request including time information of the rendering position 10 seconds forward or 10 seconds backward from the current rendering position.

In FIG. 11B, a moving image playback screen 1120 indicates a display screen after a predetermined period of time has elapsed since the moving image playback screen 1110 is displayed. As the predetermined period of time has elapsed, a motion of the subject included in the moving image display area 1117 of the moving image playback screen 1120 has changed from a motion of the subject included in the moving image display area 1117 of the moving image playback screen 1110. Additionally, the position of the indicator 1112′ in the operation instruction area 1111 of the moving image playback screen 1110 has moved to the right of the screen in the moving image playback screen 1120.

### (3) Moving Image Playback Screen 2

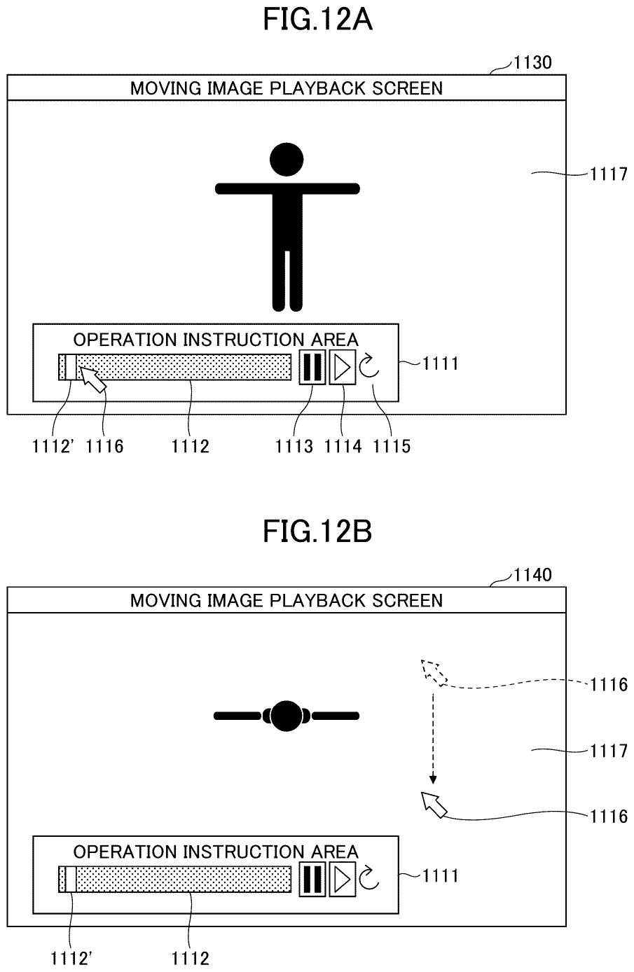

Next, another specific example of the moving image playback screen will be described. Here, a moving image playback screen will be described in the case where, after the free-viewpoint moving image of “moving image I” is rendered, the stop button 1113 is pressed by the user 440, so that the rendering of the free-viewpoint moving image of “moving image I” is stopped, and the user 440 further:
moves the indicator 1112′ of the seek bar 1112 in the operation instruction area 1111 so that time information is input, and
drags the moving image display area 1117 by the mouse pointer 1116 so that viewpoint information is input.
   FIGS. 12A and 12B are second diagrams illustrating an example of the moving image playback screen of the client terminal.

In FIG. 12A, a moving image playback screen 1130 indicates a state in which the position of the indicator 1112′ is moved to the left side of the drawing by the mouse pointer 1116 while the rendering is stopped by the stop button 1113 being pressed after the moving image playback screen 1120 is displayed.

As illustrated in the moving image playback screen 1130, because the indicator 1112′ is moved to the left side of the drawing, a frame image corresponding to the time information at the position of the indicator 1112′ is displayed in the moving image display area 1117 of the moving image playback screen 1130. Here, because the viewpoint information is not changed, a frame image is displayed when a motion that is the same as the motion of the subject included in the moving image display area 1117 of the moving image playback screen 1110 is viewed from the same viewpoint.

With respect to the above, in FIG. 12B, a moving image playback screen 1140 indicates a state in which the moving image display area 1117 is dragged downward by the mouse pointer 1116 after the moving image playback screen 1130 is displayed, so that the viewpoint is rotated upward.

As illustrated in the moving image playback screen 1140, the viewpoint of the subject included in the moving image display area 1117 is moved by the upward rotation of the viewpoint, so that a frame image of the scene viewed from above is displayed. Here, because the time information is not changed, the moving image display area 1117 of the moving image playback screen 1140 displays a frame image of a scene in which a motion that is the same as the motion of the subject included in the moving image display area 1117 of the moving image playback screen 1130 is viewed from above.

Here, in the example of the moving image playback screen 1140, the moving image display area 1117 is dragged downward by the mouse pointer 1116, but the direction in which the moving image display area 1117 is dragged is not limited to the downward direction, and the moving image display area 1117 can be dragged in any direction.

For example, it is assumed that the moving image display area 1117 is dragged to the left on the moving image playback screen 1130. In this case, the moving image display area 1117 of the moving image playback screen 1140 displays a frame image of a scene in which a motion that is the same as the motion of the subject included in the moving image display area 1117 of the moving image playback screen 1130 is viewed from the right side.

Similarly, it is assumed that the moving image display area 1117 is dragged to the right on the moving image playback screen 1130. In this case, the moving image display area 1117 of the moving image playback screen 1140 displays a frame image of a scene in which a motion that is the same as the motion of the subject included in the moving image display area 1117 of the moving image playback screen 1130 is viewed from the left side.

Here, in accordance with the above operation on the client terminal 420, for example, every time the time information is changed by the client terminal 420, the server device 410 generates a view image corresponding to the viewpoint information by using a trained reconstruction model corresponding to the changed time information. Additionally, every time the viewpoint information is changed by the client terminal 420, the server device 410 generates a view image corresponding to the changed viewpoint information in the current time information.

### (4) Moving Image Playback Screen 3

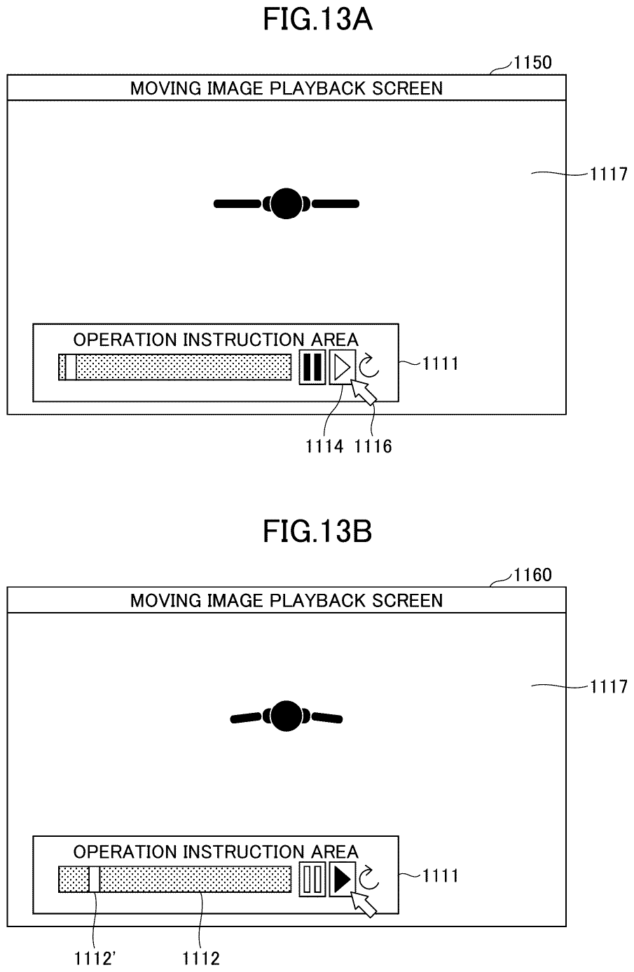

Next, another specific example of the moving image playback screen will be described. Here, the moving image playback screen will be described in the case where the user 440 presses the play button 1114 in a state where the viewpoint information is input by dragging the moving image display area 1117 downward by the mouse pointer 1116. FIGS. 13A and 13B are third diagrams illustrating an example of the moving image playback screen of the client terminal.

In FIG. 13A, a moving image playback screen 1150 indicates a state in which the play button 1114 is pressed by the user 440 after the moving image playback screen 1140 is displayed. As illustrated in the moving image playback screen 1150, when the play button 1114 is pressed by the mouse pointer 1116, the free-viewpoint moving image of “moving image 1” is rendered from the current time information based on the input viewpoint information.

In FIG. 13B, a moving image playback screen 1160 indicates a state in which a predetermined time has elapsed since the play button 1114 has been pressed on the moving image playback screen 1150. As the predetermined time has elapsed, a motion of the subject included in the moving image display area 1117 of the moving image playback screen 1160 has changed from the motion of the subject included in the moving image display area 1117 of the moving image playback screen 1150. Additionally, the position of the indicator 1112′ in the operation instruction area 1111 of the moving image playback screen 1160 has moved more toward the right side of the screen than the position of the indicator 1112′ in the operation instruction area 1111 of the moving image playback screen 1150.

Here, the moving image display area 1117 of the moving image playback screen 1160 displays a frame image of a scene in which a motion that is the same as the motion of the subject included in the moving image display area 1117 of the moving image playback screen 1120 is viewed from above.

### Flow of Free-Viewpoint Moving Image Rendering Process

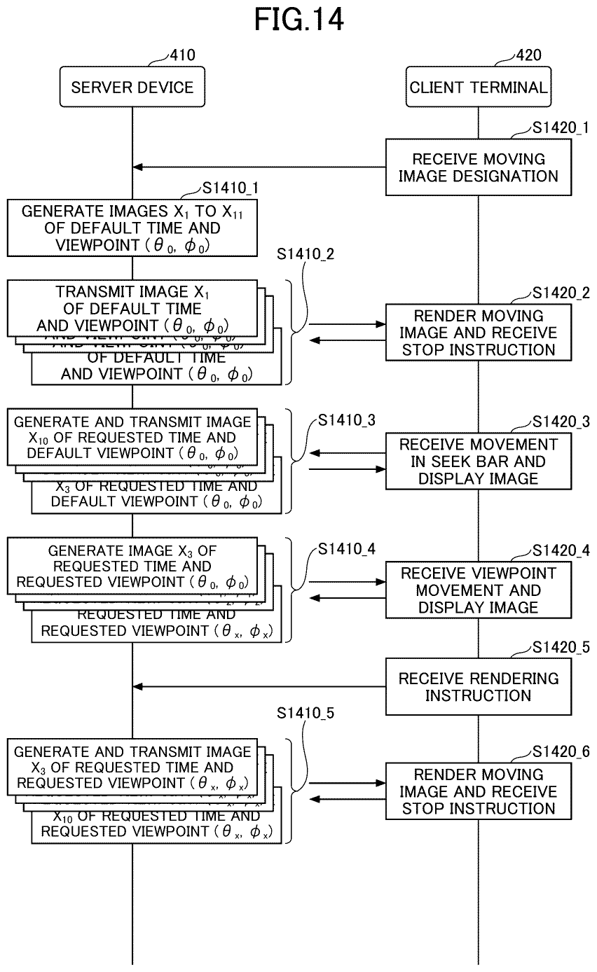

Next, a flow of free-viewpoint moving image rendering process by the free-viewpoint moving image rendering system 400 will be described. FIG. 14 is a first sequence diagram illustrating the flow of the free-viewpoint moving image rendering process by the free-viewpoint moving image rendering system.

In step S1420_1, the client terminal 420 receives the designation of the free-viewpoint moving image to be displayed from the user 440, and transmits, to the server device 410, the identification information for uniquely identifying the designated free-viewpoint moving image.

In step S1410_1, the server device 410 reads the group of the trained reconstruction models configured to generate the view images included in the designated free-viewpoint moving image. Additionally, the server device 410 inputs the default viewpoint information (θ₀, φ₀) into the read group of the trained reconstruction models to generate the view images X₁ to X₁₁.

In step S1410_2, the server device 410 sequentially transmits the generated view images to the client terminal 420.

In step S1420_2, the client terminal 420 plays back the free-viewpoint moving image using the view images transmitted from the server device 410 as frame images. Additionally, the client terminal 420 receives the stop instruction of the free-viewpoint moving image being rendered and transmits it to the server device 410. With this, the server device 410 stops transmitting the view image.

In step S1420_3, the client terminal 420 receives the movement instruction of the indicator 1112′ in the seek bar 1112. The client terminal 420 sequentially transmits, to the server device 410, the time information of each position of the moving indicator 1112′.

In step S1410_3, the server device 410 inputs the default viewpoint information into a trained reconstruction model corresponding to the time information of each position every time the time information of each position of the moving indicator 1112′ is received from the client terminal 420. With this, the server device 410 generates a view image corresponding to the time information of each position. Additionally, the server device 410 sequentially transmits the generated view image to the client terminal 420. With this, the client terminal 420 displays a view image corresponding to the time information of each position of the moving indicator 1112′.

In step S1420_4, the client terminal 420 receives the dragging of the moving image display area by the mouse pointer 1116. The client terminal 420 transmits, to the server device 410, the viewpoint information of each position of the moving mouse pointer 1116.

In step S1410_4, every time the viewpoint information of each position of the moving mouse pointer 1116 is received from the client terminal 420, the server device 410 inputs the viewpoint information for the position into a trained reconstruction model corresponding to the current time information. With this, the server device 410 generates a view image corresponding to the viewpoint information for each position. Additionally, the server device 410 sequentially transmits the generated view image to the client terminal 420. With this, the view image corresponding to the viewpoint information of each position of the moving mouse pointer 1116 is displayed on the client terminal 420.

In step S1420_5, when the play button 1114 is pressed, the client terminal 420 transmits the rendering instruction to the server device 410.

In step S1410_5, the server device 410 inputs the current viewpoint information into the trained reconstruction model corresponding to the current time information, thereby generating the view image and transmitting it to the client terminal 420. Subsequently, the server device 410 inputs the current viewpoint information into the trained reconstruction model corresponding to the next time information, thereby generating the view image and transmitting it to the client terminal 420. Hereinafter, the server device 410 repeats substantially the same processing until the end condition is transmitted from the client terminal 420.

In step S1420_6, the client terminal 420 plays back the free-viewpoint moving image using the view images transmitted from the server device 410 as frame images. Additionally, the client terminal 420 receives the stop instruction of the free-viewpoint moving image being rendered and transmits it to the server device 410. With this, the server device 410 stops generating and transmitting the view images.

### Summary

As is apparent from the above description, the server device 410 according to the first embodiment includes one or more memories and one or more processors. The one or more memories hold one or more trained reconstruction models (first reconstruction models) that have been trained in advance so as to reconstruct the scene from the first time to the second time, using the time series of captured images from the plurality of viewpoints obtained by capturing the scene from the plurality of viewpoints continuously in time. The one or more trained reconstruction models (the first reconstruction models) are trained reconstruction models for the time series of the first time interval that generate the view images of the time series of the first time interval. More specifically, the one or more trained reconstruction models (the first reconstruction models) are trained reconstruction models each having a one-to-one correspondence with different time information, and are trained reconstruction models that are trained to output image information in the corresponding time information.

Additionally, the one or more processors are configured to:
receive the request including the viewpoint information and the time information for the scene from the client terminal; and
generate the time series of view images corresponding to the viewpoint information and the time information included in the request received from the client terminal by using the one or more trained reconstruction models, and transmit the generated time series of view images in a transmission format that can be played back as a moving image by the client terminal. More specifically, the view images of the time series of the first time interval, corresponding to the viewpoint information included in the request are generated, by using the trained reconstruction models for the time series of the first time interval (the first reconstruction models) from a trained reconstruction model (the first reconstruction model) corresponding to the time information included in the request to a trained reconstruction model (the first reconstruction model) corresponding to the predetermined end condition.

As described above, according to the first embodiment, a mechanism for rendering a free-viewpoint moving image can be constructed.

### Second Embodiment

In the first embodiment described above, the model storage unit 606 holds one trained reconstruction model for each piece of time information, and one trained reconstruction model generates a view image for one piece of time information. However, the trained reconstruction model is not limited to this, and the model storage unit 606 may hold a trained reconstruction model configured to generate view images for a plurality of continuous pieces of time information. Hereinafter, a second embodiment will be described mainly with respect to differences from the first embodiment.

### Outline of Training Process of Reconstruction Model

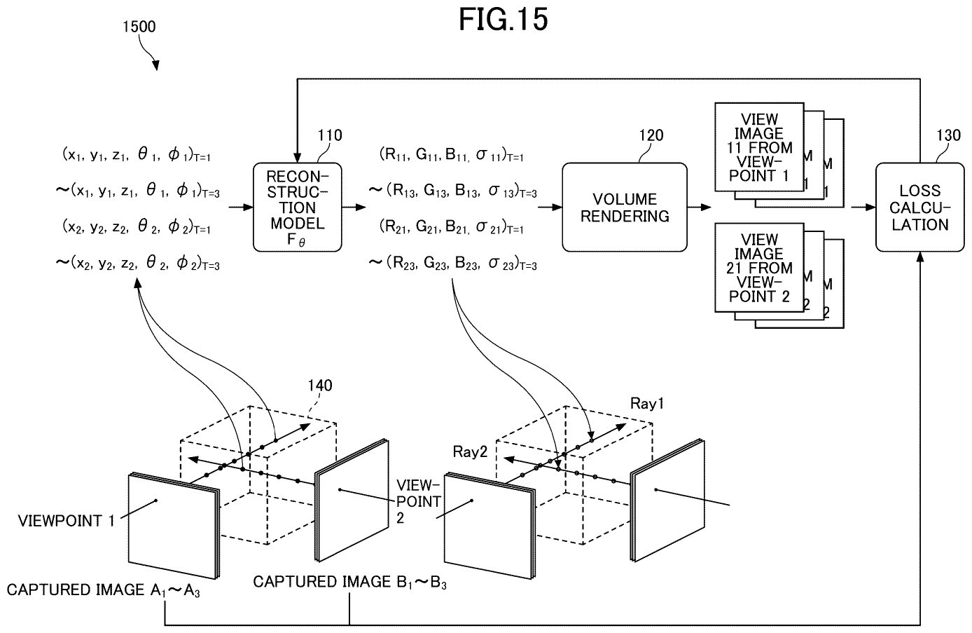

First, an outline of a training process of a reconstruction model applied to the server device 410 according to the second embodiment will be described. FIG. 15 is a second diagram for explaining the outline of the training process of the reconstruction model. The differences from the training process 100 described with reference to FIG. 1 in the first embodiment are that in the case of a training process 1500 illustrated in FIG. 15, the following information is sequentially input into the reconstruction model 110 (F_{θ}):
coordinate information for specifying coordinates of a three-dimensional point in the three-dimensional scene 140 (for example, (x₁, y₁, z₁));
viewpoint information for specifying a direction vector representing a line of sight (for example, the ray 1) from a viewpoint (for example, the viewpoint 1) with respect to the three-dimensional point (for example, the viewpoint information (θ₁, φ₁)); and
time information for specifying the time of the three-dimensional scene (for example, T=1).
   With this, with respect to the input combination of the coordinate information, viewpoint information, and time information, the reconstruction model 110 (F_{θ}) sequentially transmits a combination of:
the color of the three-dimensional point (for example, the color specified by (R₁₁, G₁₁, B₁₁)); and
the opacity of the three-dimensional point (for example, the opacity specified by σ₁₁).
   That is, the reconstruction model 110 calculates the color and opacity of the three-dimensional point from a certain viewpoint and at a certain time. Hereinafter, the coordinate information of the three-dimensional point, the viewpoint information, and the time information may be referred to as a three-dimensional point, a viewpoint, and time (or a time point), respectively.

Here, in the training process 1500, substantially the same processing is performed on the reconstruction model 110 (F_{θ}) for a plurality of viewpoints, as in the training process 100. The example of FIG. 15 indicates that substantially the same processing is performed for two viewpoints (the viewpoint 1 and the viewpoint 2).

Specifically, in the training process 1500, the following information is sequentially input into the reconstruction model 110 (F_{θ}):
a three-dimensional point in the three-dimensional scene 140 (for example, a point specified by (x₂, y₂, z₂));
viewpoint information for specifying a direction vector representing a line of sight (for example, the ray 2) from the viewpoint 2 with respect to the three-dimensional point (for example, viewpoint information (θ₂, φ₂)); and
time information for specifying the time of the three-dimensional scene (for example, T=1).
   With this, with respect to the input combination of the three-dimensional point, the viewpoint information, and the time information, the reconstruction model 110 (F_{θ}) sequentially outputs a combination of:
the color of the three-dimensional point (for example, the color specified by (R₂₁, G₂₁, B₂₁)); and
the opacity of the three-dimensional point (for example, the opacity specified by σ₂₁).

Additionally, in the training process 1500, the volume rendering process 120 is performed on the combination of the color and opacity of the three-dimensional point sequentially output from the reconstruction model 110 (F_{θ}) for each of the plurality of three-dimensional points on each line of sight (for example, the viewpoint 1 and the viewpoint 2), as in the training process 100.

In the present embodiment, the volume rendering process 120 calculates the color of each pixel of an image visible from a certain viewpoint at a certain time by using a volume rendering method. Specifically, the volume rendering process 120 calculates the color of each pixel at a certain time by performing volume rendering using a predetermined sum-of-products operation based on the color and opacity output from the reconstruction model 110 (F_{θ}) for each of a plurality of three-dimensional points on a line of sight connecting the pixel and the viewpoint. As a result, the volume rendering process 120 generates a view image from the certain viewpoint at the certain time. An example of FIG. 15 indicates a state in which view images from the viewpoint 1 in the respective time information (view images 11 to 13 from the viewpoint 1) and view images from the viewpoint 2 in the respective time information (view images 21 to 23 from the viewpoint 2) are generated by the volume rendering process 120.

Additionally, in the training process 1500 illustrated in FIG. 15, the loss calculation process 130 is performed on the generated view images from the viewpoints in the respective time information (the view images 11 to 13 from the viewpoint 1 and the view images 21 to 23 from the viewpoint 2).

For example, the view images from the viewpoint 1 in the respective time information (view images 11 to 13 from the viewpoint 1) are compared with the captured images (the captured images A₁ to A₃) in the respective time information captured by the imaging device having the viewpoint 1 to calculate the errors. Additionally, the view images from the viewpoint 2 in the respective time information (view images 21 to 23 from the viewpoint 2) are compared with the captured images (the captured images B₁ to B₃) in the respective time information captured by the imaging device having the viewpoint 2 to calculate the errors.

The error calculated in the loss calculation process 130 is backpropagated through the reconstruction model 110 (F_{θ}) by the error backpropagation method in the update process of the reconstruction model 110 (F_{θ}). With this, the model parameters of the reconstruction model 110 (F_{θ}) are updated. The model parameters are updated by the training process of the reconstruction model 110 (F_{θ}), thereby generating the trained reconstruction model (F_{θ}), according to the training process 1500 illustrated in FIG. 15.

Here, in order to simplify the description, the case in which the training process is performed using a captured image captured by an imaging device having a viewpoint other than the viewpoints 1 and 2 is omitted here, but a captured image captured by an imaging device having a viewpoint other than the viewpoints 1 and 2 may be used in the training process.

Outline of Image Generation Process Using Trained Reconstruction model

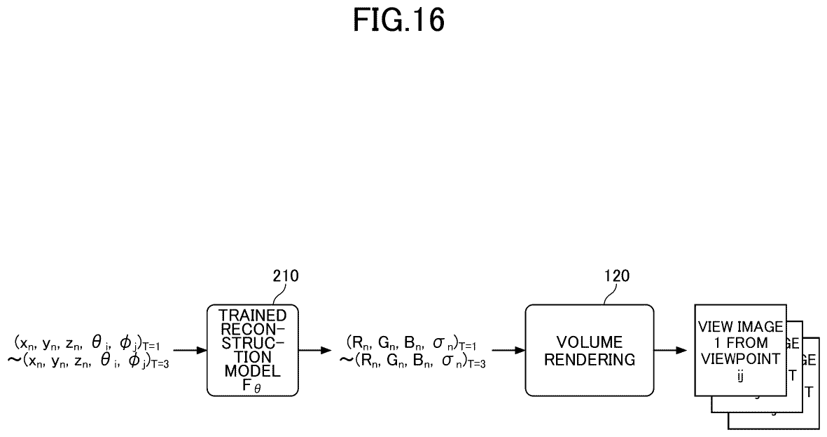

Next, an outline of an image generation process using the trained reconstruction model applied to the server device 410 according to the second embodiment will be described. FIG. 16 is a second diagram for explaining the outline of the image generation process using the trained reconstruction model.

As illustrated in FIG. 16, in the image generation process for generating view images from the viewpoint ij in the time information T, the three-dimensional point (xₙ, yₙ, zₙ) related to the viewpoint ij, the viewpoint information (θᵢ, φⱼ), and the time information T are input into the trained reconstruction model 210 (F_{θ}), and the color and opacity of each three-dimensional point in the time information T are calculated as the output. Then, in the image generation process, the volume rendering process 120 based on the calculated color and opacity of the three-dimensional point is performed for each pixel of a view image, thereby generating a view image from the viewpoint ij in the time information T. In the image generation process, by sequentially inputting different pieces of time information T into the trained reconstruction model 210 (F_{θ}), view images (view images 1 to 3 from the viewpoint ij) in different pieces of time information (for example, T=1, 2, 3) are sequentially generated.

### Relationship Between Captured Image and Trained Reconstruction Model

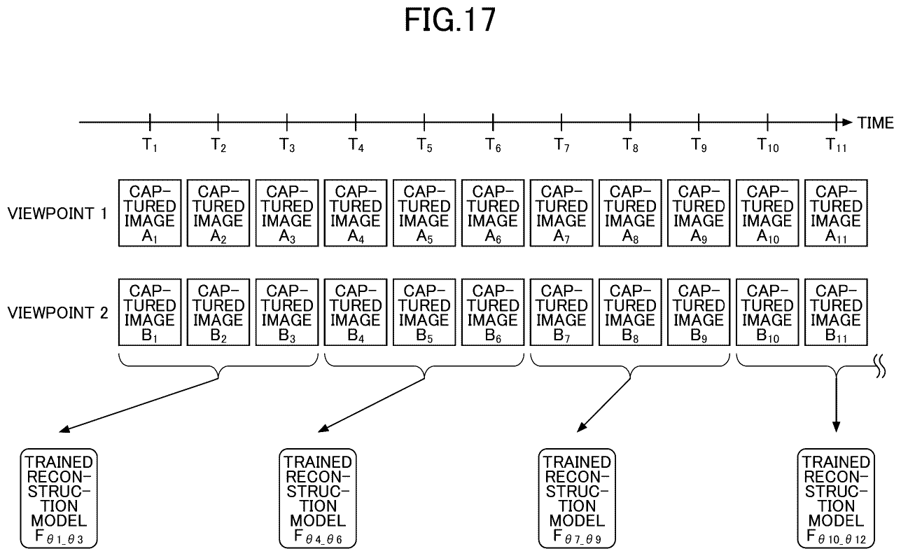

Next, trained reconstruction models applied to the server device 410 according to the second embodiment will be described. FIG. 17 is a second diagram illustrating an example of the trained reconstruction models applied to the server device. Here, FIG. 17 also illustrates the case where two viewpoints, which are the viewpoint 1 and the viewpoint 2, are used for the sake of simplification of explanation, but as described above, a captured image captured by an imaging device having a viewpoint other than the viewpoint 1 and the viewpoint 2 may be used in the training process.

As illustrated in FIG. 17, a group of the trained reconstruction models that are trained in advance so as to reconstruct a scene from the first time to the second time by using a time series of captured images obtained by capturing the scene from each of a plurality of viewpoints continuously in time is applied to the server device 410.

Specifically, a trained reconstruction model F_{θ1_θ3} on which a training process has been performed using the following captured images is applied to the server device 410:
captured images A₁ to A₃ captured by the imaging device having the viewpoint 1 in time information T₁ to time information T₃; and
captured images B₁ to B₃ captured by the imaging device having the viewpoint 2 in the time information T₁ to the time information T₃.

Similarly, a trained reconstruction model F_{θ4_θ6} on which a training process has been performed using the following captured images is applied to the server device 410:
captured images A₄ to A₆ captured by the imaging device having the viewpoint 1 in time information T₄ to time information T₆; and
captured images B₄ to B₆ captured by the imaging device having the viewpoint 2 in time information T₄ to time information T₆.

Hereinafter, in the example of FIG. 17, the trained reconstruction models up to the trained reconstruction model F_{θ10_θ12} of the time information T₁₁ are illustrated for the sake of space, but the number of the trained reconstruction models applied to the server device 410 is not limited to 4. However, it is assumed that all of the trained reconstruction models are associated with the respective time information and are managed as the trained reconstruction models for the time series.

Here, in FIG. 17, the time information T₁, T₄, T₇, . . . corresponds to a second time interval that is longer than the frame period (an example of the first time interval) of the captured images A₁, A₂, . . . or the captured images B₁, B₂, . . . captured by the imaging device during the training process. That is, the trained reconstruction models for the time series of the second time interval (an example of second reconstruction models) configured to generate the view images of the time series of the first time interval are applied to the server device 410.

### Example of Trained Reconstruction Model

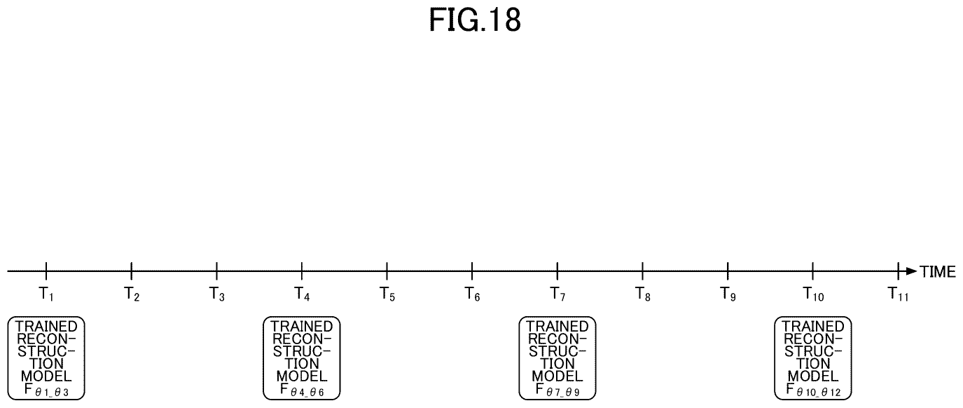

Next, the trained reconstruction model held by the model storage unit 606 in the server device 410 according to the second embodiment will be described. FIG. 18 is a diagram illustrating an example of the trained reconstruction models held by the model storage unit of the server device according to the second embodiment.

As illustrated in FIG. 18, the trained reconstruction models held by the model storage unit 606 are associated with the time information. Specifically, the trained reconstruction model F_{θ1_θ3} is associated with the time information T₁ to T₃, and the trained reconstruction model F_{θ4_θ6} is associated with the time information T₄ to T₆. Similarly, the example of FIG. 18 illustrates that the trained reconstruction models F_{θ7_θ9} and F_{θ10_θ12} are associated with the time information T₇ to T₉ and T₁₀ to T₁₂, respectively. That is, each model has time information to which it corresponds (supports). The association between the time information and the trained reconstruction model may be made by directly associating the time information with the trained reconstruction model, or by indirectly associating the time information with the trained reconstruction model through other data.

The server device 410 generates a time series of view images corresponding to viewpoint information and time information included in the request received from the client terminal 420 by using the trained reconstruction model held by the model storage unit 606.

Here, in FIG. 18, as described above, the time information T₁, T₂, T₃, . . . corresponds to the frame period of the captured images captured by the imaging device during the training process. Therefore, the time information T₁, T₂, T₃. . . corresponds to a frame period when a free-viewpoint moving image is rendered in the free-viewpoint moving image rendering system 400.

Additionally, as illustrated in FIG. 18, the trained reconstruction models associated with the respective time information are mutually different trained reconstruction models. The different trained reconstruction models herein are configured by NNs to which the NeRF technique is applied, and are trained with mutually different training data (captured images). The architectures of the NNs may be the same or partially different.

Here, each of the trained reconstruction models illustrated in FIG. 18 can generate a view image (a free-viewpoint image) from an arbitrary viewpoint for the scene in the time information.

Additionally, as illustrated in FIG. 18, the model storage unit 606 holds at least a group of trained reconstruction models configured to generate view images for a series of scenes for one single object. However, the group of trained reconstruction models held by the model storage unit 606 is not limited to one, and there may be another group of trained reconstruction models configured to generate view images for a series of scenes for another single object.

Additionally, as illustrated in FIG. 18, the group of trained reconstruction models held by the model storage unit 606 includes four trained reconstruction models corresponding to the time information T₁ to T₁₁ for the sake of space. However, the number of the trained reconstruction models included in the group of trained reconstruction models held by the model storage unit 606 is not limited to this.

### Specific Example of Processing by Server Device

Next, a specific example of processing by the default moving image generation unit 602 and the requested moving image generation unit 604 of the server device 410 according to the second embodiment will be described.

### (1) Specific Example of Processing by Default Moving Image Generation Unit

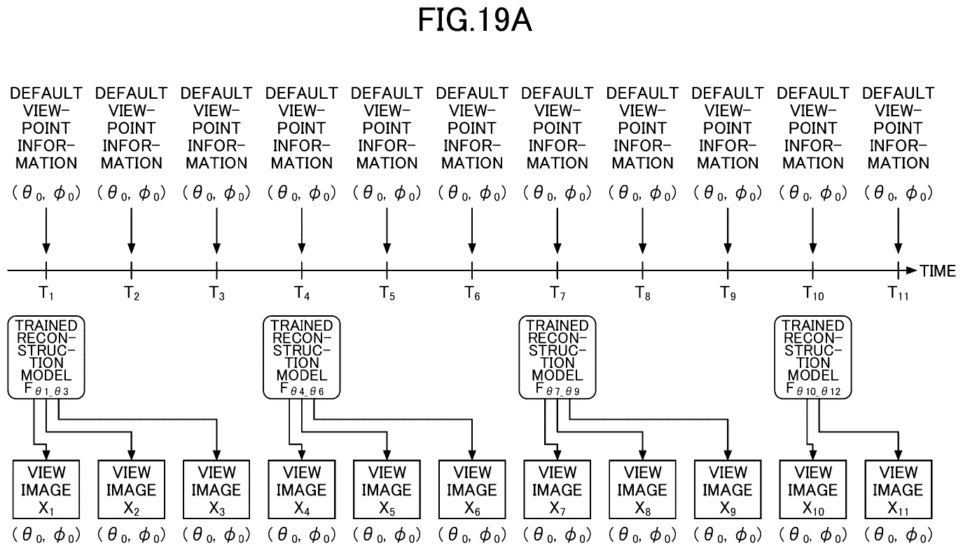

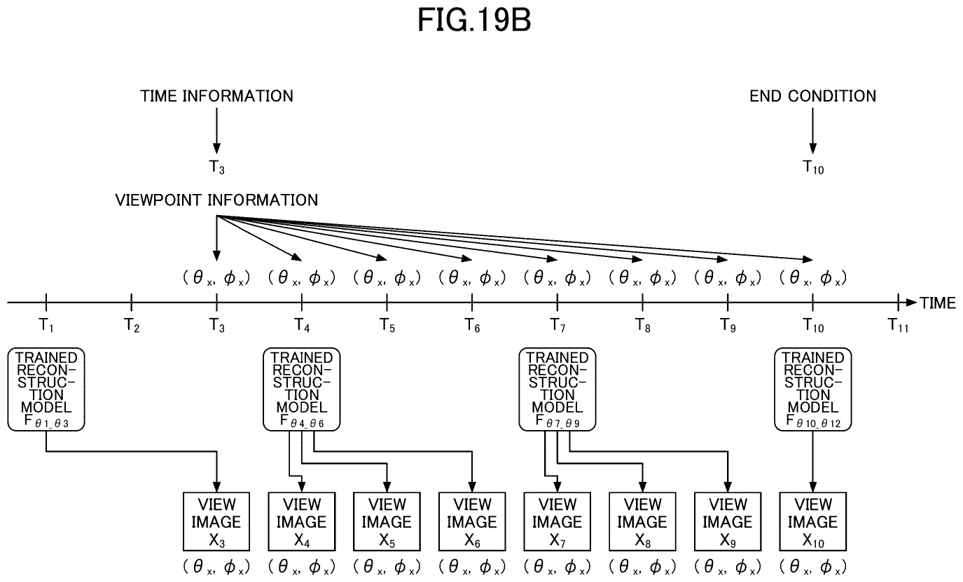

First, a specific example of processing by the default moving image generation unit 602 will be described. FIG. 19A is a first diagram illustrating a specific example of the processing by the server device 410 according to the second embodiment. FIG. 19A illustrates a specific example of the processing when the moving image designation receiving unit 601 receives a designation of a free-viewpoint moving image and the default moving image generation unit 602 receives the notification of the identification information of the designated free-viewpoint moving image from the moving image designation receiving unit 601.

As illustrated in FIG. 19A, the default moving image generation unit 602 reads the trained reconstruction models F_{θ1_θ3} to F_{θ10_θ12} configured to generate view images included in the designated free-viewpoint moving image from the model storage unit 606.

Additionally, the default moving image generation unit 602 inputs the default viewpoint information (θ₀, φ₀) and the time information into each of the read trained reconstruction models F_{θ1_θ3} to F_{θ10_θ12}. With this, the trained reconstruction models F_{θ1_θ3} to F_{θ10_θ12} generate the view images X₁ to X₁₁ of a scene viewed from a viewpoint based on the default viewpoint information (θ₀, φ₀) in the respective time information.

Additionally, the default moving image generation unit 602 notifies the moving image transmitting unit 605 of the generated view images X₁ to X₁₁ in association with the time information T₁ to T₁₁. With this, the moving image transmitting unit 605 transmits the view images X₁ to X₁₁ in a transmission format that can be played back as a moving image by the client terminal 420.

### (2) Specific Example of Processing by Requested Moving Image Generation Unit

As described above, it is assumed that the client terminal 420 plays back the free-viewpoint moving image using the view images X₁ to X₁₁ as frame images of the scene viewed from the viewpoint based on the default viewpoint information (θ₀, φ₀) in the respective time information. Additionally, it is assumed that a request including the time information and the viewpoint information is transmitted from the client terminal 420 in response to this. In this case, the request receiving unit 603 receives the request and notifies the requested moving image generation unit 604.

Here, a specific example of processing by the requested moving image generation unit 604 when the request (time information and viewpoint information) is notified by the request receiving unit 603 will be described. FIG. 19B is a second diagram illustrating a specific example of the processing by the server device according to the second embodiment, and illustrates a specific example of the processing by the requested moving image generation unit 604 when the request is notified by the request receiving unit 603.

As illustrated in FIG. 19B, the requested moving image generation unit 604 identifies the trained reconstruction model F_{θ1_θ3} corresponding to the time information (in the example of FIG. 19B, T₃) included in the request among the trained reconstruction models F_{θ1_θ3} to F_{θ10_θ12} that are already read.

Additionally, the requested moving image generation unit 604 inputs the time information (in the example of FIG. 19B, T₃) and the viewpoint information (in the example of FIG. 19B, (θₓ, φₓ)) included in the request into the identified trained reconstruction model F_{θ1_θ3}. With this, the trained reconstruction model F_{θ1_θ3} generates the view image X₃ of the scene viewed from the viewpoint based on the viewpoint information (θₓ, φₓ) included in the request in the time information T₃.

Subsequently, the requested moving image generation unit 604 identifies the trained reconstruction model F_{θ4_θ6} as the next trained reconstruction model. Additionally, the requested moving image generation unit 604 sequentially inputs the respective time information (in the example of FIG. 19B, T₄, T₅, T₆) and the viewpoint information (in the example of FIG. 19B, (θₓ, φₓ)) included in the request into the identified trained reconstruction model F_{θ4_θ6}. With this, the trained reconstruction model F_{θ4_θ6} sequentially generates the view images X₄ to X₆ in the respective time information T₄ to T₆ of the scene viewed from the viewpoint based on the viewpoint information (θₓ, φₓ) included in the request.

Hereinafter, the requested moving image generation unit 604 repeats substantially the same processing until an end condition is transmitted from the client terminal 420. The example of FIG. 19B indicates a state in which the time information T₁₀ is transmitted as the end condition from the client terminal 420.

When the time information T₁₀ is transmitted as the end condition from the client terminal 420, the requested moving image generation unit 604 identifies the trained reconstruction model F_{θ10_θ12} corresponding to the time information T₁₀ transmitted as the end condition as the last trained reconstruction model. Additionally, the requested moving image generation unit 604 inputs the time information T₁₀ and the viewpoint information (in the example of FIG. 19B, (θₓ, φₓ)) included in the request into the identified trained reconstruction model F_{θ10_θ12}. With this, the trained reconstruction model F_{θ10_θ12} generates the view image X₁₀ of the scene viewed from the viewpoint based on the viewpoint information (θₓ, φₓ) included in the request in the time information T₁₀.

As described above, the requested moving image generation unit 604 generates the view images of the time series of the first time interval, corresponding to the viewpoint information, using the trained reconstruction models for the time series of the second time interval from the trained reconstruction model corresponding to the time information contained in the request to the trained reconstruction model corresponding to the predetermined end condition.

The requested moving image generation unit 604 sequentially notifies the moving image transmitting unit 605 of the generated view images X₃ to X₁₀ in association with the time information T₃ to T₁₀. With this, the moving image transmitting unit 605 can transmit the view images X₃ to X₁₀ in a transmission format that can be played back as a moving image by the client terminal 420.

### Summary

As is apparent from the above description, one or more memories included in the server device 410 according to the second embodiment hold the trained reconstruction models (the second reconstruction models) that are configured to generate the view images of the time series of the first time interval, and that are the trained reconstruction models for the time series of the second time interval that is longer than the first time interval. One or more trained reconstruction models (the second reconstruction models) are held, and each of the one or more trained reconstruction models (the second reconstruction models) is a trained reconstruction model trained to output image information in the input time information.

Additionally, one or more processors included in the server device 410 according to the second embodiment generates the view images of the time series of the first time interval, corresponding to the viewpoint information included in the request, using the trained reconstruction models for the time series of the second time interval (the second reconstruction models) from the trained reconstruction model (the second reconstruction model) corresponding to the time information included in the request to the trained reconstruction model (the second reconstruction model) corresponding to the predetermined end condition.

With this, according to the second embodiment, a mechanism different from that of the first embodiment can be constructed as a mechanism for rendering a free-viewpoint moving image.

### Third Embodiment

In the second embodiment described above, the case in which, as the trained reconstruction model configured to generate view images of the plurality of continuous pieces of time information, the model storage unit 606 holds the trained reconstruction model configured to generate view images of three continuous pieces of time information has been described. However, as the trained reconstruction model configured to generate view images of the plurality of continuous pieces of time information, the model storage unit 606 may hold a trained reconstruction model configured to generate view images of time information of the entire time range. Here, the entire time range refers to a finite time range captured by the imaging device, and in a third embodiment, it is described as, for example, three minutes. When the frame period is 30 fps, the free-viewpoint moving image of three minutes includes 5400 frame images.

### Outline of Training Process of Reconstruction Model

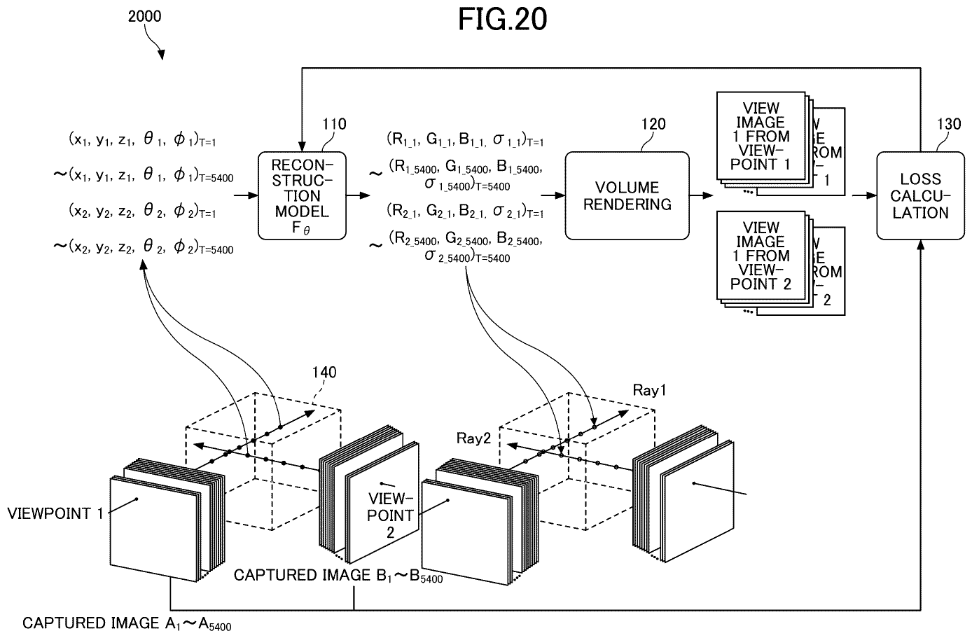

First, an outline of a training process of the reconstruction model applied to the server device 410 according to the third embodiment will be described. FIG. 20 is a third diagram for explaining the outline of the training process of the reconstruction model. The differences from the training process 1500 described with reference to FIG. 15 in the second embodiment are that in the case of a training process 2000 illustrated in FIG. 20, the following information is sequentially input into the reconstruction model 110 (F_{θ}):
a three-dimensional point in the three-dimensional scene 140 (for example, a point identified by (x₁, y₁, z₁));
viewpoint information for specifying a direction vector representing a line of sight (for example, the ray 1) from the viewpoint 1 with respect to the three-dimensional point (for example, viewpoint information (θ₁, φ₁)); and
respective time information corresponding to the three-dimensional point and the viewpoint information (for example, T=1 to T=5400).
   With this, with respect to the input combination of the three-dimensional point, the viewpoint information, and the time information, the reconstruction model 110 (F_{θ}) sequentially transmits a combination of:
the colors of the three-dimensional point in the respective time information (for example, colors specified by (R_{1_1}, G_{1_1}, B_{1_1}) to (R_{1_5400}, G_{1_5400}, B_{1_5400})); and
the opacities of the three-dimensional point in the respective time information (for example, opacities specified by σ_{1_1}, to σ_{1_5400}).
   That is, the reconstruction model 110 (F_{θ}) calculates the colors and opacities of a certain three-dimensional point from a certain viewpoint and at a certain time.

Here, in the training process 2000, substantially the same processing is performed on the reconstruction model 110 (F_{θ}) for a plurality of viewpoints, as in the training process 1500. The example of FIG. 20 indicates that substantially the same processing is performed for two viewpoints (the viewpoint 1 and the viewpoint 2).

Specifically, in the training process 2000, the following information is further sequentially input into the reconstruction model 110 (F_{θ}):
a three-dimensional point in the three-dimensional scene 140 (for example, a point identified by (x_{2_1}, y_{2_1}, z_{2_1}));
viewpoint information for specifying a direction vector representing a line of sight (for example, the ray 2) from the viewpoint 2 with respect to the three-dimensional point (for example, viewpoint information (θ₂, φ₂)); and
respective time information corresponding to the three-dimensional point and viewpoint information (for example, T=1 to T=5400).
   With this, with respect to the input combination of the three-dimensional point, the viewpoint information, and the time information, the reconstruction model 110 (F_{θ}) sequentially outputs a combination of:
the colors of the three-dimensional point in the time information (for example, colors specified by (R_{2_1}, G_{2_1}, B_{2_1}) to (R_{2_5400}, G_{2_5400}, B_{2_5400})); and
the opacities of the three-dimensional point in the time information (for example, opacities specified by σ_{2_1} to σ_{2_5400}).

Additionally, in the training process 2000, the volume rendering process 120 is performed on the combination of the color and opacity of the three-dimensional point sequentially output from the reconstruction model 110 (F_{θ}) for each of the three-dimensional points on the line of sight for each of the viewpoints (e.g., the viewpoints 1 and 2), as in the training process 1500.

In the present embodiment, the volume rendering process 120 calculates the color of each pixel of an image seen from a certain viewpoint at a certain time by using a volume rendering method. Specifically, the volume rendering process 120 calculates the color of each pixel at a certain time by performing volume rendering using a predetermined sum-of-products operation based on the color and opacity output from the reconstruction model 110 (F_{θ}) for each of the plurality of three-dimensional points on the line of sight connecting the pixel to the viewpoint,. As a result, the volume rendering process 120 generates a view image from a certain viewpoint at a certain time. The example of FIG. 20 indicates a state in which view images from the viewpoint 1 in the respective time information (view images 1 to 5400 from the viewpoint 1) and view images from the viewpoint 2 in the respective time information (view images 1 to 5400 from the viewpoint 2) are generated by the volume rendering process 120.

Additionally, in the training process 2000 illustrated in FIG. 20, the loss calculation process 130 is performed on the generated view images from the viewpoint 1 in the respective time information (the view images 1 to 5400 from the viewpoint 1). Additionally, in the training process 2000 illustrated in FIG. 20, the loss calculation process 130 is performed on the generated view images from the viewpoint 2 in the respective time information (the view images 1 to 5400 from the viewpoint 2).

Specifically, the view images from the viewpoint 1 in the respective time information (the view images 1 to 5400 from the viewpoint 1) are compared with captured images (captured images A₁ to A₅₄₀₀) in the respective time information captured by the imaging device having the viewpoint 1 to calculate the error. Additionally, the view images from the viewpoint 2 in the respective time information (the view images 1 to 5400 from the viewpoint 2) are compared with captured images (captured images B₁ to B₅₄₀₀) in the respective time information captured by the imaging device having the viewpoint 2 to calculate the error.

The error calculated in the loss calculation process 130 is backpropagated through the reconstruction model 110 (F_{θ}) by the error backpropagation method in the update process of the reconstruction model 110 (F_{θ}). With this, the model parameters of the reconstruction model 110 (F_{θ}) are updated. The model parameters are updated by the training process of the reconstruction model 110 (F_{θ}), thereby generating the trained reconstruction model (F_{θ}), according to the training process 2000 illustrated in FIG. 20.

Here, in order to simplify the description, the case in which the training process is performed using a captured image captured by an imaging device having a viewpoint other than the viewpoints 1 and 2 is omitted here, but a captured image captured by an imaging device having a viewpoint other than the viewpoints 1 and 2 may be used in the training process.

### Outline of Image Generation Process Using Trained Reconstruction Model

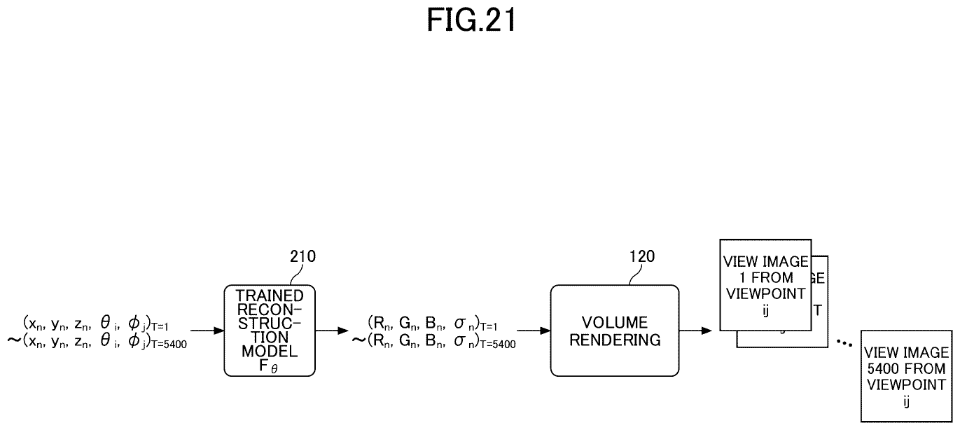

Next, an outline of an image generation process using the trained reconstruction model applied to the server device 410 according to the third embodiment will be described. FIG. 21 is a third diagram for explaining the outline of the image generation process using the trained reconstruction model.

As illustrated in FIG. 21, in the image generation process for generating view images from the viewpoint ij in the time information T, the three-dimensional point (xₙ, yₙ, zₙ) related to the viewpoint ij, the viewpoint information (θᵢ, φⱼ), and the time information T are input into the trained reconstruction model 210 (F_{θ}), and the color and opacity of each three-dimensional point in the time information T are calculated as the output. Then, in the image generation process, the volume rendering process 120 based on the calculated color and opacity of the three-dimensional point is performed for each pixel of a view image, thereby generating a view image from the viewpoint ij in the time information T. In the image generation process, different pieces of time information T are sequentially input into the trained reconstruction model 210 (F_{θ}), thereby sequentially generating view images (the view images 1 to 5400 from the viewpoint ij) in the different pieces of time information (for example, T=1˜5400).

### Relationship Between Captured Image and Trained Reconstruction Model

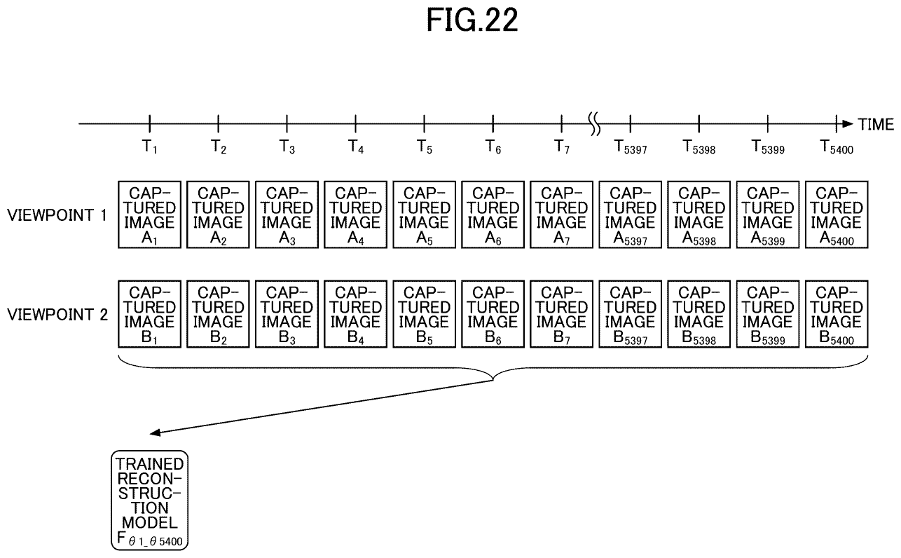

Next, a trained reconstruction model applied to the server device 410 according to the third embodiment will be described. FIG. 22 is a third diagram illustrating an example of the trained reconstruction model applied to the server device. Here, FIG. 22 also illustrates the case where two viewpoints, which are the viewpoint 1 and the viewpoint 2, are used for the sake of simplification of explanation, but as described above, a captured image captured by an imaging device having a viewpoint other than the viewpoint 1 and the viewpoint 2 may be used in the training process.

As illustrated in FIG. 22, a trained reconstruction model that is trained in advance so as to reconstruct a scene from the first time to the second time by using a time series of captured images obtained by capturing the scene from each of a plurality of viewpoints continuously in time is applied to the server device 410.

Specifically, a trained reconstruction model F_{θ1_θ5400} on which a training process has been performed using the following captured images is applied to the server device 410:
captured images A₁ to A₅₄₀₀ captured by the imaging device having the viewpoint 1 in time information T₁ to time information T₅₄₀₀; and
captured images B₁ to B₅₄₀₀ captured by the imaging device having the viewpoint 2 in the time information T₁ to the time information T₅₄₀₀.

Here, in FIG. 22, the time information T₁, T₂, T₃, . . . corresponds to a frame period (an example of the first time interval) of the captured images A₁, A₂, . . . or the captured images B₁, B₂, . . . captured by the imaging device during the training process. That is, the trained reconstruction model (an example of a third reconstruction model) configured to generate view images of the time series of the first time interval is applied to the server device 410.

### Example of Trained Reconstruction Model

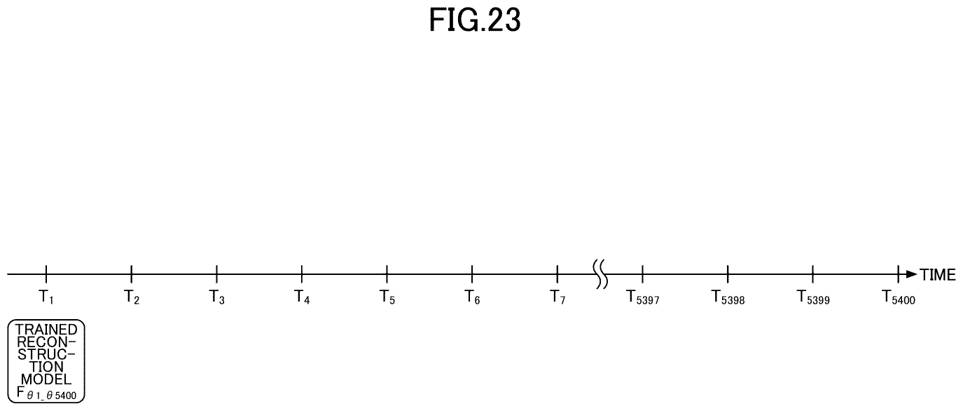

Next, the trained reconstruction model held by the model storage unit 606 in the server device 410 according to the third embodiment will be described. FIG. 23 is a diagram illustrating an example of the trained reconstruction model held by the model storage unit of the server device according to the third embodiment.

As illustrated in FIG. 23, the trained reconstruction model held by the model storage unit 606 is associated with time information. Specifically, the trained reconstruction model F_{θ1_θ5400} is associated with the time information T₁ to T₅₄₀₀.

The server device 410 generates a time series of view images corresponding to viewpoint information and time information included in the request received from the client terminal 420 by using the trained reconstruction model held by the model storage unit 606.

Here, in FIG. 23, as described above, the time information T₁, T₂, T₃, . . . corresponds to the frame period of the captured images captured by the imaging device during the training process. Therefore, the time information T₁, T₂, T₃, . . . corresponds to a frame period when a free-viewpoint moving image is rendered in the free-viewpoint moving image rendering system 400.

Additionally, the trained reconstruction model illustrated in FIG. 23 can generate a view image (a free-viewpoint image) from an arbitrary viewpoint for the scene in the time information.

Additionally, as illustrated in FIG. 23, the model storage unit 606 holds at least one trained reconstruction model configured to generate view images for a series of scenes for one single object. However, the trained reconstruction model held by the model storage unit 606 is not limited to one, and another trained reconstruction model configured to generate view images for a series of scenes for another single object may be held.

### Specific Example of Processing by Server Device

Next, a specific example of processing by the default moving image generation unit 602 and the requested moving image generation unit 604 of the server device 410 according to the third embodiment will be described.

### (1) Specific Example of Processing by the Default Moving Image Generation Unit

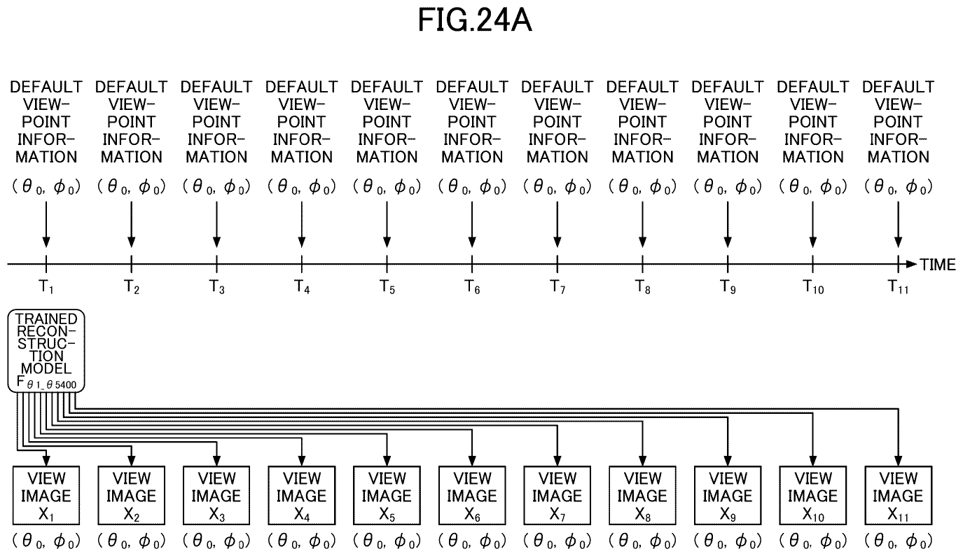

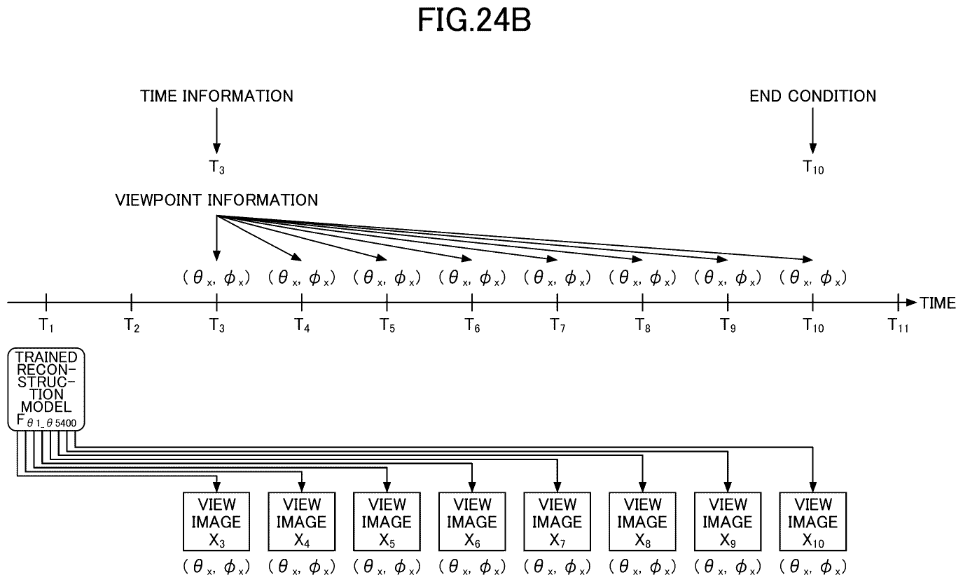

First, a specific example of processing by the default moving image generation unit 602 will be described. FIG. 24A is a first diagram illustrating a specific example of the processing by the server device 410 according to the third embodiment. FIG. 24A illustrates a specific example of processing when the moving image designation receiving unit 601 receives a designation of a free-viewpoint moving image and the default moving image generation unit 602 receives notification of identification information of the designated free-viewpoint moving image from the moving image designation receiving unit 601.

As illustrated in FIG. 24A, the default moving image generation unit 602 reads the trained reconstruction model F_{θ1_θ5400} configured to generate view images included in the designated free-viewpoint moving image from the model storage unit 606.

Additionally, the default moving image generation unit 602 sequentially inputs the default viewpoint information (θ₀, φ₀) and respective time information into the read trained reconstruction model F_{θ1_θ5400}. With this, the trained reconstruction model F_{θ1_θ5400} sequentially generates view images X₁ to X₅₄₀₀ of a scene viewed from a viewpoint based on the default viewpoint information (θ₀, φ₀) in the respective time information.

Additionally, the default moving image generation unit 602 notifies the moving image transmitting unit 605 of the generated view images X₁ to X₅₄₀₀ in association with the time information T₁ to T₅₄₀₀. With this, the moving image transmitting unit 605 transmits the view images X₁ to X₅₄₀₀ in a transmission format that can be played back as a moving image by the client terminal 420.

### (2) Specific Example of Processing by Requested Moving Image Generation Unit

As described above, it is assumed that the client terminal 420 plays back a free-viewpoint moving image using the view images X₁ to X₅₄₀₀ as frame images of the scene viewed from the viewpoint based on the default viewpoint information (θ₀, φ₀) in the respective time information. Additionally, it is assumed that a request including the time information and the viewpoint information is transmitted from the client terminal 420 in response to this. In this case, the request receiving unit 603 receives the request and notifies the requested moving image generation unit 604 of the request.

Here, a specific example of processing performed by the requested moving image generation unit 604 when the request (time information and viewpoint information) is notified by the request receiving unit 603 will be described. FIG. 24B is a second diagram illustrating the specific example of the processing by the server device according to the third embodiment, and illustrates a specific example of the processing by the requested moving image generation unit 604 when the request is notified by the request receiving unit 603.

As illustrated in FIG. 24B, the requested moving image generation unit 604 identifies the trained reconstruction model F_{θ1_θ5400} that has already been read.

Additionally, the requested moving image generation unit 604 inputs the time information (in the example of FIG. 24B, T₃) and the viewpoint information (in the example of FIG. 24B, (θₓ, φₓ)) included in the request into the identified trained reconstruction model F_{θ1_θ5400}. With this, the trained reconstruction model F_{θ1_θ5400} generates the view image X₃ of the scene viewed from the viewpoint based on the viewpoint information (θₓ, φₓ) in the time information T₃ included in the request.

Subsequently, the requested moving image generation unit 604 inputs the next time information T₄ and the viewpoint information (in the example of FIG. 24B, (θₓ, φₓ)) included in the request into the identified trained reconstruction model F_{θ1_θ5400}. With this, the trained reconstruction model F_{θ1_θ5400} generates the view image X₄ of the scene viewed from the viewpoint based on the viewpoint information (θₓ, φₓ) in the time information T₄ included in the request.

Hereinafter, the requested moving image generation unit 604 repeats substantially the same processing until an end condition is transmitted from the client terminal 420. The example of FIG. 24B indicates a state in which the time information T₁₀ is transmitted as the end condition from the client terminal 420.

When the time information T₁₀ is transmitted as the end condition from the client terminal 420, the requested moving image generation unit 604 inputs, into the identified trained reconstruction model F_{θ1_θ5400}:
the time information T₁₀ as the end condition; and
the viewpoint information (in the example of FIG. 24B, (θₓ, φₓ)) included in the request.
   With this, the trained reconstruction model F_{θ1_θ5400} generates the view image X₁₀ of the scene viewed from the viewpoint based on the viewpoint information (θₓ, φₓ) in the time information T₁₀ included in the request.

As described above, the requested moving image generation unit 604 uses the trained reconstruction model to generate the view images of the time series of a frame period from the time information included in the request to a predetermined end condition, corresponding to the viewpoint information.

The requested moving image generation unit 604 sequentially notifies the moving image transmitting unit 605 of the generated view images X₃ to X₁₀ in association with the time information T₃ to T₁₀. With this, the moving image transmitting unit 605 can transmit the view images X₃ to X₁₀ in a transmission format that can be played back as a moving image by the client terminal 420.

### Summary

As is apparent from the above description, one or more memories included in the server device 410 according to the third embodiment hold the trained reconstruction model (the third reconstruction model) configured to generate the view images of the time series of the first time interval. The trained reconstruction model (the third reconstruction model) is a single trained reconstruction model trained to output, in response to time information being input, image information corresponding to the input time information.

Additionally, one or more processors included in the server device 410 according to the third embodiment generate the view images of the time series of the first time interval from the time information included in the request to the predetermined end condition, corresponding to the viewpoint information included in the request, by using the trained reconstruction model (the third reconstruction model).

With this, according to the third embodiment, a mechanism different from those of the first and second embodiments can be constructed as a mechanism for rendering a free-viewpoint moving image.

### Fourth Embodiment

In the first embodiment described above, the model storage unit 606 holds one trained reconstruction model for each piece of time information, and one trained reconstruction model generates a view image for one piece of time information. However, the trained reconstruction model held by the model storage unit 606 for each piece of time information is not limited to this, and the model storage unit 606 may hold, for example, a trained difference reconstruction model configured to generate a difference image from a view image generated by a trained reconstruction model for the immediately preceding time information. Hereinafter, a fourth embodiment will be described mainly with respect to differences from the first embodiment.

### Outline of Training Process of Reconstruction Model

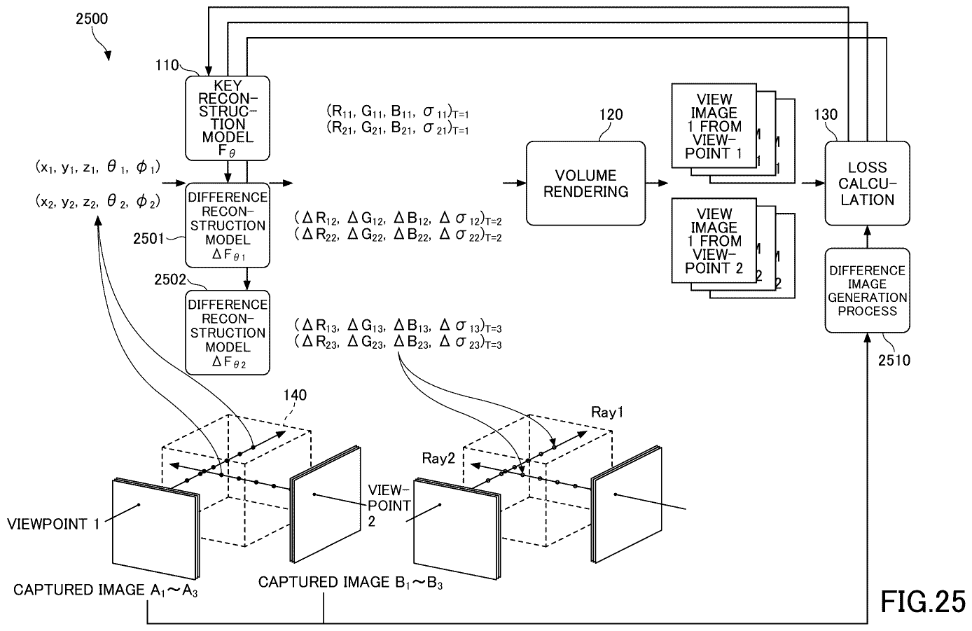

First, an outline of a training process of a reconstruction model applied to the server device 410 according to the fourth embodiment will be described. FIG. 25 is a fourth diagram for explaining the outline of the training process of the reconstruction model. The differences from the training process 100 described with reference to FIG. 1 in the first embodiment are that in the case of a training process 2500 illustrated in FIG. 25, the following models are included as the reconstruction model:
a key reconstruction model 110 (F_{θ});
a difference reconstruction model 2501 (ΔF_{θ1}); and
a difference reconstruction model 2502 (ΔF_{θ2}).

As illustrated in FIG. 25, in the training process 2500, the following information is input into the key reconstruction model 110 (F_{θ}):
a three-dimensional point in the three-dimensional scene 140 (for example, a point identified by (x₁, y₁, z₁)); and
viewpoint information for specifying a direction vector representing a line of sight (for example, the ray 1) from the viewpoint 1 with respect to the three-dimensional point (for example, viewpoint information (θ₁, φ₁)). With this, with respect to the input combination of the three-dimensional point and the viewpoint information, the key reconstruction model 110 (F_{θ}) outputs a combination of:
the color of the three-dimensional point in the time information T=1 (for example, the color specified by (R₁₁, G₁₁, B₁₁)); and
the opacity of the three-dimensional point in the time information T=1 (for example, the opacity specified by σ₁₁).
   That is, the key reconstruction model 110 calculates the color and opacity of a three-dimensional point from a certain viewpoint.

Here, in the training process 2500, substantially the same processing is performed for a plurality of viewpoints for the key reconstruction model 110 (F_{θ}). The example of FIG. 25 indicates that substantially the same processing is performed for two viewpoints (the viewpoint 1 and the viewpoint 2).

Specifically, in the training process 2500, the following information is further input into the key reconstruction model 110 (F_{θ}):
a three-dimensional point in the three-dimensional scene 140 (for example, a point identified by (x₂, y₂, z₂)); and
viewpoint information for specifying a direction vector representing a line of sight (for example, the ray 2) from the viewpoint 2 with respect to the three-dimensional point (for example, viewpoint information (θ₂, φ₂)).
   With this, with respect to the input combination of the three-dimensional point and the viewpoint information, the key reconstruction model 110 (F_{θ}) outputs a combination of:
the color of the three-dimensional point in the time information T=1 (for example, the color specified by (R₂₁, G₂₁, B₂₁)), and
the opacity of the three-dimensional point in the time information T=1 (for example, the opacity specified by σ₂₁).
   That is, the key reconstruction model 110 calculates the color and opacity of the certain three-dimensional point from the certain viewpoint.

Additionally, as illustrated in FIG. 25, in the training process 2500, the following information is input into the difference reconstruction model 2501 (ΔF_{θ1}):
a three-dimensional point in the three-dimensional scene 140 (for example, a point identified by (x₁, y₁, z₁)); and
viewpoint information for specifying a direction vector representing a line of sight (for example, the ray 1) from the viewpoint 1 with respect to the three-dimensional point (for example, viewpoint information (θ₁, φ₁)).
   With this, the difference reconstruction model 2501 (ΔF_{θ1}) outputs a combination of:
the difference color of the three-dimensional point in the time information T=2 (for example, a differential color specified by (ΔR₁₂, ΔG₁₂, ΔB₁₂)); and
the difference opacity of the three-dimensional point in the time information T=2 (for example, the differential opacity specified by Δσ₁₂).
   These are differences with the color and opacity of the three-dimensional point generated one frame period earlier, with respect to the color and opacity of the three-dimensional point generated one frame period later than the color and opacity of the three-dimensional point output by the key reconstruction model 110 (F_{θ)}. That is, the difference reconstruction model 2501 (ΔF_{θ1}) calculates the difference color and the difference opacity of the three-dimensional point from a certain viewpoint.

Here, in the training process 2500, substantially the same processing is performed on the difference reconstruction model 2501 (ΔF_{θ1}) for a plurality of viewpoints. The example of FIG. 25 indicates that substantially the same processing is performed for two viewpoints (the viewpoint 1 and the viewpoint 2).

Specifically, in the training process 2500, the following information is further input into the difference reconstruction model 2501 (ΔF_{θ1}):
a three-dimensional point in the three-dimensional scene 140 (for example, a point identified by (x₂, y₂, z₂)); and
viewpoint information for specifying a direction vector representing a line of sight (for example, the ray 2) from the viewpoint 2 with respect to the three-dimensional point (for example, viewpoint information (θ₂, φ₂)).
   With this, the difference reconstruction model 2501 (ΔF_{θ1}) outputs a combination of:
the difference color of the three-dimensional point in the time information T=2 (for example, a differential color specified by (ΔR₂₂, ΔG₂₂, ΔB₂₂)); and
the differential opacity of the three-dimensional point in the time information T=2 (for example, the differential opacity specified by Δσ₂₂).
   These are differences with the color and opacity of the three-dimensional point generated one frame period earlier, with respect to the color and opacity of the three-dimensional point generated one frame period later than the color and opacity of the three-dimensional point output by the key reconstruction model 110 (F_{θ}).

Additionally, as illustrated in FIG. 25, in the training process 2500, the following information is input into the difference reconstruction model 2502 (ΔF_{θ2}):
a three-dimensional point in the three-dimensional scene 140 (for example, a point identified by (x₁, y₁, z₁)); and
viewpoint information for specifying a direction vector representing a line of sight (for example, the ray 1) from the viewpoint 1 with respect to the three-dimensional point (for example, viewpoint information (θ₁, φ₁)).
   With this, the difference reconstruction model 2502 (ΔF_{θ2}) outputs a combination of:
the difference color of the three-dimensional point in the time information T=3 (for example, a differential color specified by (ΔR₁₃, ΔG₁₃, ΔB₁₃)); and
the difference opacity of the three-dimensional point in the time information T=3 (for example, the differential opacity specified by Δσ₁₃).
   These are differences with the color and opacity of a three-dimensional point generated one frame period earlier, with respect to the color and opacity of the three-dimensional point generated two frame period later than the color and opacity of the three-dimensional point output by the key reconstruction model 110 (F_{θ}). That is, the difference reconstruction model 2502 (ΔF_{θ2}) calculates the difference color and the difference opacity of a certain three-dimensional point at a certain viewpoint.

Here, in the training process 2500, substantially the same processing is performed on the difference reconstruction model 2502 (ΔF_{θ2}) for a plurality of viewpoints. The example of FIG. 25 indicates that substantially the same processing is performed for two viewpoints (the viewpoint 1 and the viewpoint 2).

Specifically, in the training process 2500, the following information is further input into the difference reconstruction model 2502 (ΔF_{θ2}):
a three-dimensional point in the three-dimensional scene 140 (for example, a point identified by (x₂, y₂, z₂)); and
viewpoint information for specifying a direction vector representing a line of sight (for example, the ray 2) from the viewpoint 2 with respect to the three-dimensional point (for example, viewpoint information (θ₂, φ₂)).
   With this, the difference reconstruction model 2502 (ΔF_{θ2}) outputs a combination of:
the difference color of the three-dimensional point in the time information T=3 (for example, the differential color specified by (ΔR₂₃, ΔG₂₃, ΔB₂₃)); and
the difference opacity of the three-dimensional point in the time information T=3 (for example, the differential opacity specified by Δσ₂₃).
   These are differences with the color and opacity of the three-dimensional point generated one frame period earlier, with respect to the color and opacity of the three-dimensional point generated two frame periods later than the color and opacity of the three-dimensional point output by the key reconstruction model 110 (F_{θ}).

Additionally, in the training process 2500 illustrated in FIG. 25, the volume rendering process 120 is performed on the combination of the color and opacity of the three-dimensional point output from the key reconstruction model 110 (F_{θ}) for each of the plurality of three-dimensional points on the line of sight for each of the viewpoints (e.g., the viewpoints 1 and 2), as in the training process 100.

In the present embodiment, the volume rendering process 120 calculates the color of each pixel of an image seen from a certain viewpoint using a volume rendering method. Specifically, the volume rendering process 120 calculates the color of each pixel by performing volume rendering using a predetermined sum-of-products operation based on the color and opacity output from the key reconstruction model 110 (F_{θ}) for each of the plurality of three-dimensional points on the line of sight connecting the pixel and the viewpoint. As a result, the volume rendering process 120 generates a view image from the certain viewpoint. The example of FIG. 25 indicates a state in which a view image 1 from the viewpoint 1 and a view image 1 from the viewpoint 2 are generated by the volume rendering process 120.

Additionally, in the training process 2500 illustrated in FIG. 25, the volume rendering process 120 is performed on the combination of the difference color and the difference opacity of the three-dimensional point output from the difference reconstruction model 2501 (ΔF_{θ1}) and the difference reconstruction model 2502 (ΔF_{θ2}) for each of the plurality of three-dimensional points on the line of sight for each of the viewpoints (for example, the viewpoints 1 and 2).

In the present embodiment, the volume rendering process 120 calculates the difference color of each pixel representing the difference between the image seen from the certain viewpoint and the image seen from the certain viewpoint at the immediately preceding time by using the volume rendering method. The difference color of each pixel representing the difference is calculated by performing volume rendering using a predetermined sum-of-products operation based on the difference color and the difference opacity output from the difference reconstruction model 2501 (ΔF_{θ1}) and the difference color and the difference opacity output from the difference reconstruction model 2502 (ΔF_{θ2}) for each of the plurality of three-dimensional points on the line of sight connecting the pixel and the viewpoint. As a result, the volume rendering process 120 generates a difference view image from the immediately preceding time from the certain viewpoint. The example illustrated in FIG. 25 indicates a state in which the following images are generated by the volume rendering process 120:
a difference view image from the viewpoint 1 in each time information (a difference view image 1 and a difference view image 2 from the viewpoint 1); and
a difference view image from the viewpoint 2 in each time information (a difference view image 1 and a difference view image 2 from the viewpoint 2).

Additionally, in the training process 2500 illustrated in FIG. 25, a difference image generation process 2510 generates a difference image to be used in the loss calculation process 130. Specifically, the difference image generation process 2510:
acquires a captured image A₁ corresponding to time information T=1;
acquires a captured image A₂ corresponding to time information T=2, and generates a difference image (A₁₋A₂) by calculating a difference with the captured image A₁;
acquires a captured image A₃ corresponding to time information T=3, and generates a difference image (A₂₋A₃) by calculating a difference with the captured image A₂;
acquires a captured image B₁ corresponding to time information T=1;
acquires a captured image B₂ corresponding to time information T=2, and generates a difference image (B₁₋B₂) by calculating a difference with the captured image B₁; and
acquires a captured image B₃ corresponding to time information T=3, and generates a difference image (B₂₋B₃) by calculating a difference with the captured image B₂.

Additionally, in the training process 2500 illustrated in FIG. 25, the loss calculation process 130 is performed on the generated view images of the respective viewpoints (the view image 1 from the viewpoint 1 and the view image 1 from the viewpoint 2). Specifically, the view image 1 from the viewpoint 1 is compared with the captured image A₁ captured by the imaging device having the viewpoint 1 to calculate the error. Additionally, the view image 1 from the viewpoint 2 is compared with the captured image B₁ captured by the imaging device having the viewpoint 2 to calculate the error.

The error calculated in the loss calculation process 130 is backpropagated through the key reconstruction model 110 (F_{θ}) by the error backpropagation method in the update process of the key reconstruction model 110 (F_{θ}). With this, the model parameters of the key reconstruction model 110 (F_{θ}) are updated. The model parameters are updated by the training process of the key reconstruction model 110 (F_{θ}), thereby generating the trained key reconstruction model F_{θ}, according to the training process 2500 illustrated in FIG. 25.

Similarly, in the training process 2500 illustrated in FIG. 25, the loss calculation process 130 is performed on the generated difference view images of the respective viewpoints (the difference view image 1 from the viewpoint 1 and the difference view image 1 from the viewpoint 2). Specifically, the difference view image 1 from the viewpoint 1 is compared with the difference image (A₁-A₂) generated in the difference image generation process 2510 to calculate the error. Additionally, the difference view image 1 from the viewpoint 2 is compared with the difference image (B₁-B₂) generated in the difference image generation process 2510 to calculate the error.

The error calculated in the loss calculation process 130 is backpropagated through the difference reconstruction model 2501 (ΔF_{θ1}) by the error backpropagation method in the update process of the difference reconstruction model 2501 (ΔF_{θ1}). With this, the model parameters of the difference reconstruction model 2501 (ΔF_{θ1}) are updated. The model parameters are updated by the training process of the difference reconstruction model 2501 (ΔF_{θ1}), thereby generating the trained difference reconstruction model ΔF_{θ1} according to the training process 2500 illustrated in FIG. 25.

Similarly, in the training process 2500 illustrated in FIG. 25, the loss calculation process 130 is performed on the generated difference view images of the respective viewpoints (the difference view image 2 from the viewpoint 1 and the difference view image 2 from the viewpoint 2). Specifically, the difference view image 2 from the viewpoint 1 is compared with the difference image (A₂-A₃) generated in the difference image generation process 2510 to calculate the error. Additionally, the difference view image 2 from the viewpoint 2 is compared with the difference image (B₂-B₃) generated in the difference image generation process 2510 to calculate the error.

The error calculated in the loss calculation process 130 is backpropagated through the difference reconstruction model 2502 (ΔF_{θ2}) by the error backpropagation method in the update process of the difference reconstruction model 2502 (ΔF_{θ2}). With this, the model parameters of the difference reconstruction model 2502 (ΔF_{θ2}) are updated. The model parameters are updated by the training process of the difference reconstruction model 2502 (ΔF_{θ2}), thereby generating the trained difference reconstruction model ΔF_{θ2} according to the training process 2500 illustrated in FIG. 25.

Here, in order to simplify the description, the case in which the training process is performed using a captured image captured by an imaging device having a viewpoint other than the viewpoints 1 and 2 is omitted here, but a captured image captured by an imaging device having a viewpoint other than the viewpoints 1 and 2 may be used in the training process.

### Outline of Image Generation Process Using Trained Reconstruction Model

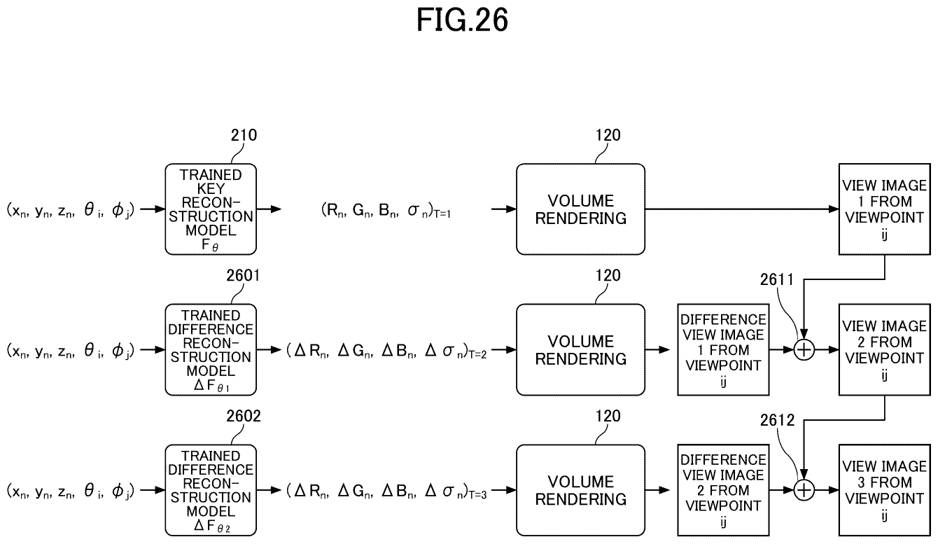

Next, an outline of an image generation process using the trained reconstruction model applied to the server device 410 according to the fourth embodiment will be described. FIG. 26 is a fourth view for explaining the outline of the image generation process using the trained reconstruction model.

As illustrated in FIG. 26, in the image generation process for generating a view image from the viewpoint ij in the time information T, the three-dimensional point (xₙ, yₙ, zₙ) and viewpoint information (θᵢ, φⱼ) related to the viewpoint ij are input into the trained key reconstruction model 210 (F_{θ}), and the color and opacity of each three-dimensional point in the time information T are calculated as the output. Then, in the image generation process, the volume rendering process 120 based on the calculated color and opacity of the three-dimensional point is performed for each pixel of a view image, thereby generating a view image from the viewpoint ij in the time information T.

Additionally, as illustrated in FIG. 26, in the image generation process for generating a view image from the viewpoint ij in time information one time unit after the time information T, the three-dimensional point (xₙ, yₙ, zₙ) and the viewpoint information (θᵢ, φⱼ) related to the viewpoint ij are input into a trained difference reconstruction model 2601 (ΔF_{θ1}), and the difference color and the difference opacity of each three-dimensional point from the time information T in the time information one time unit after the time information T are calculated as the output. Then, in the image generation process, the volume rendering process 120 based on the calculated difference color and difference opacity of the three-dimensional point is performed for each pixel of a view image, thereby generating a difference view image 1 from the viewpoint ij from the time information T in the time information one time unit after the time information T. Additionally, the image generation process performs addition processing 2611 for adding the difference view image 1 from the viewpoint ij to the view image 1 from the viewpoint ij in the time information T, thereby generating a view image 2 from the viewpoint ij.

Additionally, as illustrated in FIG. 26, in the image generation process for generating a view image from the viewpoint ij in time information two time units after the time information T, the three-dimensional point (xₙ, yₙ, zₙ) and the viewpoint information (θᵢ, φⱼ) related to the viewpoint ij are input into a trained difference reconstruction model 2602 (ΔF_{θ2}), and the difference color and the difference opacity of each three-dimensional point from the time information one time unit after the time information T in the time information two time units after the time information T are calculated as the output. Then, in the image generation process, the volume rendering process 120 based on the calculated difference color and difference opacity of the three-dimensional point is performed for each pixel of a view image, thereby generating a difference view image 2 from the viewpoint ij from the time information one time unit after the time information T in the time information two time units after the time information T. Additionally, in the image generation process, the view image 3 from the viewpoint ij is generated by performing addition processing 2612 for adding the difference view image 2 from the viewpoint ij to the view image 2 from the viewpoint ij in the time information one time unit after the time information T.

### Relationship Between Captured Image and Trained Reconstruction Model

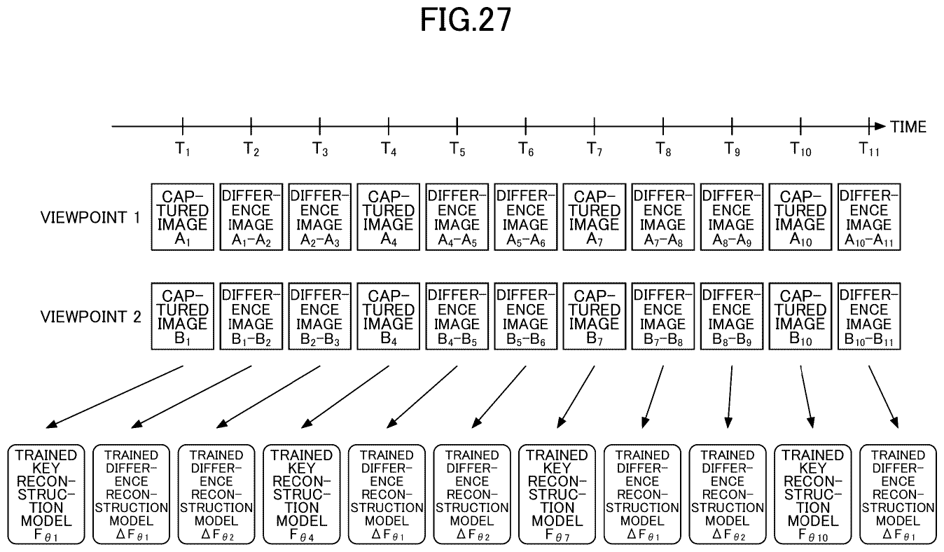

Next, trained reconstruction models applied to the server device 410 according to the fourth embodiment will be described. FIG. 27 is a fourth diagram illustrating an example of the trained reconstruction models applied to the server device. Here, FIG. 27 also illustrates the case where two viewpoints, which are the viewpoint 1 and the viewpoint 2, are used for the sake of simplification of explanation, but as described above, a captured image captured by an imaging device having a viewpoint other than the viewpoint 1 and the viewpoint 2 may be used in the training process.

As illustrated in FIG. 27, trained reconstruction models trained in advance so as to reconstruct a scene from the first time to the second time by using a time series of captured images obtained by capturing a scene from a plurality of viewpoints continuously in time are applied to the server device 410.

Specifically, to the server device 410, a trained key reconstruction model F_{θ1} on which a training process has been performed using the following images is applied:
the captured image A₁ captured by the imaging device having the viewpoint 1 in the time information T₁; and
the captured image B₁ captured by the imaging device having the viewpoint 2 in the time information T₁.

Additionally, as illustrated in FIG. 27, to the server device 410, the trained difference reconstruction model ΔF_{θ1} on which a training process has been performed using the following images is applied:
the difference image (A₁₋A₂) between the captured image A₁ captured by the imaging device having the viewpoint 1 in the time information T₁ and the captured image A₂ captured by the imaging device having the viewpoint 1 in the time information T₂; and
the difference image (B₁₋B₂) between the captured image B₁ captured by the imaging device having the viewpoint 2 in the time information T₁ and the captured image B₂ captured by the imaging device having the viewpoint 2 in the time information T₂.

Additionally, as illustrated in FIG. 27, to the server device 410, the trained difference reconstruction model ΔF_{θ2} on which a training process has been performed using the following images is applied:
the difference image (A₂-A₃) between the captured image A₂ captured by the imaging device having the viewpoint 1 in the time information T₂ and the captured image A₃ captured by the imaging device having the viewpoint 1 in the time information T₃; and
the difference image (B₂-B₃) between the captured image B₂ captured by the imaging device having the viewpoint 2 in the time information T₂ and the captured image B₃ captured by the imaging device having the viewpoint 2 in the time information T₃.

Similarly, to the server device 410, the trained key reconstruction model F_{θ4} on which a training process has been performed using the following images is applied:
the captured image A₄ captured by the imaging device having the viewpoint 1 in the time information T₄; and
the captured image B₄ captured by the imaging device having the viewpoint 2 in the time information T₄.

Additionally, as illustrated in FIG. 27, to the server device 410, the trained difference reconstruction model ΔF_{θ1} on which a training process is performed using the following images is applied:
the difference image (A₄₋A₅) between the captured image A₄ captured by the imaging device having the viewpoint 1 in the time information T₄ and the captured image A₅ captured by the imaging device having the viewpoint 1 in the time information T₅; and
the difference image (B₄₋B₅) between the captured image B₄ captured by the imaging device having the viewpoint 2 in the time information T₄ and the captured image B₅ captured by the imaging device having the viewpoint 2 in the time information T₅.

Additionally, as illustrated in FIG. 27, to the server device 410, the trained difference reconstruction model ΔF_{θ2} on which a training process is performed using the following images is applied:
the difference image (A₅₋A₆) between the captured image A₅ captured by the imaging device having the viewpoint 1 in the time information T₅ and the captured image A₆ captured by the imaging device having the viewpoint 1 in the time information T₆; and
the difference image (B₅₋B₆) between the captured image B₅ captured by the imaging device having the viewpoint 2 in the time information T₅ and the captured image B₆ captured by the imaging device having the viewpoint 2 in the time information T₆.

Hereinafter, in the example of FIG. 27, the trained difference reconstruction models up to the trained difference reconstruction model ΔF_{θ1} of the time information T₁₁ are illustrated for the sake of space, but the number of the trained key reconstruction models and the trained difference reconstruction models applied to the free-viewpoint moving image rendering system 400 are not limited to the example of FIG. 27. However, it is assumed that any of the trained key reconstruction models and the trained difference reconstruction models is associated with the time information and is managed as the trained reconstruction models for the time series.

Here, in FIG. 27, the time information T₁, T₄, T₇, . . . corresponds to a third time interval that is longer than the frame period (an example of the first time interval) of the captured images A₁, A₂, . . . or the captured images B₁, B₂, . . . captured by the imaging device during the training process. That is, the following models are applied to the server device 410:
the trained key reconstruction models for the time series of the third time interval (an example of fourth reconstruction models) configured to generate the view images of the time series of the third time interval that is longer than the first time interval; and
the trained difference reconstruction models for the time series of the first time interval (an example of fifth reconstruction models) configured to generate a difference image representing a difference from the view image generated the first time interval earlier, for generating the view images of the time series of the first time interval.

### Example of Trained Reconstruction Model

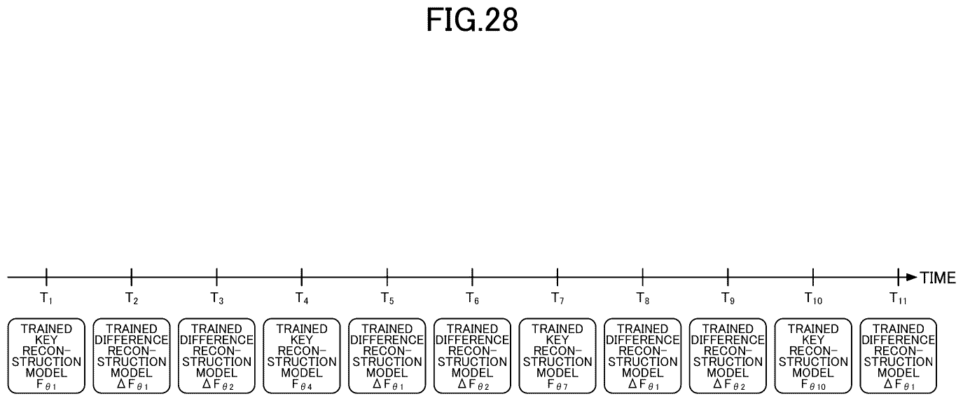

Next, the trained reconstruction model held by the model storage unit 606 in the server device 410 according to the fourth embodiment will be described. FIG. 28 is a diagram illustrating an example of the trained reconstruction models of the server device according to the fourth embodiment.

As illustrated in FIG. 28, the trained key reconstruction model and the trained difference reconstruction model held by the model storage unit 606 are associated with the time information. Specifically, the trained key reconstruction model F_{θ1} is associated with the time information T₁, and the trained difference reconstruction models ΔF_{θ1} and ΔF_{θ2} are associated with the time information T₂ to T₃. Similarly, in the example illustrated in FIG. 28, the trained key reconstruction model F_{θ4} and the trained difference reconstruction models ΔF_{θ1} and ΔF_{θ2} are associated with the time information T₄ to T₆. Additionally, the trained key reconstruction model F_{θ7} and the trained difference reconstruction models ΔF_{θ1} and ΔF_{θ2} are associated with the time information T₇ to T₉, and the trained key reconstruction model F_{θ10} and the trained difference reconstruction model ΔF_{θ1} are associated with the time information T₁₀ to T₁₁. The association between the time information and the trained key reconstruction model (or the trained difference reconstruction model) may be made by directly associating the time information with the trained key reconstruction model (or the trained difference reconstruction model), or may be made by indirectly associating the time information with the trained key reconstruction model (or the trained difference reconstruction model) through other data.

The server device 410 generates a time series of view images corresponding to viewpoint information and time information included in the request received from the client terminal 420 by using the trained key reconstruction models and the trained difference reconstruction models held by the model storage unit 606.

Here, in FIG. 28, as described above, the time information T₁, T₂, T₃. . . corresponds to the frame period of the captured images captured by the imaging device during the training process. Therefore, the time information T₁, T₂, T₃. . . corresponds to a frame period when a free-viewpoint moving image is rendered in the free-viewpoint moving image rendering system 400.

Additionally, as illustrated in FIG. 28, the trained key reconstruction models or the trained difference reconstruction models associated with the respective time information are different trained key reconstruction models or different trained difference reconstruction models. The different trained key reconstruction models or the different trained difference reconstruction models are constituted by NNs to which the NeRF technique is applied, and are trained by different training data (captured images). The architectures of the NNs may be the same or partially different.

Here, by using each of the trained key reconstruction models or each of the trained difference reconstruction models illustrated in FIG. 28, the server device 410 generates a view image (a free-viewpoint image) from an arbitrary viewpoint for the scene in the time information.

Additionally, as illustrated in FIG. 28, the model storage unit 606 holds at least a group of trained key reconstruction models and trained difference reconstruction models configured to generate view images for a series of scenes for one single object. However, the group of trained key reconstruction models and trained difference reconstruction models held by the model storage unit 606 is not limited to one, and another group of trained key reconstruction models and trained difference reconstruction models configured to generate view images for a series of scenes for another single object may be held.

Additionally, as illustrated in FIG. 28, the group of trained key reconstruction models and trained difference reconstruction models held by the model storage unit 606 includes four trained key reconstruction models and seven trained difference reconstruction models for the time information T₁ to T₁₁ for the sake of space. However, the number of trained key reconstruction models and the number of trained difference reconstruction models in the group held by the model storage unit 606 are not limited to this.

### Specific Example of Processing by Server Device

Next, a specific example of processing by the default moving image generation unit 602 and the requested moving image generation unit 604 of the server device 410 according to the fourth embodiment will be described.

### (1) Specific Example of Processing by the Default Moving Image Generation Unit

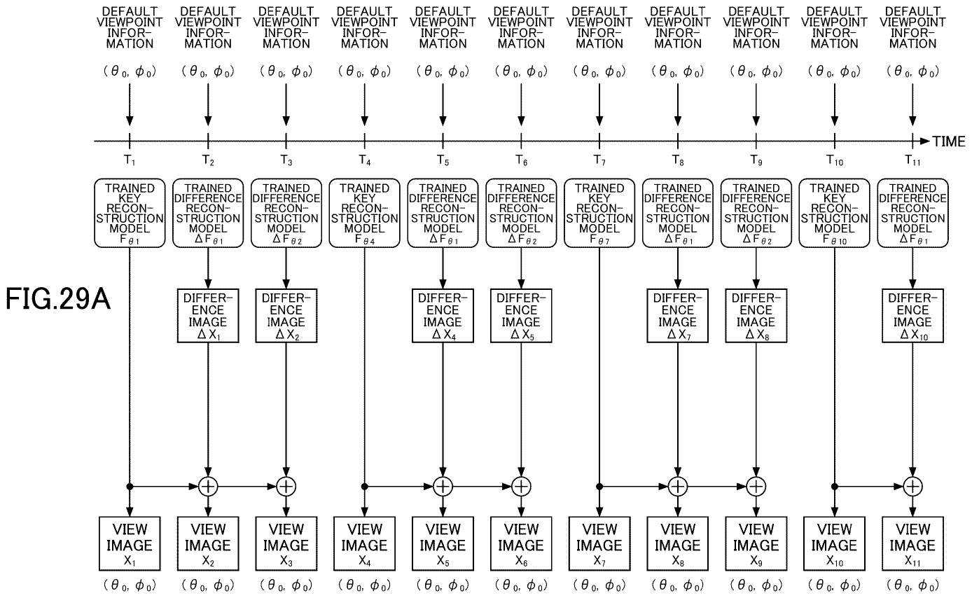

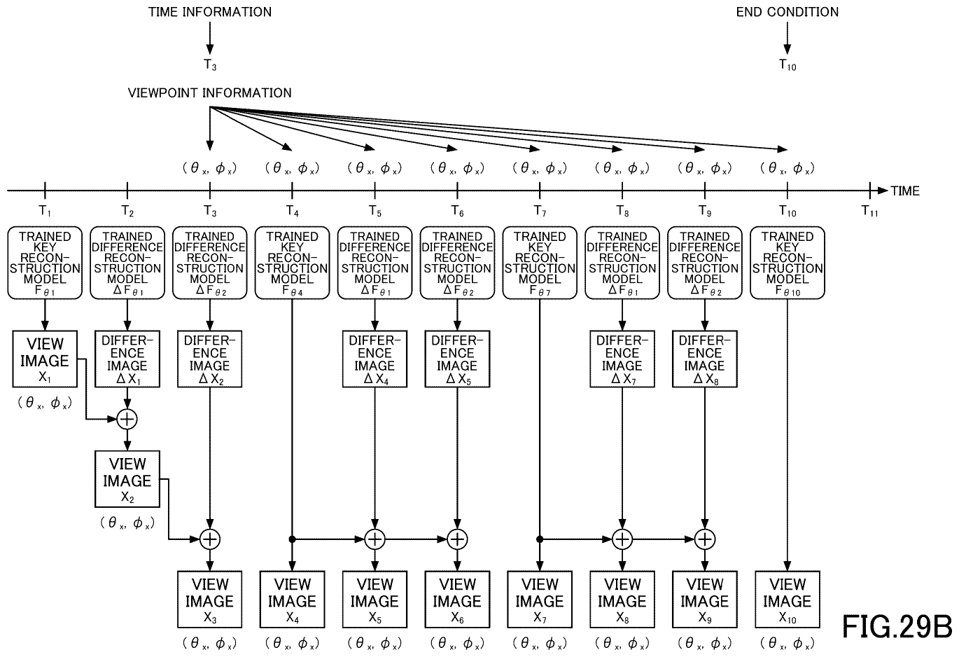

First, a specific example of processing by the default moving image generation unit 602 will be described. FIG. 29A is a first diagram illustrating a specific example of processing by the server device 410 according to the fourth embodiment. FIG. 29A illustrates a specific example of processing when the moving image designation receiving unit 601 receives a designation of a free-viewpoint moving image and the default moving image generation unit 602 receives notification of identification information of the designated free-viewpoint moving image from the moving image designation receiving unit 601.

As illustrated in FIG. 29A, the default moving image generation unit 602 reads the following trained reconstruction models from the model storage unit 606 as trained reconstruction models configured to generate view images included in the designated free-viewpoint moving image:
trained key reconstruction models F_{θ1,} F_{θ4,} F_{θ7}, and F_{θ10}; and
trained difference reconstruction models ΔF_{θ1} and ΔF_{θ2} corresponding to the time information T₂, T₃, T₅, T₆, T₈, T₉, and T₁₁, respectively.

Additionally, the default moving image generation unit 602 inputs the default viewpoint information (θ₀, φ₀) into each of:
the read trained key reconstruction models F_{θ1}, F_{θ4}, F_{θ7}, and F_{θ10}; and
the trained difference reconstruction models ΔF_{θ1} and ΔF_{θ2} corresponding to the time information T₂, T₃, T₅, T₆, T₈, T₉, and T₁₁, respectively.

With this, the trained key reconstruction models F_{θ1}, F_{θ4}, F_{θ7}, and F_{θ10} generate view images X₁, X₄, X₇, and X₁₀ of the scene viewed from the viewpoint based on the default viewpoint information (θ₀, φ₀) in the respective time information.

Additionally, the trained difference reconstruction models ΔF_{θ1} and ΔF_{θ2} corresponding to the time information T₂, T₃, T₅, T₆, T₈, T₉, and T₁₁ generate difference images ΔX₁, ΔX₂, ΔX₄, ΔX₅, ΔX₇, ΔX₈, and ΔX₁₀.

Additionally, the difference image ΔX₁ is added to the view image X₁ to generate the view image X₂ of the scene viewed from the viewpoint based on the default viewpoint information (θ₀, φ₀) in the time information T₂.

Additionally, the difference image ΔX₂ is added to the view image X₂ to generate the view image X₃ of the scene viewed from the viewpoint based on the default viewpoint information (θ₀, φ₀) in the time information T₃.

Additionally, the difference image ΔX₄ is added to the view image X₄ to generate the view image X₅ of the scene viewed from the viewpoint based on the default viewpoint information (θ₀, φ₀) in the time information T₅.

Additionally, the difference image ΔX₅ is added to the view image X₅ to generate the view image X₆ of the scene viewed from the viewpoint based on the default viewpoint information (θ₀, φ₀) in the time information T₆.

Additionally, the difference image ΔX₇ is added to the view image X₇ to generate the view image X₈ of the scene viewed from the viewpoint based on the default viewpoint information (θ₀, φ₀) in the time information T₈.

Additionally, the difference image ΔX₈ is added to the view image X₈ to generate the view image X₉ of the scene viewed from the viewpoint based on the default viewpoint information (θ₀, φ₀) in the time information T₉.

Additionally, the difference image ΔX₁₀ is added to the view image X₁₀ to generate the view image X₁₁ of the scene viewed from the viewpoint based on the default viewpoint information (θ₀, φ₀) in the time information T₁₁.

Additionally, the default moving image generation unit 602 notifies the moving image transmitting unit 605 of the generated view images X₁ to X₁₁ in association with the time information T₁ to T₁₁. With this, the moving image transmitting unit 605 transmits the view images X₁ to X₁₁ in a transmission format that can be played back as a moving image by the client terminal 420.

Here, in the above description, it is assumed that the default moving image generation unit 602 generates the view images X₂, X₃, X₅, X₆, X_{8,} X₉, and X₁₁ using the difference images ΔX₁, ΔX₂, ΔX₄, ΔX₅, ΔX₇, ΔX₈, and ΔX₁₀. Additionally, in the above description, it is assumed that the default moving image generation unit 602 notifies the moving image transmitting unit 605 of the generated view images X₂, X₃, X₅, X₆, X₈, X₉, and X₁₁.

However, the contents of the processing by the default moving image generation unit 602 are not limited to this, and for example, the default moving image generation unit 602 may notify the moving image transmitting unit 605 of:
the view images X₁, X₄, X₇, and X₁₀ generated by the trained key reconstruction model; and
the difference images ΔX₁, ΔX₂, ΔX₄, ΔX₅, ΔX₇, ΔX₈, and ΔX₁₀ generated by the trained difference reconstruction model.

In this case, the client terminal 420 receives the view images X₁, X₄, X₇, and X₁₀ from the server device 410. Additionally, the client terminal 420 receives the difference images ΔX₁, ΔX₂, ΔX₄, ΔX₅, ΔX₇, ΔX₈, and ΔX₁₀ from the server device 410. Then, the client terminal 420 generates the view images X₂, X₃, X₅, X₆, X₈, X₉, and X₁₁ by using the received view images X₁, X₄, X₇, and X₁₀ and the received difference images ΔX₁, ΔX₂, ΔX₄, ΔX₅, ΔX₇, ΔX₈, and ΔX₁₀.

As described above, a part of the processing performed by the default moving image generation unit 602 may be performed by the client terminal 420.

### (2) Specific Example of Processing Performed by Requested Moving Image Generation Unit

As described above, it is assumed that the client terminal 420 plays back the free-viewpoint moving image using the view images X₁ to X₁₁ as frame images of the scene viewed from the viewpoint based on the default viewpoint information (θ₀, φ₀) in the respective time information. Additionally, it is assumed that the request including the time information and the viewpoint information is transmitted from the client terminal 420 in response to this. In this case, the request receiving unit 603 receives the request and notifies the requested moving image generation unit 604.

Here, a specific example of processing by the requested moving image generation unit 604 when the request (time information and viewpoint information) is notified by the request receiving unit 603 will be described. FIG. 29B is a second diagram illustrating a specific example of processing by the server device according to the fourth embodiment, and illustrates a specific example of processing by the requested moving image generation unit 604 when a request is notified by the request receiving unit 603.

As illustrated in FIG. 29B, the requested moving image generation unit 604 identifies the trained difference reconstruction model ΔF_{θ2} corresponding to the time information (in the example of FIG. 29B, T₃) included in the request among the trained reconstruction models that have already been read. Additionally, the requested moving image generation unit 604 identifies the trained key reconstruction model F_{θ1} and the trained difference reconstruction model ΔF_{θ1} that are necessary for generating the view image X₃ based on the trained difference reconstruction model ΔF_{θ2}.

Additionally, the requested moving image generation unit 604 inputs the viewpoint information (in the example of FIG. 29B, (θₓ, φₓ)) included in the request into the identified trained key reconstruction model F_{θ1} and trained difference reconstruction models ΔF_{θ1} and ΔF_{θ2}. With this, the trained key reconstruction model F_{θ1} generates the view image X₁ of the scene viewed from the viewpoint based on the viewpoint information (θₓ, φₓ) in the time information T₁ included in the request. Additionally, the trained difference reconstruction models ΔF_{θ1} and ΔF_{θ2} generate the difference images ΔX₁ and ΔX₂ of the scene viewed from the viewpoint based on the viewpoint information (θₓ, φₓ) in the time information T₂ and T₃ included in the request. Further, the requested moving image generation unit 604 generates the view image X₃ of the scene viewed from the viewpoint based on the viewpoint information (θₓ, φₓ) in the time information T₃ included in the request by using the generated view image X₁ and the difference images ΔX₁ and ΔX₂.

Subsequently, the requested moving image generation unit 604 identifies the trained key reconstruction model F_{θ4} corresponding to the next time information (the next time point) as the next trained reconstruction model. Additionally, the requested moving image generation unit 604 inputs the viewpoint information (θₓ, φₓ) included in the request into the identified trained key reconstruction model F_{θ4}. With this, the trained key reconstruction model F_{θ4} generates the view image X₄ of the scene viewed from the viewpoint based on the viewpoint information (θₓ, φₓ) in the time information T₄ included in the request.

Subsequently, the requested moving image generation unit 604 identifies the trained difference reconstruction model ΔF_{θ1} corresponding to the next time information (the next time point) as the next trained reconstruction model. Additionally, the requested moving image generation unit 604 inputs the viewpoint information (θₓ, φₓ) included in the request into the identified trained difference reconstruction model ΔF_{θ1}. With this, the trained difference reconstruction model ΔF_{θ1} generates the difference image ΔX₄ of the scene viewed from the viewpoint based on the viewpoint information (θₓ, φₓ) in the time information T₅ included in the request. Further, the requested moving image generation unit 604 generates the view image X₅ of the scene viewed from the viewpoint based on the viewpoint information (θₓ, φₓ) in the time information T₅ included in the request by using the generated view image X₄ and the difference image ΔX₄.

Subsequently, the requested moving image generation unit 604 identifies the trained difference reconstruction model ΔF_{θ2} corresponding to the next time information (the next time point) as the next trained reconstruction model. Additionally, the requested moving image generation unit 604 inputs the viewpoint information (θₓ, φₓ) included in the request into the identified trained difference reconstruction model ΔF_{θ2}. With this, the trained difference reconstruction model ΔF_{θ2} generates the difference image ΔX₅ of the scene viewed from the viewpoint based on the viewpoint information (θₓ, φₓ) in the time information T₆ included in the request. Further, the requested moving image generation unit 604 generates the view image X₆ of the scene viewed from the viewpoint based on the viewpoint information (θₓ, φₓ) in the time information T₆ included in the request by using the generated view image X₅ and the difference image ΔX₅.

Hereinafter, the requested moving image generation unit 604 repeats substantially the same processing until an end condition is transmitted from the client terminal 420. The example of FIG. 29B indicates a state in which time information T₁₀ is transmitted as the end condition from the client terminal 420.

When the time information T₁₀ is transmitted as the end condition from the client terminal 420, the requested moving image generation unit 604 identifies, as the last trained key reconstruction model, the trained key reconstruction model F_{θ10} corresponding to the time information T₁₀ transmitted as the end condition. Additionally, the requested moving image generation unit 604 inputs the viewpoint information (in the example of FIG. 29B, (θₓ, φₓ)) included in the request into the identified trained reconstruction model F_{θ10}. With this, the trained key reconstruction model F_{θ10} generates the view image X₁₀ of the scene viewed from the viewpoint based on the viewpoint information (θₓ, φₓ) in the time information T₁₀ included in the request.

As described above, the requested moving image generation unit 604 generates:
the view images of the time series of the third time interval, corresponding to the viewpoint information, by using the trained key reconstruction models for the time series of the third time interval from the trained key reconstruction model corresponding to the time information included in the request to the trained key reconstruction model corresponding to the predetermined end condition;
the difference images of the time series of the first time interval, corresponding to the viewpoint information, by using the trained difference reconstruction models for the time series of the first time interval from the trained difference reconstruction model corresponding to the time information included in the request to the trained difference reconstruction model corresponding to the predetermined end condition, the difference image being a difference image corresponding to the time information excluding the time information for which the view image is generated by using the trained key reconstruction models for the time series; and
the view images of the time series of the first time interval excluding the view image generated by using the trained key reconstruction model, by adding each of the difference images to the view image the first time interval earlier.

The requested moving image generation unit 604 sequentially notifies the moving image transmitting unit 605 of the generated view images X₃ to X₁₀ in association with the time information T₃ to T₁₀. With this, the moving image transmitting unit 605 transmits the view images X₃ to X₁₀ in a transmission format that can be played back as a moving image by the client terminal 420.

### Summary

As is apparent from the above description, one or more memories included in the server device 410 according to the fourth embodiment hold:
the trained key reconstruction models for the time series of the third time interval (the fourth reconstruction models) configured to generate the time series of view images in the third time interval that is longer than the first time interval; and
the trained difference reconstruction models (the fourth difference reconstruction models) used for generating the view image excluding the view image generated using the trained key reconstruction models (the fourth reconstruction models) among the view images of the time series of the first time interval.
   The trained difference reconstruction models (the fourth difference reconstruction models) is the trained difference reconstruction models for the time series of the first time interval configured to generate difference images each representing a difference from the view image generated the first time interval earlier.

Additionally, one or more processors included in the server device 410 according to the fourth embodiment generate:
the view images of the time series of the third time interval, corresponding to the viewpoint information, using the trained key reconstruction models for the time series of the third time interval (the fourth reconstruction models) from the trained key reconstruction model (the fourth reconstruction model) corresponding to the time information included in the request to the trained key reconstruction model (the fourth reconstruction model) corresponding to the predetermined end condition;
the difference images of the time series of the first time interval, corresponding to the viewpoint information, using the trained difference reconstruction models for the time series of the first time interval (the fourth difference reconstruction models) from the trained difference reconstruction model (the fourth difference reconstruction model) corresponding to the time information included in the request to the trained difference reconstruction model (the fourth difference reconstruction model) corresponding to the predetermined end condition, the difference images being the time series of difference images corresponding to the time information excluding the time information for which the view images are generated using the trained key reconstruction models for the time series (the fourth reconstruction model); and
the view images of the time series of the first time interval excluding the view images generated using the trained key reconstruction models (the fourth reconstruction models) by adding each of the difference images to the view image the first time interval earlier.

With this, according to the fourth embodiment, a mechanism different from those of the first to third embodiments can be constructed as a mechanism for rendering a free-viewpoint moving image.

### Fifth Embodiment

In the first embodiment, the case in which one imaging device captures the three-dimensional scene 140 from the same viewpoint has been described. However, the three-dimensional scene 140 may be captured from the same viewpoint by, for example, two imaging devices. This can generate a trained reconstruction model that divides the three-dimensional scene 140 into two spaces and generates a view image in each of the spaces. Hereinafter, a fifth embodiment will be described, mainly with respect to differences from the first embodiment.

### Outline of Training Process of Reconstruction Model

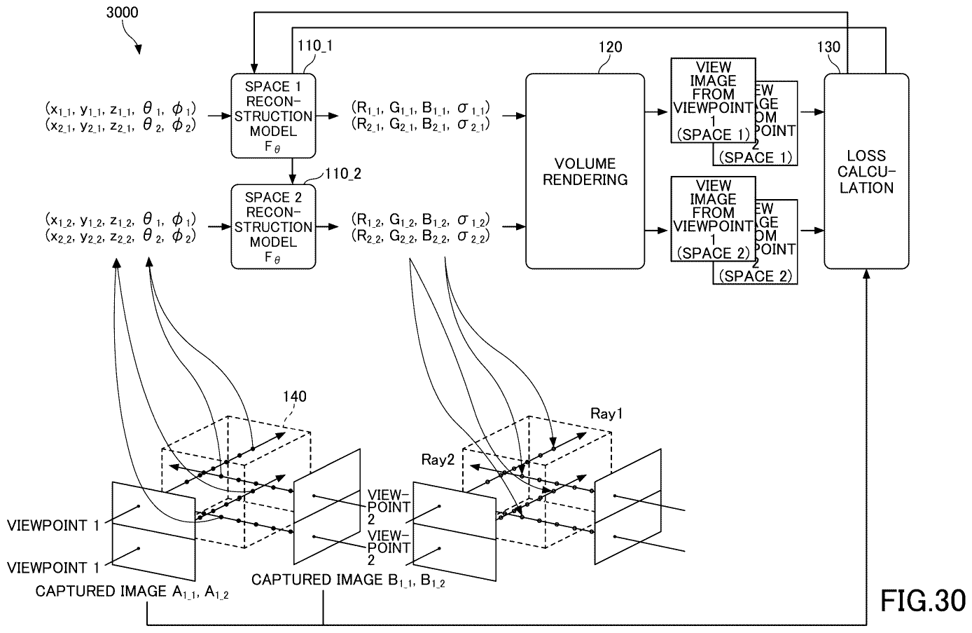

First, an outline of a training process of a reconstruction model applied to the server device 410 according to the fifth embodiment will be described. FIG. 30 is a fifth diagram for explaining the outline of the training process of the reconstruction model. In the case of a training process 3000 illustrated in FIG. 30, the following models are included as the reconstruction model:
a space 1 reconstruction model 110_1 (F_{θ}); and
a space 2 reconstruction model 110_2 (F_{θ}).
   The following information is input into the space 1 reconstruction model 110_1 (F_{θ}):
a three-dimensional point in the upper half space (the space 1) in the three-dimensional scene 140 (for example, a point identified by (x_{1_1}, y_{1_1}, z_{1_1})); and
viewpoint information for specifying a direction vector representing a line of sight (for example, the ray 1) from the viewpoint 1 with respect to the three-dimensional point (for example, viewpoint information (θ₁, φ₁)).
   With this, with respect to the input combination of the input three-dimensional point and the viewpoint information, the space 1 reconstruction model 110_1 (F_{θ}) outputs a combination of:
the color of the three-dimensional point in the upper half space (the space 1) in the three-dimensional scene 140 (for example, the color specified by (R_{1_1}, G_{1_1}, B_{1_1})); and
the opacity of the three-dimensional point in the upper half space (the space 1) in the three-dimensional scene 140 (for example, the opacity specified by σ_{1_1}).
   That is, the space 1 reconstruction model 110_1 (F_{θ}) calculates the color and opacity of the certain three-dimensional point in the space 1 from the certain viewpoint.

Here, in the training process 3000, substantially the same process is performed on the space 1 reconstruction model 110_1 (F_{θ}) for a plurality of viewpoints, as in the training process 100. The example of FIG. 30 indicates that substantially the same process is performed for two viewpoints (the viewpoint 1 and the viewpoint 2).

Specifically, in the training process 3000, the following information is further input into the space 1 reconstruction model 110_1 (F_{θ}):
a three-dimensional point in the upper half space (the space 1) in the three-dimensional scene 140 (for example, a point identified by (x_{2_1}, y_{2_1}, z_{2_1})); and
viewpoint information for specifying a direction vector representing a line of sight (for example, the ray 2) from the viewpoint 2 with respect to the three-dimensional point (for example, viewpoint information (θ₂, φ₂)).
   With this, with respect to the input combination of the three-dimensional point and the viewpoint information, the space 1 reconstruction model 110_2 (F_{θ}) outputs a combination of:
the color of the three-dimensional point in the upper half space (the space 1) in the three-dimensional scene 140 (for example, the color specified by (R_{2_1}, G_{2_1}, B_{2_1})); and
the opacity of the three-dimensional point in the upper half space (the space 1) in the three-dimensional scene 140 (for example, the opacity specified by σ_{2_1}).

With respect to the above, the following information is input into the space 2 reconstruction model 110_1 (F_{θ}):
a three-dimensional point in the lower half space (the space 2) in the three-dimensional scene 140 (for example, the point identified by (x_{1_2}, y_{1_2}, z_{1_2})), and
viewpoint information for specifying a direction vector representing a line of sight (for example, the ray 1) from the viewpoint 1 with respect to the three-dimensional point (for example, the viewpoint information (θ₁, φ₁)).
   With this, with respect to the input combination of the three-dimensional point and the viewpoint information, the space 2 reconstruction model 110_1 (F_{θ}) outputs a combination of:
the color of the three-dimensional point in the lower half space (the space 2) in the three-dimensional scene 140 (for example, the color specified by (R_{1_2}, G_{1_2}, B_{1_2})); and
the opacity of the three-dimensional point in the lower half space (the space 2) in the three-dimensional scene 140 (for example, the opacity specified by σ_{1_2}).
   That is, the space 2 reconstruction model 110_1 (F_{θ}) calculates the color and opacity of the certain three-dimensional point in the space 2 from the certain viewpoint.

Here, in the training process 3000, substantially the same process is performed on the space 2 reconstruction model 110_2 (F_{θ}) for a plurality of viewpoints, as in the training process 100. The example of FIG. 30 indicates that substantially the same process is performed for two viewpoints (the viewpoint 1 and the viewpoint 2).

Specifically, in the training process 3000, the following information is further input into the space 2 reconstruction model 110_2 (F_{θ}):
a three-dimensional point in the lower half space (the space 2) in the three-dimensional scene 140 (for example, the point identified by (x_{2_2}, y_{2_2}, z_{2_2})); and
viewpoint information for specifying a direction vector representing a line of sight (for example, the ray 2) from the viewpoint 2 with respect to the three-dimensional point (for example, the viewpoint information (θ₂, φ₂)).
   With this, with respect to the input combination of the input three-dimensional point and the viewpoint information, the space 2 reconstruction model 110_1 (F_{θ}) outputs a combination of:
the color of the three-dimensional point in the lower half space (the space 2) in the three-dimensional scene 140 (for example, the color specified by (R_{2_2}, G_{2_2}, B_{2_2})); and
the opacity of the three-dimensional point in the lower half space (the space 2) in the three-dimensional scene 140 (for example, the opacity specified by σ_{2_2}).

Additionally, in the training process 3000, the volume rendering process 120 is performed on the combination of the color and opacity of the three-dimensional point output from the space 1 reconstruction model 110_1 (F_{θ}) for each of the plurality of three-dimensional points on the line of sight for each viewpoint (e.g., the viewpoints 1 and 2), as in the training process 100.

In the present embodiment, the volume rendering process 120 calculates the color of each pixel of an image seen from a certain viewpoint by using a volume rendering method. Specifically, the volume rendering process 120 calculates the color of each pixel in the space 1 by performing volume rendering using a predetermined sum-of-products operation based on the color and opacity output from the space 1 reconstruction model 110_1 (F_{θ}) for each of the plurality of three-dimensional points on the line of sight connecting the pixel and the viewpoint. As a result, the volume rendering process 120 generates a view image of the space 1 from a certain viewpoint. The example of FIG. 30 indicates a state in which the view image (the space 1) from the viewpoint 1 and the view image (the space 1) from the viewpoint 2 are generated by the volume rendering process 120.

Similarly, the volume rendering process 120 calculates the color of each pixel in the space 2 by performing volume rendering using a predetermined sum-of-products operation based on the color and opacity output from the space 2 reconstruction model 110_2 (F_{θ}) for each of a plurality of three-dimensional points on the line of sight connecting the pixel and the viewpoint. As a result, the volume rendering process 120 generates a view image of the space 2 from a certain viewpoint. The example of FIG. 30 indicates a state in which the view image (the space 2) from the viewpoint 1 and the view image (the space 2) from the viewpoint 2 are generated by the volume rendering process 120.

Additionally, in the training process 3000 illustrated in FIG. 30, the loss calculation process 130 is performed on the generated view image (the space 1) from the viewpoint 1 and the view image (the space 1) from the viewpoint 2. For example, the view image (the space 1) from the viewpoint 1 is compared with the captured image A_{1_1} captured by the imaging device having the viewpoint 1 to calculate the error. The view image (the space 1) from the viewpoint 2 is compared with the captured image B_{1_1} captured by the imaging device having the viewpoint 2 to calculate the error.

Similarly, the loss calculation process 130 is performed on the generated view image (the space 2) from the viewpoint 1 and the view image (the space 2) from the viewpoint 2. For example, the view image (the space 2) from the viewpoint 1 is compared with the captured image A_{1_2} captured by the imaging device having the viewpoint 1 to calculate the error. Additionally, the view image (the space 2) from the viewpoint 2 is compared with the captured image B_{1_2} captured by the imaging device having the viewpoint 2 to calculate the error.

The errors calculated in the loss calculation process 130 are backpropagated through the space 1 reconstruction model 110_1 (F_{θ}) and the space 2 reconstruction model 110_2 (F_{θ}) by the error backpropagation method in the update processes of the space 1 reconstruction model 110_1 (F_{θ}) and the space 2 reconstruction model 110_2 (F_{θ}), respectively. With this, the model parameters of the space 1 reconstruction model 110_1 (F_{θ}) and the model parameters of the space 2 reconstruction model 110_2 (F_{θ}) are updated. The model parameters are updated by the training process of the space 1 reconstruction model 110_1 (F_{θ}), thereby generating the trained space 1 reconstruction model (F_{θ}) according to the training process illustrated in FIG. 30. Additionally, the model parameters are updated by the training process of the space 2 reconstruction model 110_2 (F_{θ}), thereby generating the trained space 2 reconstruction model (F_{θ}) according to the training process illustrated in FIG. 30.

Here, in order to simplify the description, the case in which the training process is performed using a captured image captured by an imaging device having a viewpoint other than the viewpoints 1 and 2 is omitted here, but a captured image captured by an imaging device having a viewpoint other than the viewpoints 1 and 2 may be used in the training process.

### Outline of Image Generation Process Using Trained Reconstruction Model

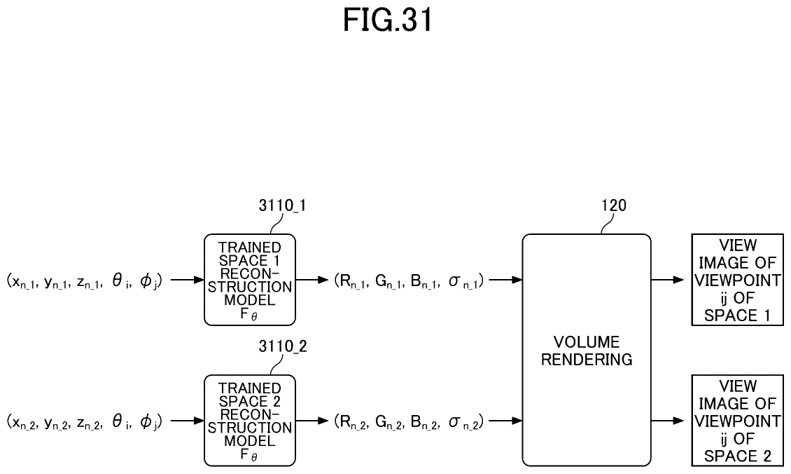

Next, an outline of an image generation process using the trained reconstruction model applied to the server device 410 according to the fifth embodiment will be described. FIG. 31 is a fifth diagram for explaining the outline of the image generation process using the trained reconstruction model.

As illustrated in FIG. 31, in the image generation process for generating a view image from the viewpoint ij with respect to the space 1, the three-dimensional points (xₙ, yₙ, zₙ) and viewpoint information (θᵢ, φⱼ) related to the viewpoint ij are input into the trained space 1 reconstruction model 3110_1 (F_{θ}), and the color and opacity of each three-dimensional point are calculated as the output. Then, in the image generation process, the volume rendering process 120 based on the calculated color and opacity of each three-dimensional point is performed for each pixel of a view image of the space 1, thereby generating a view image of the space 1 from the viewpoint ij.

Additionally, as illustrated in FIG. 31, in the image generation process for generating a view image from the viewpoint ij with respect to the space 2, the three-dimensional points (xₙ, yₙ, zₙ) and viewpoint information (θᵢ, φⱼ) related to the viewpoint ij are input into the trained space 2 reconstruction model 3110_2 (F_{θ}), and the color and opacity of each three-dimensional point are calculated as the output. Then, in the image generation process, the volume rendering process 120 based on the calculated color and opacity of each three-dimensional point is performed for each pixel of a view image of the space 2, thereby generating a view image of the space 2 from the viewpoint ij.

Relationship between Captured Image and Trained Reconstruction Model

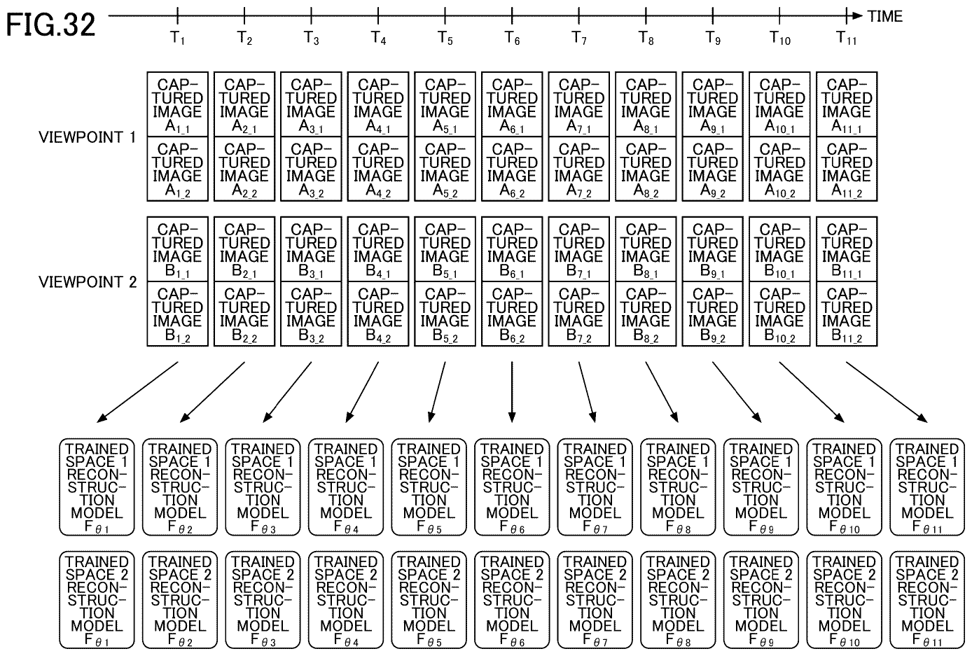

Next, trained reconstruction models applied to the server device 410 according to the fifth embodiment will be described. FIG. 32 is a fifth diagram illustrating an example of the trained reconstruction models applied to the server device. Here, FIG. 32 also illustrates the case where two viewpoints, which are the viewpoint 1 and the viewpoint 2, are used for the sake of simplification of explanation, but as described above, a captured image captured by an imaging device having a viewpoint other than the viewpoint 1 and the viewpoint 2 may be used in the training process.

As illustrated in FIG. 32, a group of trained reconstruction models corresponding to each space is applied to the server device 410. The group of trained reconstruction models corresponding to each space is trained in advance so as to reconstruct a scene from the first time to the second time by using a time series of captured images obtained by capturing each space of the scene from a plurality of viewpoints continuously in time.

Specifically, a trained space 1 reconstruction model F_{θ1} on which a training process is performed using:
a captured image A_{1_1} of the space 1 captured by the imaging device having the viewpoint 1 in the time information T₁; and
a captured image B_{1_1} of the space 1 captured by the imaging device having the viewpoint 2 in the time information T₁, and a trained space 2 reconstruction model F_{θ1} on which a training process is performed using:
a captured image A_{1_2} of the space 2 captured by the imaging device having the viewpoint 1 in the time information T₁; and
a captured image B_{1_2} of the space 2 captured by the imaging device having the viewpoint 2 in the time information T₁ are applied to the server device 410.

Similarly,

a trained space 1 reconstruction model F_{θ2} on which a training process has been performed using:
a captured image A_{2_1} of the space 1 captured by the imaging device having the viewpoint 1 in the time information T₂; and
a captured image B_{2_1} of the space 1 captured by the imaging device having the viewpoint 2 in the time information T₂, and a trained space 2 reconstruction model F_{θ2} on which a training process has been performed using:
a captured image A_{2_2} of the space 2 captured by the imaging device having the viewpoint 1 in the time information T₂; and
a captured image B_{2_2} of the space 2 captured by the imaging device having the viewpoint 2 in the time information T₂ are applied to the server device 410.

Hereinafter, in the example of FIG. 32, the trained reconstruction models up to the trained space 1 reconstruction model F_{θ11} and the trained space 2 reconstruction model F_{θ11} of the time information T₁₁ are illustrated for the sake of space, but the number of the trained reconstruction models applied to the server device 410 is not limited to 22. However, it is assumed that any of the trained reconstruction models is associated with the time information and the space information and is managed as the trained reconstruction model for the time series.

Here, in FIG. 32, the time information T₁, T₂, T₃ and . . . corresponds to a frame period (an example of the first time interval) of:
the captured images A_{1_1} (or A_{1_2}), A_{2_1} (or A_{2_2}), . . . ; or
the captured images B_{1_1} (or B_{1_2}), B_{2_1} (or B_{2_2}), . . . which are captured by the imaging device during the training process. That is, the trained reconstruction models for the time series of the first time interval, corresponding to each space (another example of the first reconstruction model) are applied to the server device 410 to generate the view images of the time series of the first time interval of each space.

### Example of Trained Reconstruction Model

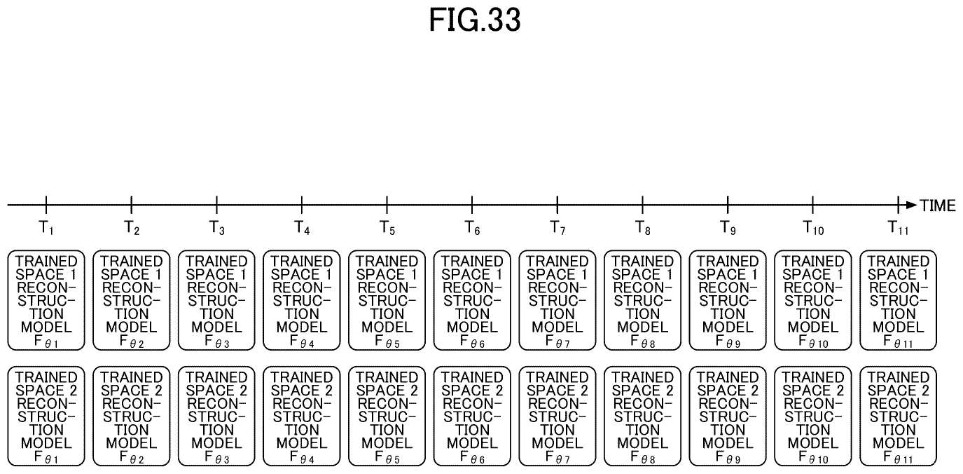

Next, the trained reconstruction model held by the model storage unit 606 in the server device 410 according to the fifth embodiment will be described. FIG. 33 is a diagram illustrating an example of the trained reconstruction models of the server device according to the fifth embodiment.

As illustrated in FIG. 33, the trained reconstruction models held by the model storage unit 606 are associated with time information. Specifically, the trained space 1 reconstruction model F_{θ1} and the trained space 2 reconstruction model F_{θ1} are associated with the time information T₁, and the trained space 1 reconstruction model F_{θ2} and the trained space 2 reconstruction model F_{θ2} are associated with the time information T₂. Similarly, the example of FIG. 33 illustrates that the trained space 1 reconstruction model F_{θ3} and the trained space 2 reconstruction model F_{θ3} to the trained space 1 reconstruction model F_{θ11} and the trained space 2 reconstruction model F_{θ11} are associated with the time information T₃ to T₁₁, respectively. The time information may be associated with the trained space 1 reconstruction model and the trained space 2 reconstruction model by directly associating the time information with the trained space 1 reconstruction model and the trained space 2 reconstruction model, or by indirectly associating the time information with the trained space 1 reconstruction model and the trained space 2 reconstruction model through other data.

The server device 410 generates a time series of view images corresponding to viewpoint information, time information, and space information included in the request received from the client terminal 420 by using the trained reconstruction models corresponding to the respective spaces held by the model storage unit 606.

Here, in FIG. 33, as described above, the time information T₁, T₂, T₃, . . . corresponds to the frame period of the captured images captured by the imaging device during the training process. Therefore, the time information T₁, T₂, T₃, . . . corresponds to a frame period when a free-viewpoint moving image is rendered in the free-viewpoint moving image rendering system 400.

Additionally, as illustrated in FIG. 33, the trained space 1 reconstruction models or the trained space 2 reconstruction models associated with the respective time information are mutually different trained space 1 reconstruction models or trained space 2 reconstruction models. The different trained space 1 reconstruction models or the different trained space 2 reconstruction models herein are configured by NNs to which the NeRF technique is applied, and are trained by different training data (captured images). The architectures of the NNs may be the same or partially different.

Here, the trained space 1 reconstruction models or the trained space 2 reconstruction models illustrated in FIG. 33 can generate a view image (a free-viewpoint image) of the scene in the time information for a corresponding space from an arbitrary viewpoint.

Additionally, as illustrated in FIG. 33, the model storage unit 606 holds at least a group of trained space 1 reconstruction models and a group of trained space 2 reconstruction models configured to generate view images of a series of scenes for one single object for each space. However, the group of trained space 1 reconstruction models and the group of trained space 2 reconstruction models held by the model storage unit 606 is not limited to one, and another group of trained space 1 reconstruction models and trained space 2 reconstruction models configured to generate view images of a series of scenes for another single object for each space may be held.

Additionally, as illustrated in FIG. 33, the group of trained space 1 reconstruction models and trained space 2 reconstruction models held by the model storage unit 606 includes 22 trained space 1 reconstruction models and trained space 2 reconstruction models for the time information T₁ to T₁₁ for the sake of space. However, the number of the trained space 1 reconstruction models and the trained space 2 reconstruction models in the group held by the model storage unit 606 is not limited to this.

### Specific Example of Processing by Server Device

Next, a specific example of processing by the default moving image generation unit 602 and the requested moving image generation unit 604 of the server device 410 according to the fifth embodiment will be described.

### (1) Specific Example of Processing by Default Moving Image Generation Unit

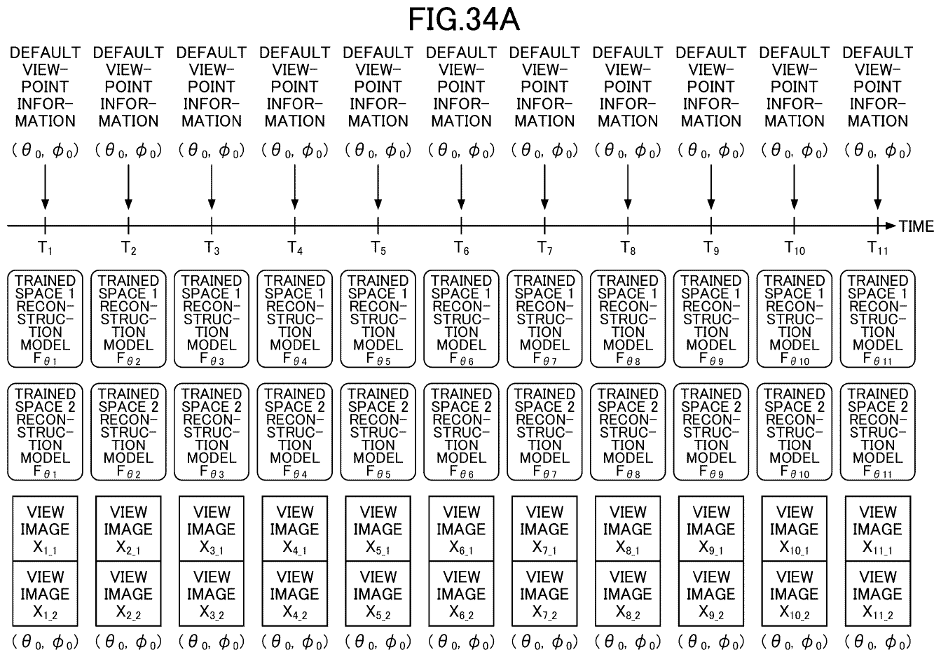

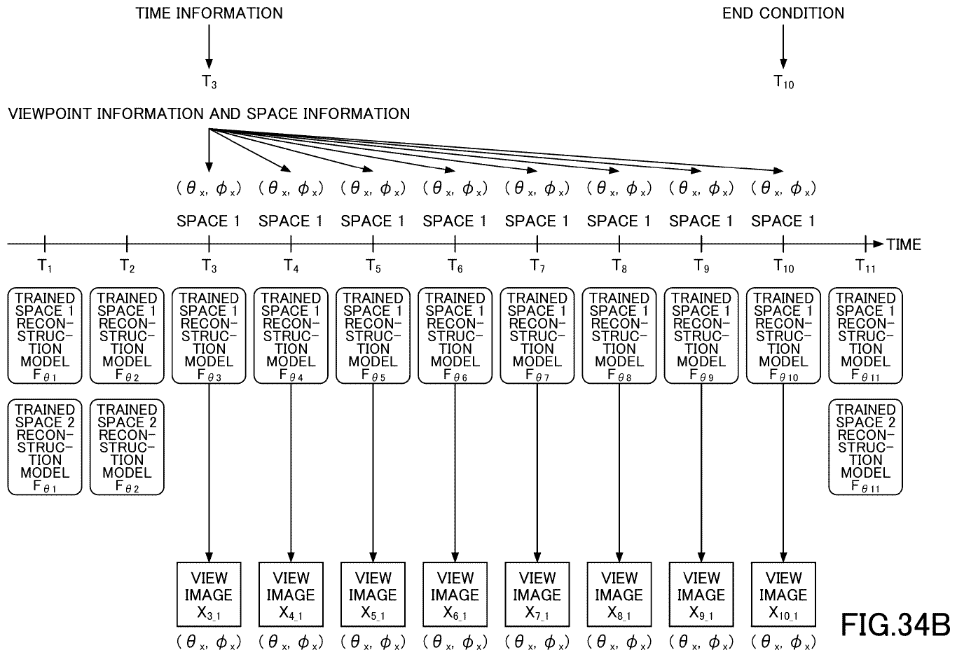

First, a specific example of processing by the default moving image generation unit 602 will be described. FIG. 34A is a first diagram illustrating a specific example of processing by the server device 410 according to the fifth embodiment. FIG. 34A illustrates a specific example of processing when the moving image designation receiving unit 601 receives a designation of a free-viewpoint moving image and the default moving image generation unit 602 receives notification of identification information of the designated free-viewpoint moving image from the moving image designation receiving unit 601.

As illustrated in FIG. 34A, the default moving image generation unit 602 reads the following trained reconstruction models as trained reconstruction models configured to generate view images included in the designated free-viewpoint moving image from the model storage unit 606:
the trained space 1 reconstruction models F_{θ1} to F_{θ11}; and
the trained space 2 reconstruction models F_{θ1} to F_{θ11}.

The default moving image generation unit 602 inputs the default viewpoint information (θ₀, φ₀) into each of the trained space 1 reconstruction models F_{θ1} to F_{θ11} and the trained space 2 reconstruction models F_{θ1} to F_{θ11} that have been read. With this, the trained space 1 reconstruction models F_{θ1} to F_{θ11} generate view images X_{1_1} to X_{11_1} of the space 1 of the scene viewed from the viewpoint based on the default viewpoint information (θ₀, φ₀) in respective time information. Additionally, the trained space 2 reconstruction models F_{θ1} to F_{θ11} generate view images X_{1_2} to X_{11_2} of the space 2 of the scene viewed from the viewpoint based on the default viewpoint information (θ₀, φ₀) in respective time information.

Additionally, the default moving image generation unit 602 notifies the moving image transmitting unit 605 of the view image X_{1_1}, view image X_{1_2} to view image X_{11_1} and view image X_{11_2} that have been generated, in association with the time information T₁ to T₁₁. With this, the moving image transmitting unit 605 transmits the view image X_{1_1} and view image X_{1_2} to the view image X_{11_1} and view image X_{11_2} in a transmission format that can be played back as a moving image by the client terminal 420.

### (2) Specific Example of Processing by Requested Moving Image Generation Unit

As described above, it is assumed that the client terminal 420 plays back a free-viewpoint moving image using the view images X_{1_1} to X_{11_1} and the view images X_{1_2} to X_{11_2} of the scene viewed from the viewpoint based on the default viewpoint information (θ₀, φ₀) as frame images. Additionally, it is assumed that a request including the time information, the viewpoint information, and the space information is transmitted from the client terminal 420 in response to this. In this case, the request receiving unit 603 receives the request and notifies the requested moving image generation unit 604 of the request.

Here, a specific example of the processing performed by the requested moving image generation unit 604 when the request (the time information, the viewpoint information, and the space information) is notified by the request receiving unit 603 will be described. FIG. 34B is a second diagram illustrating a specific example of the processing performed by the server device according to the fifth embodiment, and illustrates a specific example of the processing performed by the requested moving image generation unit 604 when the request is notified by the request receiving unit 603.

As illustrated in FIG. 34B, the requested moving image generation unit 604 identifies the trained space 1 reconstruction model F_{θ3} corresponding to the request (in the example of FIG. 34B, T₃, the space 1) from the trained space 1 reconstruction models and the trained space 2 reconstruction models that have already been read.

Additionally, the requested moving image generation unit 604 inputs the viewpoint information (in the example of FIG. 34B, (θₓ, φₓ)) included in the request into the identified trained space 1 reconstruction model F_{θ3}. With this, the trained space 1 reconstruction model F_{θ3} generates the view image X_{3_1} of the space 1 of the scene viewed from the viewpoint based on the viewpoint information (θₓ, φₓ) included in the request in the time information T₃.

Subsequently, the requested moving image generation unit 604 identifies the trained space 1 reconstruction model F_{θ4} corresponding to the next time information (the next time point) as the next trained reconstruction model. Additionally, the requested moving image generation unit 604 inputs the viewpoint information (in the example of FIG. 34B, (θₓ, φₓ)) included in the request into the identified trained space 1 reconstruction model F_{θ4}. With this, the trained space 1 reconstruction model F_{θ4} generates a view image X_{4_1} of the space 1 of the scene viewed from the viewpoint based on the viewpoint information (θₓ, φₓ) included in the request in the time information T₄.

Hereinafter, the requested moving image generation unit 604 repeats substantially the same processing until an end condition is transmitted from the client terminal 420. The example of FIG. 34B indicates a state in which the time information T₁₀ is transmitted as the end condition from the client terminal 420.

When the time information T₁₀ is transmitted as the end condition from the client terminal 420, the requested moving image generation unit 604 identifies the trained space 1 reconstruction model F_{θ10} corresponding to the time information T₁₀ transmitted as the end condition, as the last trained reconstruction model. Additionally, the requested moving image generation unit 604 inputs the viewpoint information (in the example of FIG. 34B, (θₓ, φₓ)) included in the request into the identified trained space 1 reconstruction model F_{θ10}. With this, the trained space 1 reconstruction model F_{θ10} generates the view image X₁₀ of the space 1 of the scene viewed from the viewpoint based on the viewpoint information (θₓ, φₓ) included in the request in the time information T₁₀.

As described above, the requested moving image generation unit 604 generates the view images of the time series of the first time interval, corresponding to the viewpoint information, using the trained reconstruction models for the time series of the first time interval, corresponding to the space information included in the request, from the trained reconstruction model corresponding to the time information included in the request to the trained reconstruction model corresponding to the predetermined end condition.

The requested moving image generation unit 604 sequentially notifies the moving image transmitting unit 605 of the generated view images X_{3_1} to X_{10_1} of the space 1 in association with the time information T₃ to T₁₀. With this, the moving image transmitting unit 605 can transmit the view images X_{3_1} to X_{10_1} in a transmission format that can be played back as a moving image by the client terminal 420.

### Flow of Free-Viewpoint Moving Image Rendering Process

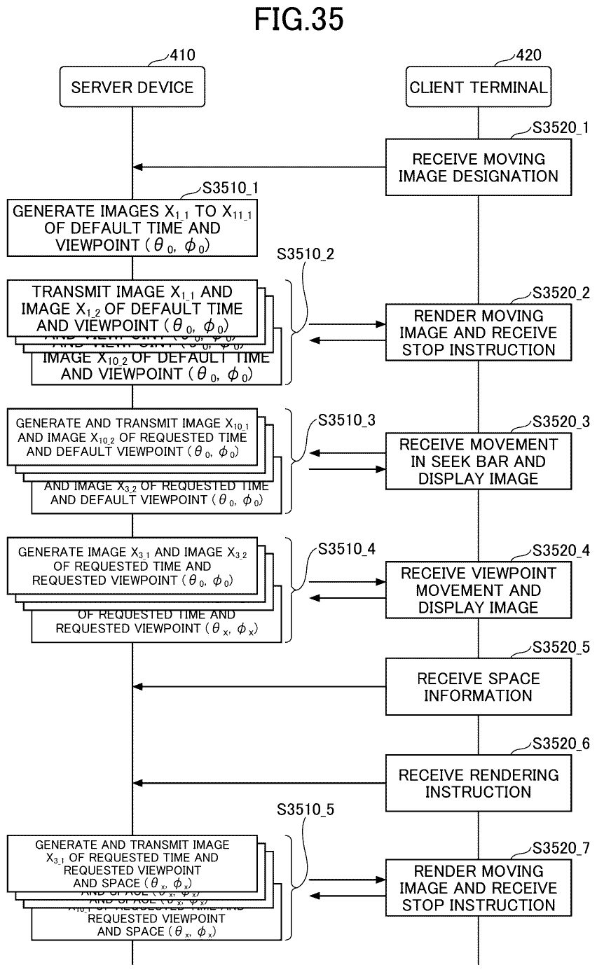

Next, a flow of a free-viewpoint moving image rendering process by the free-viewpoint moving image rendering system 400 will be described. FIG. 35 is a second sequence diagram illustrating the flow of the free-viewpoint moving image rendering process by the free-viewpoint moving image rendering system.

In step S3520_1, the client terminal 420 receives a designation of the free-viewpoint moving image to be displayed from the user 440, and transmits, to the server device 410, the identification information for uniquely identifying the designated free-viewpoint moving image.

In step S3510_1, the server device 410 reads the group of trained space 1 reconstruction models and trained space 2 reconstruction models of the space 1 and the space 2 configured to generate the view images included in the designated free-viewpoint moving image. Additionally, the server device 410 inputs the default viewpoint information (θ₀, φ₀) into the trained space 1 reconstruction models and trained space 2 reconstruction models that have been read to generate the view images X_{1_1} to X_{11_1} of the space 1 and view images X_{1_2} to X_{11_2} of the space 2.

In step S3510_2, the server device 410 sequentially transmits the generated view images of the space 1 and the space 2 to the client terminal 420.

In step S3520_2, the client terminal 420 plays back the free-viewpoint moving image using the view images of the space 1 and the space 2 transmitted from the server device 410 as frame images. Additionally, the client terminal 420 receives the stop instruction of the free-viewpoint moving image being rendered and transmits it to the server device 410. With this, the server device 410 stops transmitting the view images of the space 1 and the space 2.

In step S3520_3, the client terminal 420 receives a movement instruction of the indicator 1112′ in the seek bar 1112. The client terminal 420 sequentially transmits the time information of each position of the moving indicator 1112′ to the server device 410.

In step S3510_3, the server device 410 inputs the default viewpoint information into the trained space 1 reconstruction model and the trained space 2 reconstruction model of the space 1 and the space 2 corresponding to the time information of the position every time the time information of each position of the moving indicator 1112′ is received from the client terminal 420. With this, the server device 410 generates the view images of the space 1 and the space 2. Additionally, the server device 410 sequentially transmits the generated view images of the space 1 and the space 2 to the client terminal 420. With this, the view images of the space 1 and the space 2 corresponding to the time information of each position of the moving indicator 1112′ are displayed on the client terminal 420.

In step S3520_4, the client terminal 420 receives the dragging of the moving image display area by the mouse pointer 1116. The client terminal 420 transmits the viewpoint information of each position of the moving mouse pointer 1116 to the server device 410.

In step S3510_4, every time the viewpoint information of each position of the moving mouse pointer 1116 is received from the client terminal 420, the server device 410 inputs the viewpoint information of each position to the trained space 1 reconstruction model and the trained space 2 reconstruction model of the space 1 and the space 2 corresponding to the current time information. Thus, the server device 410 generates view images of the space 1 and the space 2. Additionally, the server device 410 sequentially transmits the generated view images of the space 1 and the space 2 into the client terminal 420. With this, the client terminal 420 displays the view images of the space 1 and the space 2 corresponding to the viewpoint information of each position of the moving mouse pointer 1116.

In step S3520_5, the client terminal 420 receives the input of the space information (for example, the space 1) and transmits it to the server device 410.

In step S3520_6, when the play button 1114 is pressed, the client terminal 420 transmits a rendering instruction to the server device 410.

In step S3510_5, the server device 410 inputs the current viewpoint information into the trained space 1 reconstruction model corresponding to the current time information and the input space information (the space 1), thereby generating the view image of the space 1 and transmitting it to the client terminal 420. Subsequently, the server device 410 inputs the current viewpoint information into the trained space 1 reconstruction model corresponding to the next time information and the input space information (the space 1), thereby generating the view image of the space 1 and transmitting it to the client terminal 420. Hereinafter, the server device 410 repeats substantially the same processing until the end condition is transmitted from the client terminal 420.

In step S3520_7, the client terminal 420 plays back the free-viewpoint moving image using the view images of the space 1 transmitted from the server device 410 as frame images. Additionally, the client terminal 420 receives a stop instruction of the free-viewpoint moving image being rendered and transmits it to the server device 410. With this, the server device 410 stops generating and transmitting the view image of the space 1.

### Summary

As is apparent from the above description, the server device 410 according to the fifth embodiment includes one or more memories and one or more processors. The one or more memories hold the trained space 1 reconstruction models or the trained space 2 reconstruction models (the first reconstruction models) that are configured to generate the view images of the time series of the first time interval for a specific space, and that are the trained space 1 reconstruction models or trained space 2 reconstruction models (the first reconstruction models) for the time series of the first time interval.

Additionally, one or more processors included in the server device 410 according to the fifth embodiment generate the view images of the time series of the first time interval, corresponding to the viewpoint information, by using the trained space 1 reconstruction models or trained space 2 reconstruction models for the time series of the first time interval (the first reconstruction models) from the trained space 1 reconstruction model or trained space 2 reconstruction model (the first reconstruction model) corresponding to the time information included in the request to the trained space 1 reconstruction model or trained space 2 reconstruction model (the first reconstruction model) corresponding to the predetermined end condition. The trained space 1 reconstruction models or trained space 2 reconstruction models for the time series of the first time interval (the first reconstruction models) are trained reconstruction models corresponding to the space information included in the request.

As described above, according to the fifth embodiment, a mechanism for rendering a free-viewpoint moving image with respect to a specific space can be constructed.

### Sixth Embodiment

In the first to fifth embodiments, the user 440 inputs time information and the viewpoint information (and the space information) to the client terminal 420, and the server device 410 generates the view image corresponding to the input time information and the viewpoint information (and the space information).

However, the mechanism for rendering the free-viewpoint moving image by the client terminal 420 is not limited to this. For example, the user 440 inputs the time information (and the space information), and the server device 410 may transmit a trained reconstruction model corresponding to the input time information (and the space information) to the client terminal 420. In this case, the client terminal 420 executes the received trained reconstruction models for the time series based on the viewpoint information input by the user 440, thereby generating view images corresponding to the viewpoint information, and playing back a free-viewpoint moving image. With this, a free-viewpoint moving image can be rendered by a mechanism different from that of the first to fifth embodiments. Hereinafter, a sixth embodiment will be described focusing on differences from the first embodiment.

### System Configuration of a Free-Viewpoint Moving Image Rendering System

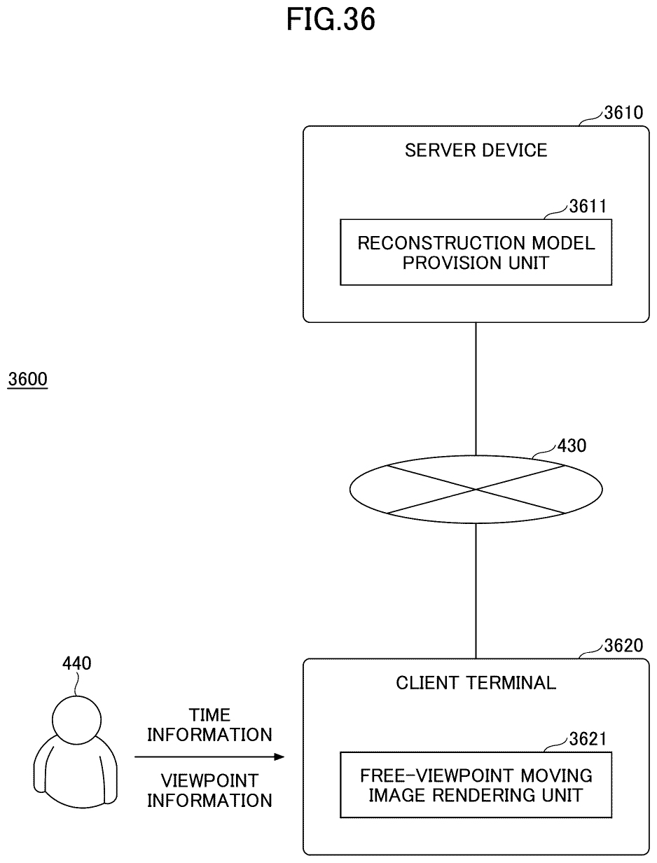

First, a system configuration of a free-viewpoint moving image rendering system including a server device according to the sixth embodiment will be described. FIG. 36 is a second diagram illustrating an example of the system configuration of the free-viewpoint moving image rendering system.

As illustrated in FIG. 36, a free-viewpoint moving image rendering system 3600 includes a server device 3610 and a client terminal 3620 according to the sixth embodiment. In the free-viewpoint moving image rendering system 3600, the server device 3610 and the client terminal 3620 are communicatively connected via the communication network 430.

A reconstruction model providing program is installed in the server device 3610, and when the program is executed, the server device 3610 functions as a reconstruction model provision unit 3611.

The reconstruction model provision unit 3611 receives a request from the client terminal 3620 via the communication network 430. Additionally, the reconstruction model provision unit 3611 transmits, to the client terminal 3620, trained reconstruction models for the time series read from the model storage unit 606 based on the time information included in the received request.

A free-viewpoint moving image rendering program is installed in the client terminal 3620, and when the program is executed, the client terminal 3620 functions as a free-viewpoint moving image rendering unit 3621. Here, the free-viewpoint moving image rendering program may be a dedicated application or a predetermined browser.

The free-viewpoint moving image rendering unit 3621 transmits a request including the time information input by the user 440 to the server device 3610 via the communication network 430.

Additionally, the free-viewpoint moving image rendering unit 3621 receives the trained reconstruction models for the time series transmitted from the server device 3610 in response to the transmission of the request to the server device 3610. Additionally, the free-viewpoint moving image rendering unit 3621 executes the received trained reconstruction models for the time series based on the viewpoint information input by the user 440, thereby generating a time series of view images corresponding to the viewpoint information in the respective time information, and plays back the free-viewpoint moving image using the generated view images as frame images of the moving image.

### Functional Configuration of Server Device

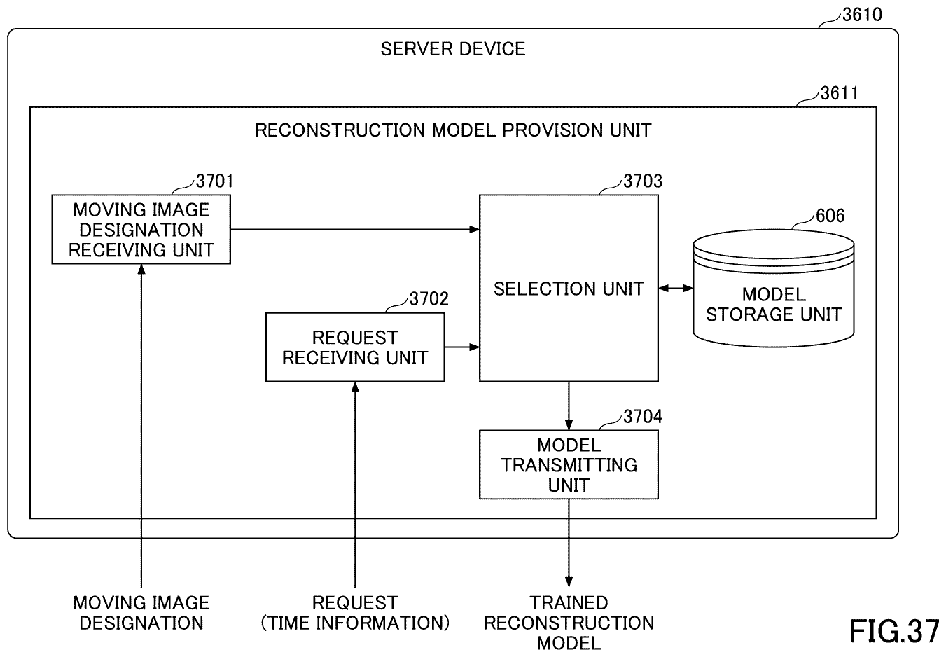

Next, a functional configuration of the server device 3610 according to the sixth embodiment will be described. FIG. 37 is a second diagram illustrating an example of the functional configuration of the server device. As described above, the server device 3610 functions as the reconstruction model provision unit 3611. As illustrated in FIG. 37, the reconstruction model provision unit 3611 further includes a moving image designation receiving unit 3701, a request receiving unit 3702, a selection unit 3703, and a model transmitting unit 3704.

The moving image designation receiving unit 3701 receives a designation of a free-viewpoint moving image from the client terminal 3620. It is assumed that the server device 3610 according to the sixth embodiment is configured to provide, to the client terminal 3620, a plurality of groups of trained reconstruction models configured to generate view images included in the free-viewpoint moving image. The moving image designation receiving unit 3701 receives a designation of one of the free-viewpoint moving images. The moving image designation receiving unit 3701 notifies the selection unit 3703 of identification information (for example, an identifier (ID) of the free-viewpoint moving image) for uniquely identifying the free-viewpoint moving image for which the designation has been received.

The request receiving unit 3702 receives the request transmitted from the client terminal 3620. In the present embodiment, it is assumed that the request transmitted from the client terminal 3620 includes the time information input by the user 440. The request received by the request receiving unit 3702 is notified to the selection unit 3703.

The selection unit 3703 notifies the model transmitting unit 3704 of the trained reconstruction model configured to generate a view image included in the free-viewpoint moving image identified by the identification information notified by the moving image designation receiving unit 3701 and corresponding to the time information notified by the request receiving unit 3702. Specifically, the selection unit 3703 reads a group of trained reconstruction models configured to generate view images of respective time information (respective time points) included in the free-viewpoint moving image notified by the moving image designation receiving unit 3701 from among the plurality of groups of trained reconstruction models held by the model storage unit 606. Additionally, the selection unit 3703 notifies the model transmitting unit 3704 of at least a part of the trained reconstruction models corresponding to the time information notified by the request receiving unit 3702 among the group of trained reconstruction models that has been read.

Here, the selection unit 3703 performs processing corresponding to the type of the time information notified by the request receiving unit 3702. For example, it is assumed that the time information included in the request is time information based on the rendering instruction in the client terminal 3620. This time information may be, for example, a time point when the user 440 issues the rendering instruction to the moving image regardless of whether the moving image is being rendered or stopped in the client terminal 3620. In this case, the selection unit 3703 sequentially notifies the model transmitting unit 3704 of the trained reconstruction model corresponding to the time information notified by the request receiving unit 3702 among the trained reconstruction models that have been already read.

Additionally, it is assumed that the time information included in the request is time information based on a stop instruction in the client terminal 3620 (an example of time information corresponding to the end condition). This time information may be, for example, a time point when the user 440 issues a rendering stop instruction to the moving image being rendered in the client terminal 3620. In this case, the selection unit 3703 identifies the trained reconstruction model corresponding to the time information notified by the request receiving unit 3702 among the trained reconstruction models that have been already read, as the last trained reconstruction model during the rendering, and notifies the model transmitting unit 3704. Then, the selection unit 3703 stops the processing after notifying the model transmitting unit 3704 of the last identified trained reconstruction model.

Additionally, for example, it is assumed that the time information included in the request is time information based on an operation instruction during a stopped state in the client terminal 3620. This time information may be, for example, time information based on an operation instruction (for example, an operation instruction to the indicator of the seek bar) performed by the user 440 for a scene to be displayed in a stopped state with respect to the moving image being stopped in the client terminal 3620. In this case, every time the time information is notified by the request receiving unit 3702, the selection unit 3703 notifies the model transmitting unit 3704 of the trained reconstruction model corresponding to the time information.

The model transmitting unit 3704 transmits, to the client terminal 3620, the trained reconstruction model notified by the selection unit 3703. Here, the trained reconstruction model transmitted by the model transmitting unit 3704 to the client terminal 3620 may be the trained reconstruction model itself (program), model parameters (including, for example, weight parameters of the NN), hyperparameters (including, for example, the number of layers of the NN and the number of nodes in each layer) of the trained reconstruction model, or a combination thereof. Alternatively, if the model transmitting unit 3704 has already transmitted the trained reconstruction model to the client terminal 3620, it may be information for identifying the transmitted trained reconstruction model.

That is, the trained reconstruction model transmitted by the model transmitting unit 3704 indicates information for enabling the client terminal 3620 to execute the target trained reconstruction model.

As described, the model transmitting unit 3704 transmits, to the client terminal 3620, the trained reconstruction model notified by the selection unit 3703 in a transmission format that can be executed by the client terminal 3620.

Here, in the following description, it is assumed that the model transmitting unit 3704 transmits the trained reconstruction model itself (program).

### Example of Trained Reconstruction Model

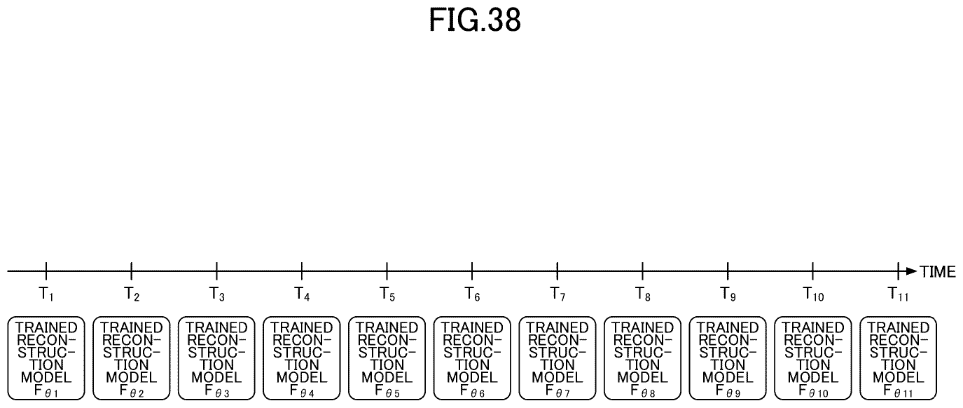

Next, the trained reconstruction model held by the model storage unit 606 in the server device 3610 according to the sixth embodiment will be described. FIG. 38 is a diagram illustrating an example of the trained reconstruction model held by the model storage unit of the server device according to the sixth embodiment.

As illustrated in FIG. 38, the trained reconstruction model held by the model storage unit 606 is associated with time information. Specifically, the trained reconstruction model F_{θ1} is associated with the time information T₁, and the trained reconstruction model F_{θ2} is associated with the time information T₂. Similarly, the example of FIG. 38 indicates that the trained reconstruction models F_{θ3} to F_{θ11} are associated with the time information T₃ to T₁₁, respectively. The association between the time information and the trained reconstruction model may be made by directly associating the time information with the trained reconstruction model, or by indirectly associating the time information with the trained reconstruction model through other data.

Here, the trained reconstruction models F_{θ1} to F_{θ11} illustrated in FIG. 38 are the same as the trained reconstruction models F_{θ1} to F_{θ11} illustrated in FIG. 7.

### Specific Example of Processing by Server Device

Next, a specific example of processing by each unit (here, the selection unit 3703) of the server device 3610 will be described.

### (1) Specific Example 1 of Processing by Selection Unit

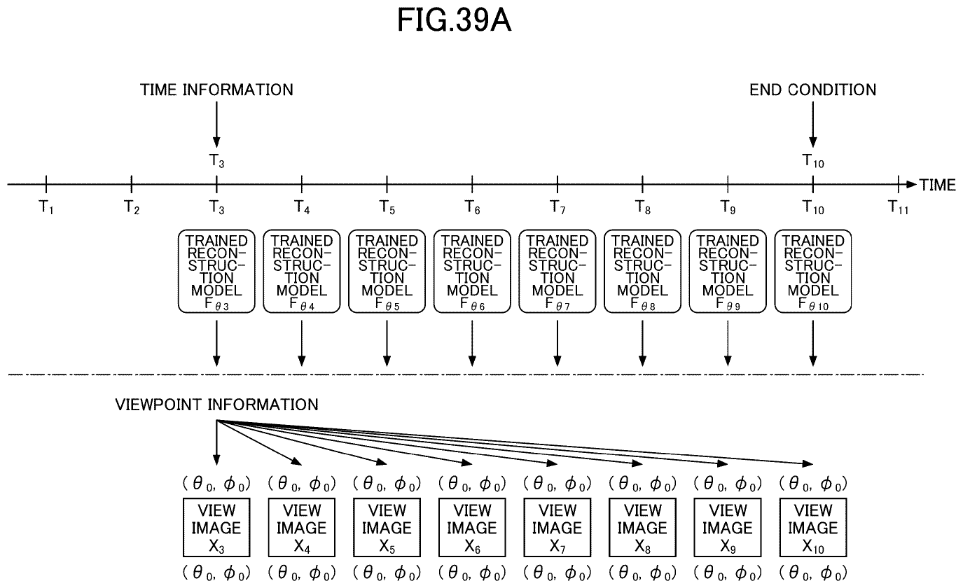

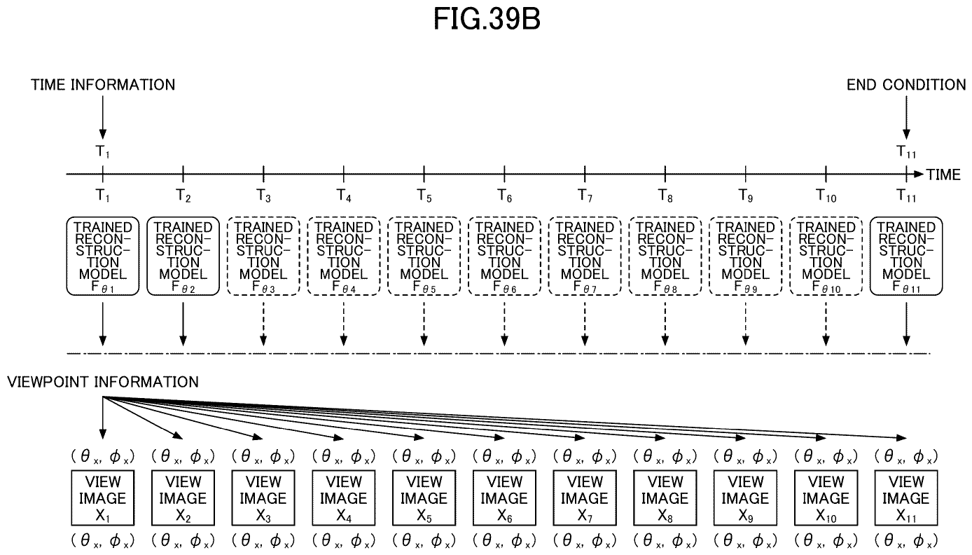

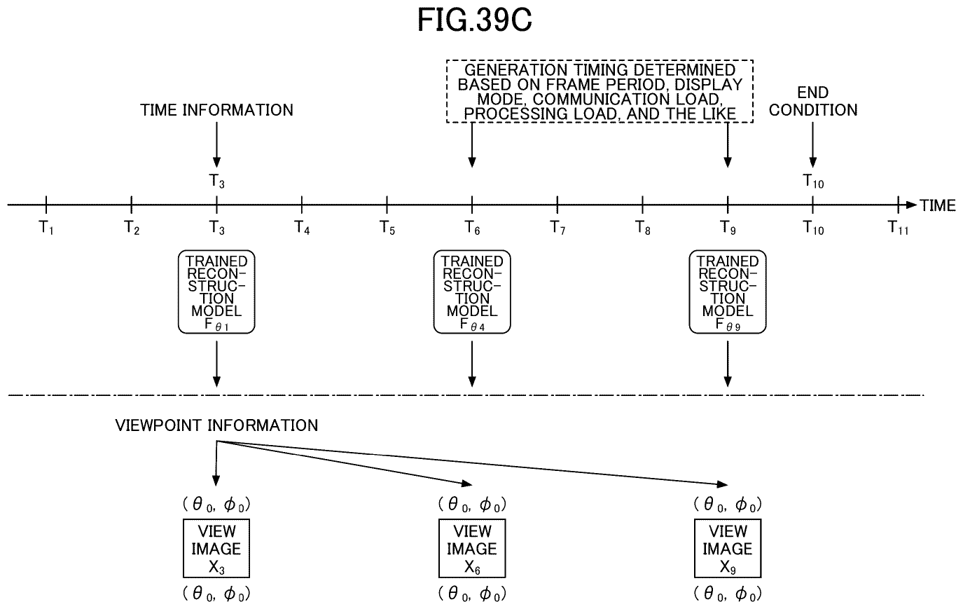

FIG. 39A is a first diagram illustrating a specific example of processing by the server device according to the sixth embodiment. FIG. 39A illustrates a specific example of the processing when the selection unit 3703 is notified of the identification information of the designated free-viewpoint moving image from the moving image designation receiving unit 3701 and is notified of the time information included in the request from the request receiving unit 3702.

As illustrated in FIG. 39A, the selection unit 3703, having been notified of the identification information of the designated free-viewpoint moving image, reads the trained reconstruction models F_{θ1} to F_{θ11} configured to generate the view images included in the designated free-viewpoint moving image from the model storage unit 606.

Additionally, the selection unit 3703 identifies the trained reconstruction model F_{θ3} corresponding to the time information (in the example of FIG. 39A, T₃) included in the request from among the trained reconstruction models F_{θ1} to F_{θ11} that have been read and notifies the model transmitting unit 3704. With this, the model transmitting unit 3704 transmits the notified trained reconstruction model F_{θ3} to the client terminal 3620. As a result, the client terminal 3620 executes the trained reconstruction model F_{θ3} based on the default viewpoint information, and generates a view image (for example, a view image X₃) of the scene viewed from the viewpoint based on the default viewpoint information (θ₀, φ₀) in the time information T₃. Further, the client terminal 3620 plays back a free-viewpoint moving image using the generated view image X₃ as a frame image.

Subsequently, the selection unit 3703 identifies the trained reconstruction model F_{θ4} corresponding to the next time information (the next time point) as the next trained reconstruction model and notifies the model transmitting unit 3704. With this, the model transmitting unit 3704 transmits the notified trained reconstruction model F_{θ4} to the client terminal 3620. As a result, the client terminal 3620 executes the trained reconstruction model F_{θ4} based on the default viewpoint information (θ₀, φ₀), and generates a view image (for example, a view image X₄) of the scene viewed from the viewpoint based on the default viewpoint information (θ₀, φ₀) in the time information T₄. Furthermore, the client terminal 3620 plays back a free-viewpoint moving image using the generated view image X₄ as a frame image.

Hereinafter, the selection unit 3703 repeats substantially the same processing until an end condition is transmitted from the client terminal 3620. The example of FIG. 39A indicates a state in which the time information T₁₀ is transmitted as the end condition from the client terminal 3620.

Here, the end condition refers to time information based on the stop instruction for stopping rendering of the free-viewpoint moving image in response to the request. When a stop button for stopping the free-viewpoint moving image being rendered is pressed, the client terminal 3620 transmits, to the server device 3610, the time information corresponding to the pressed timing as the end condition. Alternatively, the client terminal 3620 transmits, to the server device 3610, the time information corresponding to the end timing of the time range as the end condition when, for example, the designation of the time range is received when the free-viewpoint moving image is rendered.

When the time information T₁₀ is transmitted as the end condition from the client terminal 3620, the selection unit 3703 identifies, as the last trained reconstruction model, the trained reconstruction model F_{θ10} corresponding to the time information T₁₀ transmitted as the end condition and notifies the model transmitting unit 3704. With this, the model transmitting unit 3704 transmits the notified trained reconstruction model F_{θ10} to the client terminal 3620. As a result, the client terminal 3620 executes the trained reconstruction model F_{θ10} based on the default viewpoint information (θ₀, φ₀). Additionally, the client terminal 3620 generates a view image (for example, a view image X₁₀) of the scene viewed from the viewpoint based on the default viewpoint information (θ₀, φ₀) in the time information T₁₀. Further, the client terminal 3620 plays back a free-viewpoint moving image using the generated view image X₁₀ as a frame image.

### (2) Specific Example 2 of Processing by Selection Unit

As described above, it is assumed that the trained reconstruction model F_{θ3} to the trained reconstruction model F_{θ10} from the time information T₃ included in the request to the time information T₁₀ corresponding to the end condition are transmitted to the client terminal 3620. Additionally, with this, it is assumed that the free-viewpoint moving image using the view image X₃ to the view image X₁₀ as frame images is played back in the client terminal 3620. Furthermore, accompanying this, it is assumed that a request including the time information is transmitted from the client terminal 3620, and the viewpoint information is input by the user 440 in the client terminal 3620. In this case, the request receiving unit 3702 receives the request and notifies the selection unit 3703 of the request.

Here, a specific example of the processing performed by the selection unit 3703 when the request receiving unit 3702 notifies the request (the time information) will be described. FIG. 39B is a second diagram illustrating a specific example of the processing performed by the server device according to the sixth embodiment, and illustrates a specific example of the processing performed by the selection unit 3703 when the request receiving unit 3702 notifies the request.

As illustrated in FIG. 39B, the selection unit 3703 identifies the trained reconstruction model F_{θ1} corresponding to the time information (in the example of FIG. 39B, T₁) included in the request among the trained reconstruction models F_{θ1} to F_{θ11} that have been already read from the model storage unit 606.

Additionally, the selection unit 3703 notifies the model transmitting unit 3704 of the identified trained reconstruction model F_{θ1}. With this, the model transmitting unit 3704 transmits the notified trained reconstruction model F_{θ1} to the client terminal 3620.

As a result, the client terminal 3620 executes the trained reconstruction model F_{θ1} based on the viewpoint information (θₓ, φₓ) input by the user 440. Additionally, the client terminal 3620 generates a view image (for example, a view image X₁) of the scene viewed from the viewpoint based on the viewpoint information (θₓ, φₓ) in the time information T₁. Further, the client terminal 3620 plays back a free-viewpoint moving image using the generated view image X₁ as a frame image.

Subsequently, the selection unit 3703 identifies the trained reconstruction model F_{θ2} corresponding to the next time information (the next time point) as the next trained reconstruction model and notifies the model transmitting unit 3704. With this, the model transmitting unit 3704 transmits the notified trained reconstruction model F_{θ2} to the client terminal 3620. As a result, the client terminal 3620 executes the trained reconstruction model F_{θ2} based on the viewpoint information (θₓ, φₓ) input by the user 440. Additionally, the client terminal 3620 generates a view image (for example, a view image X₂) of the scene viewed from the viewpoint based on the viewpoint information (θₓ, φₓ) in the time information T₂. Further, the client terminal 3620 plays back a free-viewpoint moving image using the generated view image X₂ as a frame image.

Subsequently, the selection unit 3703 identifies the trained reconstruction model F_{θ3} corresponding to the next time information (the next time point) as the next trained reconstruction model and notifies the model transmitting unit 3704. With this, the model transmitting unit 3704 transmits the notified trained reconstruction model F_{θ3} to the client terminal 3620. As a result, the client terminal 3620 executes the trained reconstruction model F_{θ3} based on the viewpoint information (θₓ, φₓ) input by the user 440. Additionally, the client terminal 3620 generates a view image (for example, a view image X₃) of the scene viewed from the viewpoint based on the viewpoint information (θₓ, φₓ) in the time information T₃. Further, the client terminal 3620 plays back a free-viewpoint moving image using the generated view image X₃ as a frame image.

Hereinafter, the selection unit 3703 repeats substantially the same processing until an end condition is transmitted from the client terminal 3620. The example of FIG. 39B indicates a state in which the time information T₁₁ is transmitted as the end condition from the client terminal 3620.

When the time information T₁₁ is transmitted as the end condition from the client terminal 3620, the selection unit 3703 identifies, as the last trained reconstruction model, the trained reconstruction model F_{θ11} corresponding to the time information T₁₁ transmitted as the end condition. Additionally, the selection unit 3703 notifies the model transmitting unit 3704 of the identified trained reconstruction model F_{θ11}. With this, the model transmitting unit 3704 transmits the notified trained reconstruction model F_{θ11} to the client terminal 3620. As a result, the client terminal 3620 executes the trained reconstruction model F_{θ11} based on the viewpoint information (θₓ, φₓ) input by the user 440. Additionally, the client terminal 3620 generates a view image (for example, a view image X₁₁) of the scene viewed from the viewpoint based on the viewpoint information (θₓ, φₓ) in the time information T₁₁. Further, the client terminal 3620 plays back a free-viewpoint moving image using the generated view image X₁₁ as a frame image.

Here, in the above description, the selection unit 3703 is configured to notify the model transmitting unit 3704 of all the identified trained reconstruction models. However, the processing by the selection unit 3703 is not limited to this. For example, the selection unit 3703 may be configured not to notify the model transmitting unit 3704 when recognizing that the identified trained reconstruction model has already been transmitted to the client terminal 3620.

Specifically, in the case of FIG. 39B, the selection unit 3703 may be configured not to notify the model transmitting unit 3704 of the trained reconstruction models F_{θ3} to F_{θ10}.

### (3) Specific Example 3 of Processing by the Selection Unit

Next, another specific example (different from Specific Example 1) of the processing by the selection unit 3703 when the request (the time information) is notified by the request receiving unit 3702 will be described. In Specific Example 1, the selection unit 3703 identifies the next trained reconstruction model at a time interval corresponding to a frame period when identifying the next trained reconstruction model.

With respect to the above, in the free-viewpoint moving image rendering system 3600, even if the identified trained reconstruction model is transmitted, it is not always possible to play back all view images as frame images in the client terminal 3620. For example, it is not always possible to play back all the view images as frame images in the client terminal 3620:
when the frame period of the client terminal 3620 is longer than the time interval of the transmitted trained reconstruction models for the time series;
when the display mode of the client terminal 3620 is the double speed mode or the ten-second skip mode;
when the communication load between the server device 3610 and the client terminal 3620 is high and the communication speed is reduced;
when the processing load of the server device 3610 or the client terminal 3620 is increased, or the like.
   Here, a specific example of processing (frame skipping processing) by the selection unit 3703 in a case where all the view images cannot be played back as frame images in the client terminal 3620 will be described. FIG. 39C is a third diagram illustrating a specific example of the processing by the server device according to the sixth embodiment.

As illustrated in FIG. 39C, the selection unit 3703 identifies the trained reconstruction model F_{θ3} corresponding to the time information (in the example of FIG. 39C, T₃) included in the request among the trained reconstruction models F_{θ1} to F_{θ11} that have been already read from the model storage unit 606.

Additionally, the selection unit 3703 notifies the model transmitting unit 3704 of the identified trained reconstruction model F_{θ3}. With this, the model transmitting unit 3704 transmits the notified trained reconstruction model F_{θ3} to the client terminal 3620. As a result, the client terminal 3620 executes the trained reconstruction model F_{θ3} based on the default viewpoint information (θ₀, φ₀), and generates a view image (for example, a view image X₃) of the scene viewed from the viewpoint based on the default viewpoint information (θ₀, φ₀) in the time information T₃. Further, the client terminal 3620 plays back a free-viewpoint moving image using the generated view image X₃ as a frame image.

Subsequently, the selection unit 3703 determines the generation timing of the view image when identifying the next trained reconstruction model. The selection unit 3703 acquires information related to:
the frame period in the client terminal 3620;
the display mode in the client terminal 3620;
the communication load between the server device 3610 and the client terminal 3620; and
the processing loads of the server device 3610 and the client terminal 3620, and determines the generation timing of the view image based on the acquired information.

The example of FIG. 39C indicates a state in which the selection unit 3703 determines that the generation timing of the view image is the time information T₆, and identifies the trained reconstruction model F_{θ6} as the next trained reconstruction model.

Additionally, the example of FIG. 39C indicates a state in which the selection unit 3703 notifies the model transmitting unit 3704 of the identified trained reconstruction model F_{θ6}, and the notified trained reconstruction model F_{θ6} is transmitted to the client terminal 3620. Additionally, the example of FIG. 39C indicates a state in which the client terminal 3620 executes the trained reconstruction model F_{θ6} based on the default viewpoint information (θ₀, φ₀). Further, the example of FIG. 39C indicates a state in which the view image (for example, view image X₆) of the scene viewed from the viewpoint based on the default viewpoint information (θ₀, φ₀) in the time information T₆ is generated.

As illustrated in FIG. 39C, the selection unit 3703 repeats substantially the same processing (frame skipping processing) until the end condition is transmitted from the client terminal 3620. In the example of FIG. 39C, the time information T₁₀ is transmitted as the end condition from the client terminal 3620.

When the time information T₁₀ is transmitted as the end condition from the client terminal 3620, the selection unit 3703 determines that it is not the generation timing of the view image, and stops the processing without identifying the trained reconstruction model F_{θ6}.

### Functional Configuration of Client Terminal

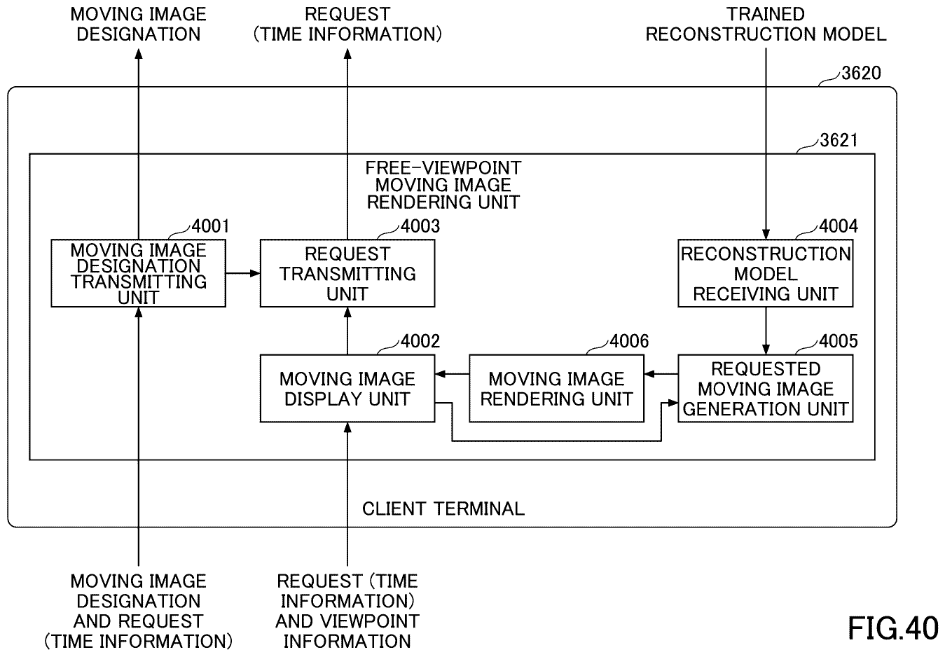

Next, a functional configuration of the client terminal 3620 according to the sixth embodiment will be described. FIG. 40 is a second diagram illustrating an example of the functional configuration of the client terminal. As described above, the client terminal 3620 functions as the free-viewpoint moving image rendering unit 3621. As illustrated in FIG. 40, the free-viewpoint moving image rendering unit 3621 further includes a moving image designation transmitting unit 4001, a moving image display unit 4002, a request transmitting unit 4003, a reconstruction model receiving unit 4004, a requested moving image generation unit 4005, and a moving image rendering unit 4006.

The moving image designation transmitting unit 4001 receives, for example, a designation of a free-viewpoint moving image from the user 440 via a moving image designation screen and input of time information for rendering the free-viewpoint moving image. Additionally, the moving image designation transmitting unit 4001 transmits, to the server device 3610, identification information for uniquely identifying the free-viewpoint moving image for which the designation has been received. The moving image designation transmitting unit 4001 notifies the request transmitting unit 4003 of a request including the time information for which the input has been received.

The request transmitting unit 4003 transmits, to the server device 3610, the request including the time information notified by the moving image designation transmitting unit 4001. Alternatively, the request transmitting unit 4003 acquires the time information input by the user 440 from the moving image display unit 4002 via the moving image playback screen on which the free-viewpoint moving image is played back, and transmits the request including the acquired time information to the server device 3610.

During rendering, the moving image display unit 4002 plays back, on the moving image playback screen, the free-viewpoint moving image using the view images notified by the moving image rendering unit 4006 at a predetermined frame period as frame images. Additionally, the moving image display unit 4002 receives the time information input by the user 440 on the moving image playback screen on which the free-viewpoint moving image is played back, and notifies the time information to the request transmitting unit 4003.

Here, as described above, the time information included in the request notified to the request transmitting unit 905 includes:
time information based on a rendering instruction;
time information based on a stop instruction;
time information based on various operations during a stop; and the like.

Additionally, The moving image display unit 4002 receives the viewpoint information input by the user 440 during a stop on the moving image playback screen on which the free-viewpoint moving image is played back, and notifies the requested moving image generation unit 4005 of the viewpoint information.

Additionally, the moving image display unit 4002 displays the view image notified by the moving image rendering unit 4006 on the moving image playback screen at the notified timing by the time information or viewpoint information being input during a stop.

The reconstruction model receiving unit 4004 receives the trained reconstruction model transmitted from the server device 3610, and notifies the requested moving image generation unit 4005.

The requested moving image generation unit 4005 inputs the default viewpoint information or the viewpoint information notified by the moving image display unit 4002 into the trained reconstruction model notified by the reconstruction model receiving unit 4004, thereby executing the trained reconstruction model and generating a view image. Additionally, the requested moving image generation unit 4005 notifies the moving image rendering unit 4006 of the generated view image.

During rendering, the moving image rendering unit 4006 notifies the moving image display unit 4002 of the view images notified by the requested moving image generation unit 4005 at a predetermined frame period as frame images. Additionally, during a stop, the moving image rendering unit 4006 notifies the moving image display unit 4002 of the view image notified by the requested moving image generation unit 4005.

### Display Screen of Client Terminal

Next, a display screen (a moving image selection screen and a moving image playback screen) of the client terminal 3620 according to the sixth embodiment will be described. Here, the display screen of the client terminal 3620 according to the sixth embodiment is substantially the same as the display screen of the client terminal 420 according to the first embodiment (FIGS. 10 to 13). However, in the case of the moving image designation screen 1000 of the client terminal 3620 according to the sixth embodiment, in addition to being able to designate a free-viewpoint moving image, it may be configured to input time information for specifying a starting position of rendering.

### Flow of Free-Viewpoint Moving Image Rendering Process

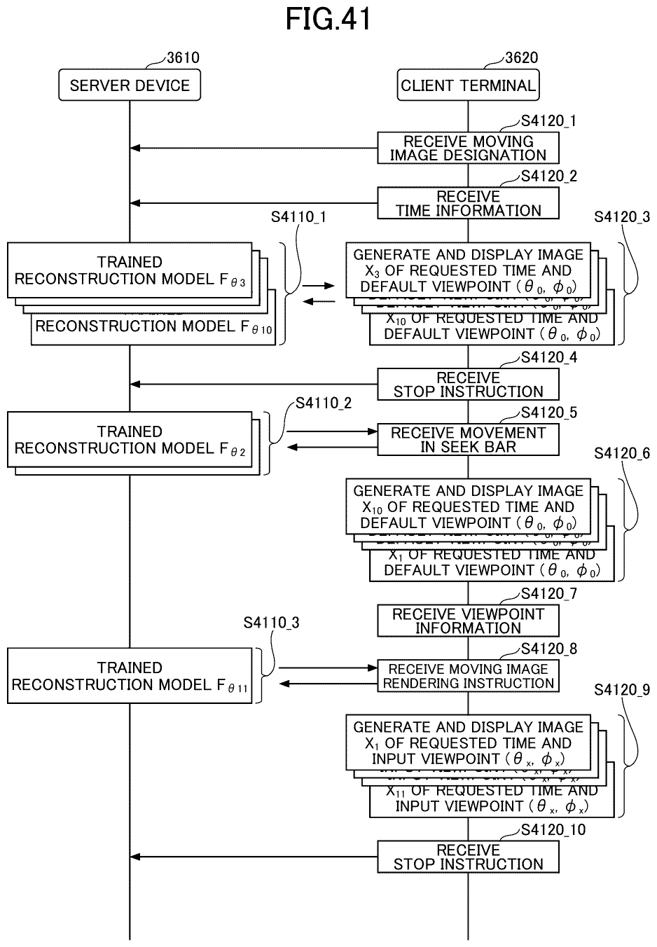

Next, a flow of a free-viewpoint moving image rendering process by the free-viewpoint moving image rendering system 3600 according to the sixth embodiment will be described. FIG. 41 is a third sequence diagram illustrating the flow of the free-viewpoint moving image rendering process by the free-viewpoint moving image rendering system.

In step S4120_1, the client terminal 3620 receives the designation of the free-viewpoint moving image to be displayed from the user 440, and transmits, to the server device 3610, the identification information for uniquely identifying the designated free-viewpoint moving image.

In step S4120_2, the client terminal 3620 receives the input of the time information T₃, and transmits the request including the input time information T₃ to the server device 3610.

In step S4110_1, the server device 3610 reads the group of trained reconstruction models configured to generate view images included in the designated free-viewpoint moving image. Additionally, the server device 3610 sequentially transmits, to the client terminal 3620, the trained reconstruction model F_{θ3} associated with the time information T₃ included in the request from among the group of trained reconstruction models that has been read.

In step S4120_3, the client terminal 3620 receives the trained reconstruction model sequentially transmitted from the server device 3610 and inputs the default viewpoint information (θ₀, φ₀) into the received trained reconstruction model. With this, the client terminal 3620 sequentially generates a view image of the default viewpoint information (θ₀, φ₀) corresponding to the time information T₃ included in the request.

In step S4120_4, the client terminal 3620 receives the stop instruction and transmits the received stop instruction to the server device 3610. With this, the server device 3610 stops the transmission of the trained reconstruction model after transmitting the trained reconstruction model F_{θ10} to the client terminal 3620. As a result, the client terminal 3620 can play back the free-viewpoint moving image using the view images X₃ to X₁₀ of the default viewpoint information (θ₀, φ₀) corresponding to the time information T₃ included in the request as frame images.

In step S4120_5, the client terminal 3620 receives the movement instruction of the indicator 1112′ in the seek bar 1112. The client terminal 3620 sequentially transmits the time information of each position of the moving indicator 1112′ to the server device 3610.

In step S4110_2, each time the server device 3610 receives the time information of the position of the moving indicator 1112′ from the client terminal 3620, the server device 3610 transmits the trained reconstruction model corresponding to the time information of the position to the client terminal 3620. At this time, the server device 3610 does not transmit the trained reconstruction model that has already been transmitted to the client terminal 3620, but transmits the trained reconstruction model that has not been transmitted to the client terminal 3620. In the example of FIG. 41, because the indicator 1112′ of the seek bar 1112 has been moved to the position of the time information T₁, the server device 3610 transmits the trained reconstruction models F_{θ2} and F_{θ1} to the client terminal 3620.

In step S4120_6, the client terminal 3620 generates a view image by inputting default viewpoint information (θ₀, φ₀) into the trained reconstruction model corresponding to the time information of each position of the moving indicator 1112′. With this, the view image corresponding to the time information of each position of the moving indicator 1112′ is displayed on the client terminal 3620. As described above, in the example of FIG. 41, the indicator 1112′ of the seek bar 1112 has been moved to the position of the time information T₁. Therefore, the client terminal 3620 displays the view images X₁₀ to X₁ as view images corresponding to the time information at each position of the moving indicator 1112′.

In step S4120_7, the client terminal 3620 receives the input of the viewpoint information (θₓ, φₓ).

In step S4120_8, when the play button 1114 is pressed, the client terminal 3620 transmits the rendering instruction to the server device 3610.

In step S4110_3, the server device 3610 sequentially transmits, to the client terminal 3620, the trained reconstruction model F_{θ1} associated with the time information T₁ included in the request. However, the server device 3610 does not transmit the trained reconstruction model that has already been transmitted to the client terminal 3620, but transmits the trained reconstruction model that has not been transmitted to the client terminal 3620.

In step S4120_9, the client terminal 3620 inputs the viewpoint information (θₓ, φₓ) into the trained reconstruction models sequentially transmitted from the server device 3610 or the trained reconstruction model that has already been received. With this, the client terminal 3620 sequentially generates the view images of the input viewpoint information (θₓ, φₓ), which are view images corresponding to the time information T₁ included in the request.

In step S4120_10, the client terminal 3620 receives the stop instruction and transmits the received stop instruction to the server device 3610. With this, the server device 3610 transmits the trained reconstruction model F_{θ11} to the client terminal 3620 and then stops transmitting the trained reconstruction model. As a result, the client terminal 3620 can play back the free-viewpoint moving image using the view images X₁ to X₁₁ of the input viewpoint information (θₓ, φₓ), which are view images corresponding to the time information T₁ included in the request, as frame images.

### Summary

As is apparent from the above description, the server device 3610 according to the sixth embodiment includes one or more memories and one or more processors. The one or more memories hold one or more trained reconstruction models (the first reconstruction models) trained in advance so as to reconstruct the scene from the first time to the second time using the time series of captured images from the plurality of viewpoints obtained by capturing the scene from the plurality of viewpoints continuously in time. The one or more trained reconstruction models (the first reconstruction models) are the trained reconstruction models for the time series of the first time interval configured to generate the view images of the time series of the first time interval.

Additionally, the one or more processors are configured to:
receive the request including the time information for the scene from the client terminal; and
transmit, in a transmission format that can be executed by the client terminal, at least a part of the held trained reconstruction models (the first reconstruction models) in response to the request received from the client. Specifically, the trained reconstruction models for time series of the first time interval (the first reconstruction models) from the trained reconstruction model (the first reconstruction model) corresponding to the time information included in the request to the trained reconstruction model (the first reconstruction model) corresponding to the predetermined end condition are transmitted in a transmission format that can be executed by the client terminal.
   With this, the client terminal plays back the free-viewpoint moving image using, as frame images, the time series of view images corresponding to the viewpoint information generated by using at least the part of the trained reconstruction models (the first reconstruction models).

As described above, according to the sixth embodiment, as a mechanism for rendering a free-viewpoint moving image, a mechanism different from that of the first to fifth embodiments can be provided.

### Seventh Embodiment

In the sixth embodiment described above, it is assumed that the model storage unit 606 holds one trained reconstruction model for each piece of time information, and that one trained reconstruction model generates a view image for one piece of time information. However, the trained reconstruction model is not limited to this, and the model storage unit 606 may hold a trained reconstruction model configured to generate view images for a plurality of continuous pieces of time information. Hereinafter, a seventh embodiment will be described, mainly with respect to differences from the sixth embodiment described above.

### Example of Trained Reconstruction Model

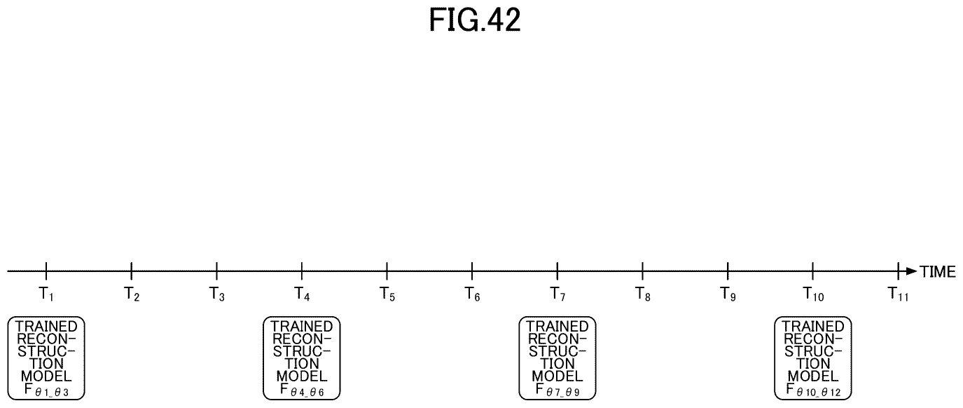

First, a trained reconstruction model held by the model storage unit 606 in the server device 3610 according to the seventh embodiment will be described. FIG. 42 is a diagram illustrating an example of the trained reconstruction model held by the model storage unit of the server device according to the seventh embodiment.

As illustrated in FIG. 42, the trained reconstruction model held by the model storage unit 606 is associated with time information. Specifically, the trained reconstruction model F_{θ1_θ3} is associated with the time information T₁ to T₃, and the trained reconstruction model F_{θ4_θ6} is associated with the time information T₄ to T₆. Similarly, the example of FIG. 42 indicates that the trained reconstruction models F_{θ7_θ9} and F_{θ10_θ12} are associated with the time information T₇ to T₉ and T₁₀ to T₁₂, respectively. That is, each model has time information to which the model corresponds (supports). The association between the time information and the trained reconstruction model may be made by directly associating the time information with the trained reconstruction model, or may be made by indirectly associating the time information with the trained reconstruction model through other data.

Here, the trained reconstruction models F_{θ1_θ3} to F_{θ10_θ12} illustrated in FIG. 42 are the same trained reconstruction models as the trained reconstruction models F_{θ1_θ3} to F_{θ10_θ12} illustrated in FIG. 18.

### Specific Example of Processing by Server Device

Next, a specific example of processing by the selection unit 3703 of the server device 3610 according to the seventh embodiment will be described.

### (1) Specific Example 1 of Processing by Selection Unit

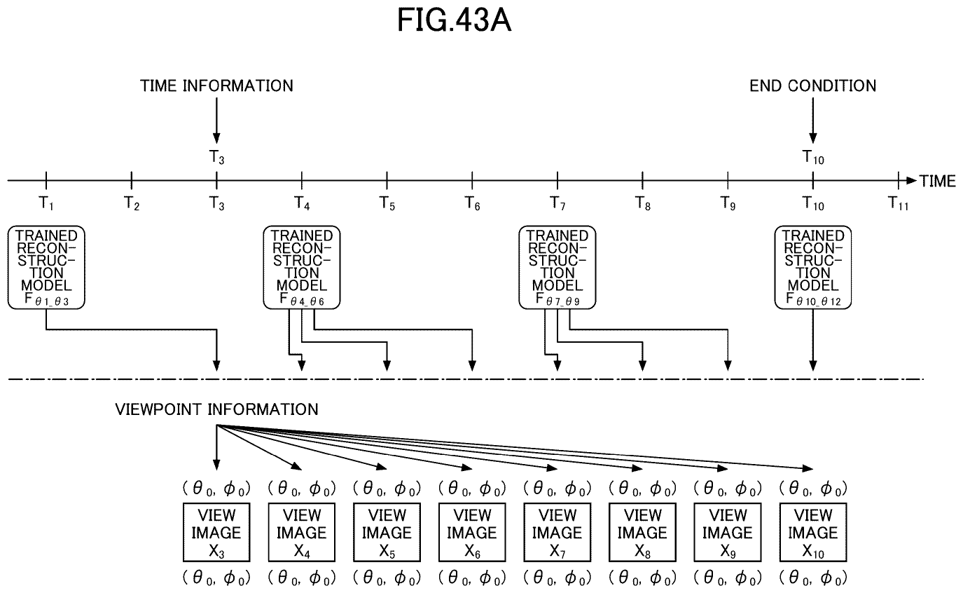

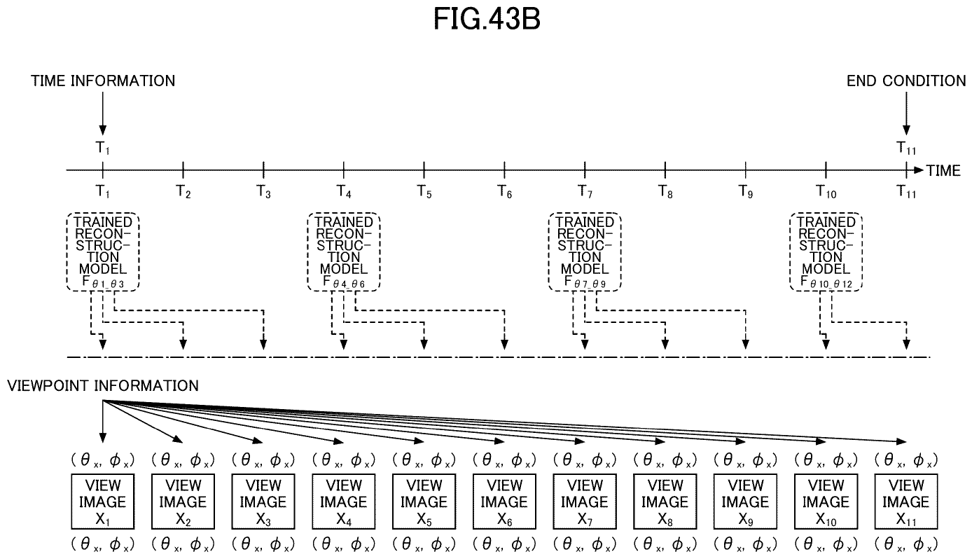

FIG. 43A is a first diagram illustrating a specific example of processing by the server device according to the seventh embodiment. FIG. 43A illustrates a specific example of the processing when the selection unit 3703 is notified of the identification information of the designated free-viewpoint moving image from the moving image designation receiving unit 3701 and is notified of the time information included in the request from the request receiving unit 3702.

As illustrated in FIG. 43A, the selection unit 3703, having been notified of the identification information for uniquely identifying the designated free-viewpoint moving image, reads the trained reconstruction models F_{θ1_θ3} to F_{θ10_θ12} configured to generate view images included in the designated free-viewpoint moving image from the model storage unit 606.

Additionally, the selection unit 3703 identifies the trained reconstruction model F_{θ1_θ3} corresponding to the time information T₃ included in the request from among the read trained reconstruction models F_{θ1_θ3} to F_{θ10_θ12} and notifies the model transmitting unit 3704. With this, the model transmitting unit 3704 transmits the notified trained reconstruction model F_{θ1_θ3} to the client terminal 3620. As a result, the client terminal 3620 executes the trained reconstruction model F_{θ1_θ3} based on the default viewpoint information (θ₀, φ₀). Additionally, the client terminal 3620 generates a view image (for example, a view image X₃) of the scene viewed from the viewpoint based on the default viewpoint information (θ₀, φ₀) in the time information T₃. Further, the client terminal 3620 plays back a free-viewpoint moving image using the generated view image X₃ as a frame image.

Subsequently, the selection unit 3703 identifies the trained reconstruction model F_{θ4_θ6} as the next trained reconstruction model and notifies the model transmitting unit 3704. With this, the model transmitting unit 3704 transmits the notified trained reconstruction model F_{θ4_θ6} to the client terminal 3620. As a result, the client terminal 3620 executes the trained reconstruction model F_{θ4_θ6} based on the default viewpoint information (θ₀, φ₀). Additionally, the client terminal 3620 generates view images (for example, view images X₄ to X₆) of the scene viewed from the viewpoint based on the default viewpoint information (θ₀, φ₀) in the respective time information T₄ to T₆. Further, the client terminal 3620 plays back a free-viewpoint moving image using the generated view images X₄ to X₆ as frame images.

Hereinafter, the selection unit 3703 repeats substantially the same processing until an end condition is transmitted from the client terminal 3620. The example of FIG. 43A indicates a state in which the time information T₁₀ is transmitted as the end condition from the client terminal 3620.

When the time information T₁₀ is transmitted as the end condition from the client terminal 3620, the selection unit 3703 identifies, as the last trained reconstruction model, the trained reconstruction model F_{θ10_θ12} corresponding to the time information T₁₀ transmitted as the end condition. Additionally, the selection unit 3703 notifies the model transmitting unit 3704 of the identified trained reconstruction model F_{θ10_θ12}. With this, the model transmitting unit 3704 transmits the notified trained reconstruction model F_{θ10_θ12} to the client terminal 3620. As a result, the client terminal 3620 executes the trained reconstruction model F_{θ10_θ12} based on the default viewpoint information (θ₀, φ₀). Additionally, the client terminal 3620 generates a view image (for example, a view image X₁₀) of the scene viewed from the viewpoint based on the default viewpoint information (θ₀, φ₀) in the time information T₁₀. Further, the client terminal 3620 plays back a free-viewpoint moving image using the generated view image X₁₀ as a frame image.

### (2) Specific Example 2 of Processing by Selection Unit

As described above, it is assumed that the trained reconstruction models F_{θ1_θ3} to F_{θ10_θ12} from the time information T₃ included in the request to the time information T₁₀ corresponding to the end condition are transmitted to the client terminal 3620. Additionally, with this, it is assumed that the client terminal 3620 plays back the free-viewpoint moving image using the view image X₃ to the view image X₁₀ as frame images. Further, accompanying this, it is assumed that the request including the time information is transmitted from the client terminal 3620, and the viewpoint information is input by the user 440 in the client terminal 3620. In this case, the request receiving unit 3702 receives the request and notifies the selection unit 3703.

Here, a specific example of the processing performed by the selection unit 3703 when the request (the time information) is notified by the request receiving unit 3702 will be described. FIG. 43B is a second diagram illustrating a specific example of the processing performed by the server device according to the seventh embodiment, and illustrates the specific example of the processing performed by the selection unit 3703 when the request is notified by the request receiving unit 3702.

As illustrated in FIG. 43B, the selection unit 3703 identifies the trained reconstruction model F_{θ1_θ3} corresponding to the time information (in the example of FIG. 43B, T₁) included in the request from among the trained reconstruction models F_{θ1_θ3} to F_{θ10_θ12} that have already been read. Here, the trained reconstruction model F_{θ1_θ3} has already been transmitted to the client terminal 3620. Therefore, the selection unit 3703 does not notify the model transmitting unit 3704 of the trained reconstruction model F_{θ1_θ3}, and the trained reconstruction model F_{θ1_θ3} is not transmitted to the client terminal 3620.

With respect to the above, the client terminal 3620 executes the trained reconstruction model F_{θ1_θ3} based on the time information (in the example of FIG. 43B, T₁) and the viewpoint information (in the example of FIG. 43B, (θₓ, φₓ)) input by the user 440. Additionally, the client terminal 3620 generates a view image (for example, a view image X₁) of the scene viewed from the viewpoint based on the viewpoint information (θₓ, φₓ) in the time information T₁. Further, the client terminal 3620 plays back a free-viewpoint moving image using the generated view image X₁ as a frame image.

Additionally, the client terminal 3620 executes the trained reconstruction model F_{θ1_θ3} based on the next time information (in the example of FIG. 43B, T₂) and the viewpoint information (in the example of FIG. 43B, (θₓ, φₓ)) input by the user 440. Additionally, the client terminal 3620 generates a view image (for example, a view image X₂) in the time information T₂ of the scene viewed from the viewpoint based on the viewpoint information (θₓ, φₓ). Further, the client terminal 3620 plays back a free-viewpoint moving image using the generated view image X₂ as a frame image.

Further, the client terminal 3620 executes the trained reconstruction model F_{θ1_θ3} based on the next time information (in the example of FIG. 43B, T₃) and the viewpoint information (in the example of FIG. 43B, (θₓ, φₓ)) input by the user 440. Additionally, the client terminal 3620 generates a view image (for example, a view image X₃) of the scene viewed from the viewpoint based on the viewpoint information (θₓ, φₓ) in the time information T₃. Further, the client terminal 3620 plays back a free-viewpoint moving image using the generated view image X₃ as a frame image.

Subsequently, the selection unit 3703 identifies the trained reconstruction model F_{θ4_θ6} as the next trained reconstruction model. Here, the trained reconstruction model F_{θ4_θ6} has already been transmitted to the client terminal 3620. Therefore, the selection unit 3703 does not notify the model transmitting unit 3704 of the trained reconstruction model F_{θ4_θ6}, and the trained reconstruction model F_{θ4_θ6} is not transmitted to the client terminal 3620.

With respect to the above, the client terminal 3620 executes the trained reconstruction model F_{θ4_θ6} based on the next time information (in the example of FIG. 43B, T₄) and the viewpoint information (in the example of FIG. 43B, (θₓ, φₓ)) input by the user 440. Additionally, the client terminal 3620 generates a view image (for example, a view image X₄) of the scene viewed from the viewpoint based on the viewpoint information (θₓ, φₓ) in the time information T₄. Further, the client terminal 3620 plays back a free-viewpoint moving image using the generated view image X₄ as a frame image.

Additionally, the client terminal 3620 executes the trained reconstruction model F_{θ4_θ6} based on the next time information (in the example of FIG. 43B, T₅) and the viewpoint information (in the example of FIG. 43B, (θₓ, φₓ)) input by the user 440. Additionally, the client terminal 3620 generates a view image (for example, a view image X₅) of the scene viewed from the viewpoint based on the viewpoint information (θₓ, φₓ) in the time information T₅. Further, the client terminal 3620 plays back a free-viewpoint moving image using the generated view image X₅ as a frame image.

Further, the client terminal 3620 executes the trained reconstruction model F_{θ4_θ6} based on the next time information (in the example of FIG. 43B, T₆) and the viewpoint information (in the example of FIG. 43B, (θₓ, φₓ)) input by the user 440. Additionally, the client terminal 3620 generates a view image (for example, a view image X₆) of the scene viewed from the viewpoint based on the viewpoint information (θₓ, φₓ) in the time information T₆. Further, the client terminal 3620 plays back a free-viewpoint moving image using the generated view image X₆ as a frame image.

Hereinafter, the selection unit 3703 repeats substantially the same processing until an end condition is transmitted from the client terminal 3620. The example of FIG. 43B indicates a state in which the time information T₁₁ is transmitted as the end condition from the client terminal 3620.

When the time information T₁₁ is transmitted as the end condition from the client terminal 3620, the selection unit 3703 identifies, as the last trained reconstruction model, the trained reconstruction model F_{θ10_θ12} corresponding to the time information T₁₁ transmitted as the end condition. Here, the trained reconstruction model F_{θ10_θ12} has already been transmitted to the client terminal 3620. Therefore, the selection unit 3703 does not notify the model transmitting unit 3704 of the trained reconstruction model F_{θ10_θ12}, and the trained reconstruction model F_{θ10_θ12} is not transmitted to the client terminal 3620.

With respect to the above, the client terminal 3620 executes the trained reconstruction model F_{θ10_θ12} based on the time information T₁₁ transmitted as the end condition and the viewpoint information (in the example of FIG. 43B, (θₓ, φₓ)) input by the user 440. Additionally, the client terminal 3620 generates a view image (for example, a view image X₁₁) of the scene viewed from the viewpoint based on the viewpoint information (θₓ, φₓ) in the time information T₁₁. Further, the client terminal 3620 plays back a free-viewpoint moving image using the generated view image X₁₁ as a frame image.

### Flow of Free-viewpoint Moving Image Rendering Process

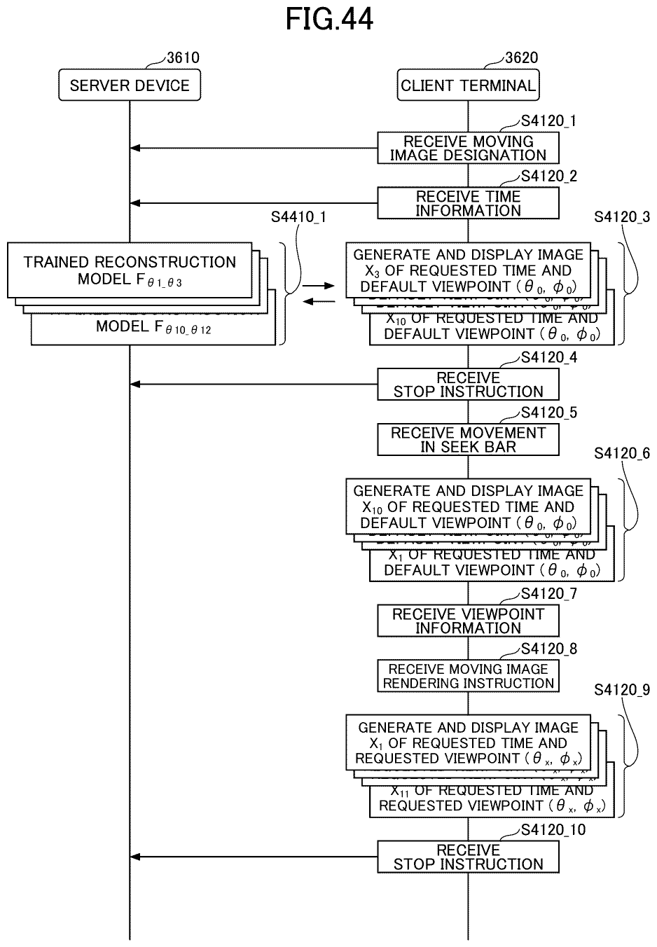

Next, a flow of a free-viewpoint moving image rendering process by the free-viewpoint moving image rendering system 3600 according to the seventh embodiment will be described. FIG. 44 is a fourth sequence diagram illustrating the flow of the free-viewpoint moving image rendering process by the free-viewpoint moving image rendering system. Here, differences from the third sequence diagram illustrated in FIG. 41 will be mainly described. Differences from the third sequence diagram illustrated in FIG. 41 are that, in the case of the fourth sequence diagram illustrated in FIG. 44, the processing of step S4410_1 is included instead of the processing of step S4110_1, and the processing of steps S4110_2 and S4110_3 is not included.

In step S4410_1, the server device 3610 reads a group of trained reconstruction models configured to generate view images included in the designated free-viewpoint moving image. Additionally, the server device 3610 sequentially transmits, to the client terminal 3620, the trained reconstruction model F_{θ1_θ3} associated with the time information T₃ included in the request among the group of trained reconstruction models that has been read. After transmitting the trained reconstruction model F_{θ10_θ12} to the client terminal 3620, the server device 3610 stops transmitting the trained reconstruction models.

In the fourth sequence diagram of FIG. 44, the processing of steps S4110_2 and S4110_3 is not included for the following reasons.

That is, the trained reconstruction model F_{θ1_θ3} and the trained reconstruction model F_{θ10_θ12} configured to generate the view images corresponding to the time information T₁, T₂, and T₁₁ have already been transmitted to the client terminal 3620 in step S4410_1. Therefore, the selection unit 3703 does not notify the model transmitting unit 3704 of the trained reconstruction model F_{θ1_θ3} and the trained reconstruction model F_{θ10_θ12}. Additionally, the trained reconstruction model F_{θ1_θ3} and the trained reconstruction model F_{θ10_θ12} are not transmitted to the client terminal 3620.

### Summary

As is apparent from the above description, one or more memories included in the server device 3610 according to the seventh embodiment hold the trained reconstruction models for the time series of the second time interval that is longer than the first time interval (the second reconstruction models) configured to generate the view images of the time series of the first time interval.

Additionally, one or more processors included in the server device 3610 according to the seventh embodiment transmits the trained reconstruction models for the time series of the second time interval (the second reconstruction models) from the trained reconstruction model (the second reconstruction model) corresponding to the time information included in the request to the trained reconstruction model (the second reconstruction model) corresponding to the predetermined end condition in a transmission format that can be executed by the client terminal 3620.

With this, according to the seventh embodiment, a mechanism different from that of the sixth embodiment can be constructed as a mechanism for rendering a free-viewpoint moving image.

### Eighth Embodiment

In the seventh embodiment, the case in which, as the trained reconstruction model configured to generate view images in a plurality of continuous pieces of time information, the model storage unit 606 holds the trained reconstruction model configured to generate view images in three continuous pieces of time information has been described. However, as the trained reconstruction model configured to generate view images in a plurality of continuous pieces of time information, the model storage unit 606 may hold the trained reconstruction model configured to generate view images in the time information of the entire time range. Here, the entire time range refers to a finite time range captured by the imaging device, and in an eighth embodiment, it is described as, for example, three minutes. When the frame period is 30 fps, the free-viewpoint moving image of three minutes includes 5400 frame images.

### Example of Trained Reconstruction Model

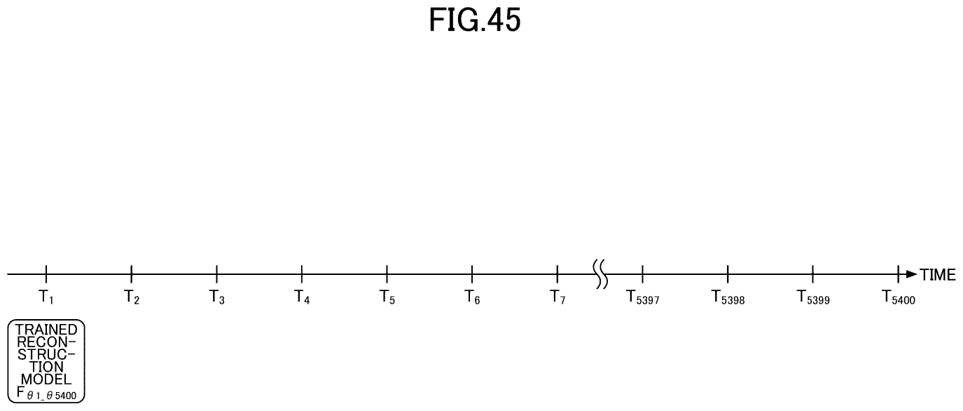

First, the trained reconstruction model held by the model storage unit 606 in the server device 3610 according to the eighth embodiment will be described. FIG. 45 is a diagram illustrating an example of the trained reconstruction model held by the model storage unit of the server device according to the eighth embodiment.

As illustrated in FIG. 45, the trained reconstruction model held by the model storage unit 606 is associated with time information. Specifically, the trained reconstruction model F_{θ1_θ5400} is associated with the time information T₁ to T₅₄₀₀. Here, the trained reconstruction model F_{θ1_θ5400} illustrated in FIG. 45 is the same as the trained reconstruction model F_{θ1_θ5400} illustrated in FIG. 23.

### Specific Example of Processing by Server Device

Next, a specific example of processing by the selection unit 3703 of the server device 3610 according to the eighth embodiment will be described.

### (1) Specific Example 1 of Processing by Selection Unit

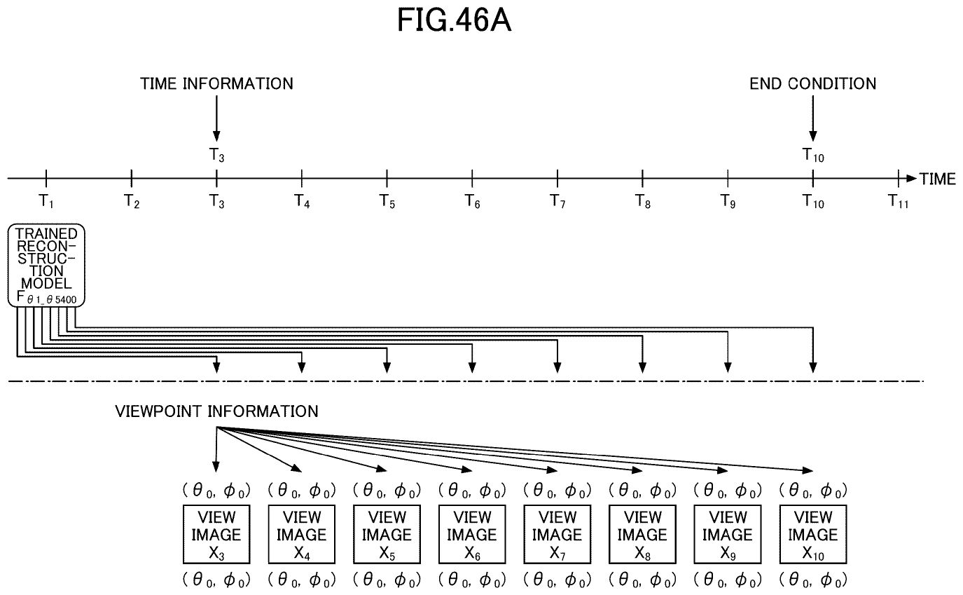

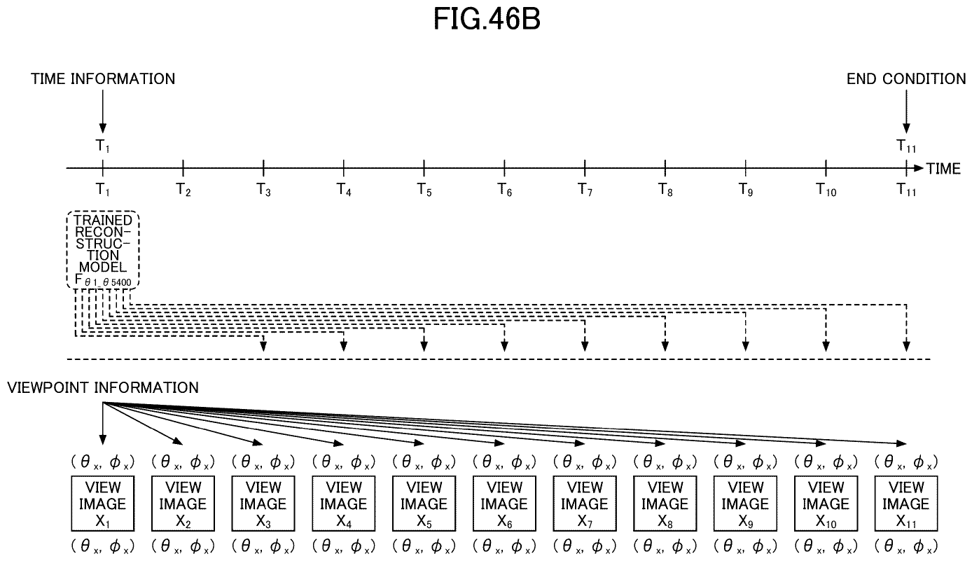

FIG. 46A is a first diagram illustrating a specific example of processing by the server device according to the eighth embodiment. FIG. 46A illustrates a specific example of the processing when the selection unit 3703 is notified of the identification information of the designated free-viewpoint moving image from the moving image designation receiving unit 3701 and is notified of the time information included in the request from the request receiving unit 3702.

As illustrated in FIG. 46A, the selection unit 3703, having been notified of the identification information of the designated free-viewpoint moving image, reads the trained reconstruction model F_{θ1_θ5400} configured to generate view images included in the designated free-viewpoint moving image from the model storage unit 606.

Additionally, the selection unit 3703 notifies the model transmitting unit 3704 of the trained reconstruction model F_{θ1_θ5400} that has been read. With this, the model transmitting unit 3704 transmits the notified trained reconstruction model F_{θ1_θ5400} to the client terminal 3620. As a result, the client terminal 3620 executes the trained reconstruction model F_{θ1_θ5400} based on the default viewpoint information (θ₀, φ₀). Additionally, the client terminal 3620 generates a view image X₃ of a scene viewed from a viewpoint based on the default viewpoint information (θ₀, φ₀) in time information T₃.

Further, the client terminal 3620 plays back a free-viewpoint moving image using the generated view image X₃ as a frame image.

Additionally, the client terminal 3620 executes the trained reconstruction model F_{θ1_θ5400} based on the next time information (in the example of FIG. 46A, T₄) and the default viewpoint information (in the example of FIG. 46A, (θ₀, φ₀)). Additionally, the client terminal 3620 generates a view image (for example, a view image X₄) of a scene viewed from a viewpoint based on the viewpoint information (θ₀, φ₀) in time information T₄. Further, the client terminal 3620 plays back a free-viewpoint moving image using the generated view image X₄ as a frame image.

Hereinafter, the client terminal 3620 repeats substantially the same processing until an end condition is input by the user 440. The example of FIG. 46A indicates a state in which the time information T₁₀ is input as the end condition by the user 440.

When the time information T₁₀ is input as the end condition, the client terminal 3620 executes the trained reconstruction model F_{θ1_θ5400} based on the input time information T₁₀ and the viewpoint information (in the example of FIG. 43A, (θ₀, φ₀)) input by the user 440. Additionally, the client terminal 3620 generates a view image (for example, a view image X₁₀) of the scene viewed from the viewpoint based on the viewpoint information (θ₀, φ₀) in the time information T₁₀. Further, the client terminal 3620 plays back a free-viewpoint moving image using the generated view image X₁₀ as a frame image.

### (2) Specific Example 2 of Processing by Selection Unit

As described above, it is assumed that the trained reconstruction model F_{θ1_θ5400} is transmitted, and the client terminal 3620 generates the view images X₃ to X₁₀ in the respective time information from the time information T₃ included in the request to the time information T₁₀ corresponding to the end condition. Additionally, it is assumed that the client terminal 3620 plays back a free-viewpoint moving image using the generated view images X₃ to X₁₀ as frame images. Additionally, accompanying this, it is assumed that a request including the time information is transmitted from the client terminal 3620, and the viewpoint information is input by the user 440 in the client terminal 3620. In this case, the request receiving unit 3702 receives the request and notifies the selection unit 3703 of the request.

Here, a specific example of the processing performed by the selection unit 3703 when the request (the time information) is notified by the request receiving unit 3702 will be described. FIG. 46B is a second diagram illustrating the specific example of the processing performed by the server device according to the eighth embodiment, and illustrates the specific example of the processing performed by the selection unit 3703 when the request is notified by the request receiving unit 3702.

As illustrated in FIG. 46B, the selection unit 3703 identifies the trained reconstruction model F_{θ1_θ5400} corresponding to the time information (in the example of FIG. 46B, T₁) included in the request. Here, the trained reconstruction model F_{θ1_θ5400} has already been transmitted to the client terminal 3620. Therefore, the selection unit 3703 does not notify the model transmitting unit 3704 of the trained reconstruction model F_{θ1_θ5400}, and the trained reconstruction model F_{θ1_θ5400} is not transmitted to the client terminal 3620.

With respect to the above, the client terminal 3620 executes the trained reconstruction model F_{θ1_θ5400} based on the time information (in the example of FIG. 43B, T₁) and the viewpoint information (in the example of FIG. 43B, (θₓ, φₓ)) input by the user 440. Additionally, the client terminal 3620 generates a view image (for example, a view image X₁) of the scene viewed from the viewpoint based on the viewpoint information (θₓ, φₓ) in the time information T₁. Further, the client terminal 3620 plays back a free-viewpoint moving image using the generated view image X₁ as a frame image.

Additionally, the client terminal 3620 executes the trained reconstruction model F_{θ1_θ5400} based on the next time information (in the example of FIG. 43B, T₂) and the viewpoint information (in the example of FIG. 43B, (θₓ, φₓ)) input by the user 440.

Additionally, the client terminal 3620 generates a view image (for example, a view image X₂) of the scene viewed from the viewpoint based on the viewpoint information (θₓ, φₓ) in the time information T₂. Further, the client terminal 3620 plays back a free-viewpoint moving image using the generated view image X₂ as a frame image.

Hereinafter, the client terminal 3620 repeats substantially the same processing until an end condition is input by the user 440. The example of FIG. 46B indicates that the user 440 inputs the time information T₁₁ as the end condition.

When the time information T₁₁ is input as the end condition, the client terminal 3620 executes the trained reconstruction model F_{θ1_θ5400} based on the input time information T₁₁ and the viewpoint information (in the example of FIG. 46B, (θₓ, φₓ)) input by the user 440. Additionally, the client terminal 3620 generates a view image (for example, a view image X₁₁) of the scene viewed from the viewpoint based on the viewpoint information (θₓ, φₓ) in the time information T₁₁. Further, the client terminal 3620 plays back a free-viewpoint moving image using the generated view image X₁₁ as a frame image.

### Flow of Free-Viewpoint Moving Image Rendering Process

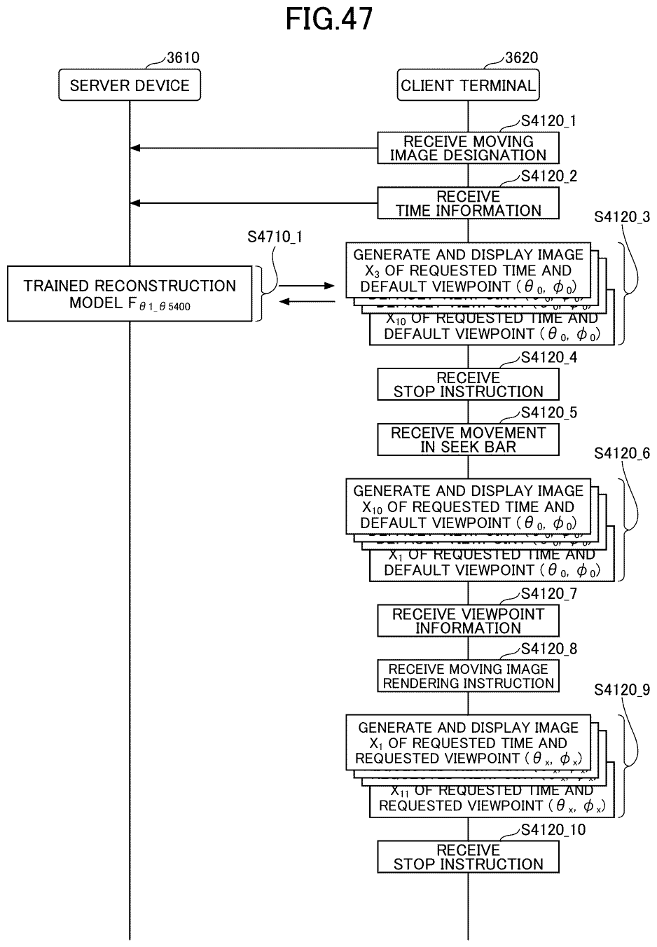

Next, a flow of a free-viewpoint moving image rendering process by the free-viewpoint moving image rendering system 3600 according to the eighth embodiment will be described. FIG. 47 is a fifth sequence diagram illustrating the flow of the free-viewpoint moving image rendering process by the free-viewpoint moving image rendering system. Here, differences from the fourth sequence diagram illustrated in FIG. 44 will be mainly described. Differences from the fourth sequence diagram illustrated in FIG. 44 are that, in the case of the fifth sequence diagram illustrated in FIG. 47:
the processing of step S4710_1 is included instead of the processing of step S4410_1; and
the stop instruction received in steps S4120_4 and S4120_10 is not transmitted to the server device 3610.

In step S4710_1, the server device 3610 reads the trained reconstruction model F_{θ1_θ5400} configured to generate the view images included in the designated free-viewpoint moving image. Additionally, the server device 3610 transmits the trained reconstruction model F_{θ1_θ5400} that has been read to the client terminal 3620.

In the fifth sequence diagram of FIG. 47, the reason why the stop instruction received in steps S4120_4 and S4120_10 is not transmitted to the server device 3610 is that the server device 3610 has no trained reconstruction model to be newly transmitted. That is, in step S4710_1, all the transmittable trained reconstruction models have been transmitted to the client terminal 3620.

### Summary

As is apparent from the above description, one or more memories included in the server device 3610 according to the eighth embodiment hold the trained reconstruction model (the third reconstruction model) configured to generate the view images of the time series of the first time interval.

Additionally, one or more processors included in the server device 3610 according to the eighth embodiment transmit the trained reconstruction model (the third reconstruction model) in a transmission format that can be executed by the client terminal 3620.

With this, according to the eighth embodiment, a mechanism different from the sixth and seventh embodiments can be constructed as a mechanism for rendering a free-viewpoint moving image.

### Ninth Embodiment

In the sixth embodiment, the model storage unit 606 holds one trained reconstruction model for each piece of time information, and one trained reconstruction model generates a view image for one piece of time information. However, the trained reconstruction model held by the model storage unit 606 for each piece of time information is not limited to this. For example, the model storage unit 606 may hold a trained difference reconstruction model that generates a difference image from the view image generated by the trained reconstruction model of the immediately preceding time information. Hereinafter, a ninth embodiment will be described mainly with respect to differences from the sixth embodiment.

### Example of Trained Reconstruction Model

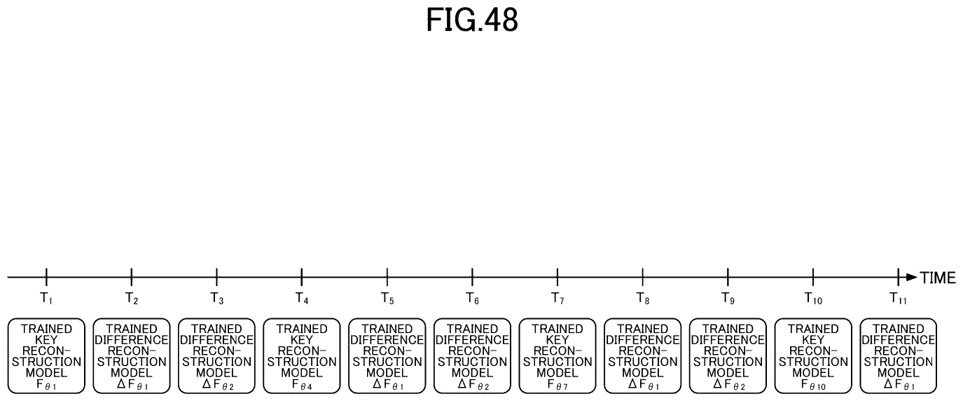

First, the trained reconstruction model held by the model storage unit 606 in the server device 3610 according to the ninth embodiment will be described. FIG. 48 is a diagram illustrating an example of the trained reconstruction model held by the model storage unit of the server device according to the ninth embodiment.

As illustrated in FIG. 48, the trained key reconstruction model and the trained difference reconstruction model held by the model storage unit 606 are associated with time information. Specifically, the trained key reconstruction model F_{θ1} is associated with the time information T₁, and the trained difference reconstruction models ΔF_{θ1} and ΔF_{θ2} are associated with the time information T₂ to T₃. Similarly, in the example illustrated in FIG. 48, the trained key reconstruction model F_{θ4} and the trained difference reconstruction models ΔF_{θ1} and ΔF_{θ2} are associated with the time information T₄ to T₆. Additionally, the trained key reconstruction model F_{θ7} and the trained difference reconstruction models ΔF_{θ1} and ΔF_{θ2} are associated with the time information T₇ to T₉, and the trained key reconstruction model F_{θ10} and the trained difference reconstruction model ΔF_{θ1} are associated with the time information T₁₀ to T₁₁. The association between the time information and the trained key reconstruction model (or the trained difference reconstruction model) may be made by directly associating the time information with association between the time information and the trained key reconstruction model (or the trained difference reconstruction model), or by indirectly associating the time information with association between the time information and the trained key reconstruction model (or the trained difference reconstruction model) through other data.

Here, the trained key reconstruction models F_{θ1}, F_{θ4}, F_{θ7}, and F_{θ10} illustrated in FIG. 48 are the same trained key reconstruction models as the trained key reconstruction models F_{θ1}, F_{θ4}, F_{θ7}, and F_{θ10} illustrated in FIG. 28. Additionally, the trained difference reconstruction models ΔF_{θ1} and ΔF_{θ2} associated with the time information T₂, T₃, T₅, T₆, T₈, T₉, and T₁₁ illustrated in FIG. 48 are the same trained difference reconstruction models as the corresponding trained difference reconstruction models ΔF_{θ1} and ΔF_{θ2} illustrated in FIG. 28.

### Specific Example of Processing by Server Device

Next, a specific example of processing by the selection unit 3703 of the server device 410 according to the ninth embodiment will be described.

### (1) Specific Example 1 of Processing by Selection Unit

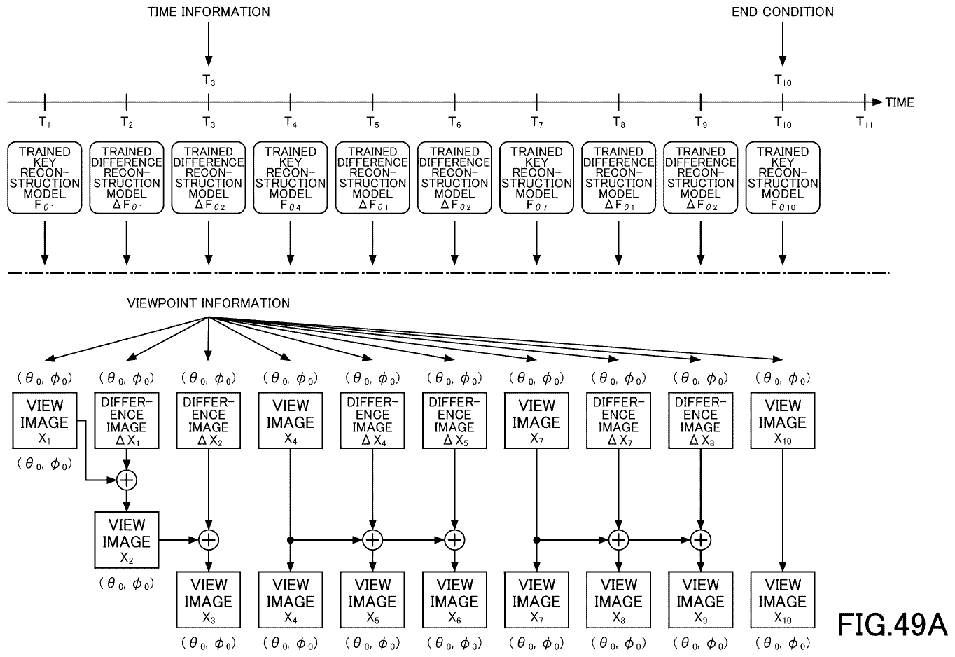

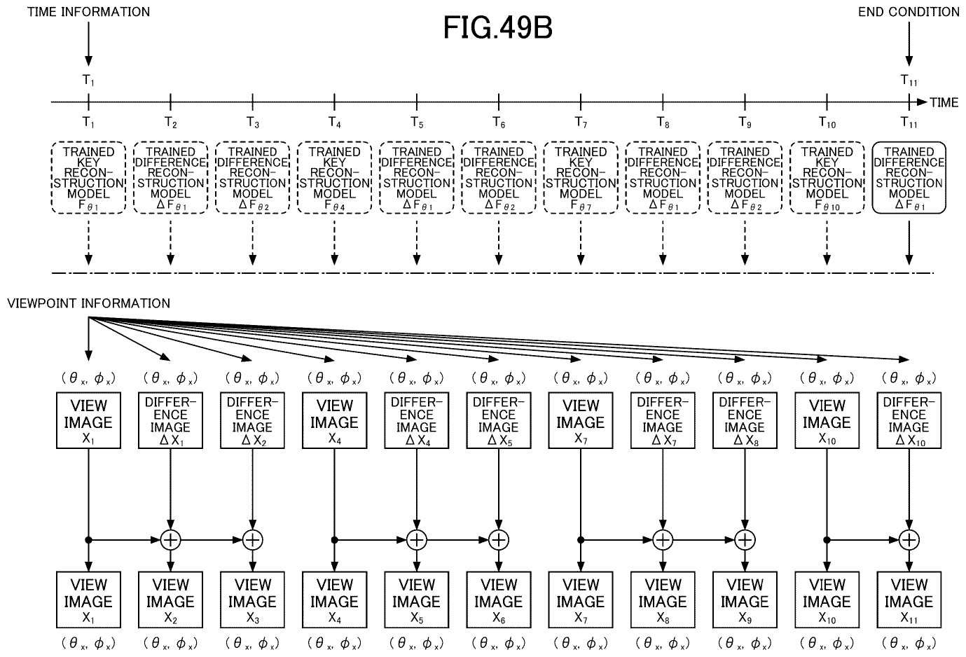

FIG. 49A is a first diagram illustrating a specific example of processing by the server device according to the ninth embodiment. FIG. 49A illustrates a specific example of the processing when the selection unit 3703 is notified of the identification information of the designated free-viewpoint moving image from the moving image designation receiving unit 3701 and is notified of the time information included in the request from the request receiving unit 3702.

As illustrated in FIG. 49A, the selection unit 3703, having been notified of the identification information of the designated free-viewpoint moving image, reads the following models as the trained reconstruction models configured to generate view images included in the designated free-viewpoint moving image from the model storage unit 606:
the trained key reconstruction models F_{θ1}, F_{θ4}, F_{θ7}, F_{θ10}; and
the trained difference reconstruction models ΔF_{θ1}, ΔF_{θ2,} associated with the respective time information T₂, T₃, T₅, T₆, T₈, T₉, T₁₁.

Additionally, the selection unit 3703 identifies, as the trained key reconstruction model and the trained difference reconstruction model corresponding to the time information T₃ included in the request, among the trained key reconstruction models and the trained difference reconstruction models that have been read, the following models:
the trained key reconstruction model F_{θ1};
the trained difference reconstruction models ΔF_{θ1} and ΔF_{θ2} associated with the time information T₂ and T₃,
and notifies the model transmitting unit 3704. With this, the model transmitting unit 3704 transmits the trained key reconstruction model F_{θ1} and the trained difference reconstruction models ΔF_{θ1} and ΔF_{θ2} associated with the time information T₂ and T₃ to the client terminal 3620. As a result, the client terminal 3620:
executes the trained key reconstruction model F_{θ1} based on the default viewpoint information (θ₀, φ₀), and generates a view image X₁ of the scene viewed from the viewpoint based on the default viewpoint information (θ₀, φ₀) in the time information T₁;
executes the trained difference reconstruction model ΔF_{θ1} based on the default viewpoint information (θ₀, φ₀), and generates a difference image ΔX₁ of the scene viewed from the viewpoint based on the default viewpoint information (θ₀, φ₀) in the time information T₂;
adds the generated difference image ΔX₁ to the generated view image X₁ to generate a view image X₂;
executes the trained difference reconstruction model ΔF_{θ2} based on the default viewpoint information (θ₀, φ₀), and generates a difference image ΔX₂ of the scene viewed from the viewpoint based on the default viewpoint information (θ₀, φ₀) in the time information T₃; and
adds the generated difference image ΔX₂ to the generated view image X₂ to generate a view image X₃.

Further, the client terminal 3620 plays back a free-viewpoint moving image using the generated view image X₃ as a frame image.

Subsequently, the selection unit 3703 identifies the trained key reconstruction model F_{θ4} corresponding to the next time information (the next time point) as the next trained reconstruction model and notifies the model transmitting unit 3704. With this, the model transmitting unit 3704 transmits the trained key reconstruction model F_{θ4} to the client terminal 3620. As a result, the client terminal 3620 executes the trained key reconstruction model F_{θ4} based on the default viewpoint information (θ₀, φ₀), and generates the view image X₄ of the scene viewed from the viewpoint based on the default viewpoint information (θ₀, φ₀) in the time information T₄. Furthermore, the client terminal 3620 plays back a free-viewpoint moving image using the generated view image X₄ as a frame image.

Subsequently, the selection unit 3703 identifies the trained difference reconstruction model ΔF_{θ1} corresponding to the next time information (the next time point) as the next trained reconstruction model, and notifies the model transmitting unit 3704. With this, the model transmitting unit 3704 transmits the trained difference reconstruction model ΔF_{θ1} to the client terminal 3620. As a result, the client terminal 3620:
executes the trained difference reconstruction model ΔF_{θ1} based on the default viewpoint information (θ₀, φ₀), and generates a difference image ΔX₄ of the scene viewed from the viewpoint based on the default viewpoint information (θ₀, φ₀) in the time information T₅; and
adds the generated difference image ΔX₄ to the generated view image X₄ to generate a view image X₅.

Further, the client terminal 3620 plays back a free-viewpoint moving image using the generated view image X₅ as a frame image.

Subsequently, the selection unit 3703 identifies the trained difference reconstruction model ΔF_{θ2} corresponding to the next time information (the next time point) as the next trained reconstruction model and notifies the model transmitting unit 3704. With this, the model transmitting unit 3704 transmits the trained difference reconstruction model ΔF_{θ2} to the client terminal 3620. As a result, the client terminal 3620:
executes the trained difference reconstruction model ΔF_{θ2} based on the default viewpoint information (θ₀, φ₀), and generates a difference image ΔX₅ of the scene viewed from the viewpoint based on the default viewpoint information (θ₀, φ₀) in the time information T₆; and
adds the generated difference image ΔX₅ to the generated view image X₅ to generate a view image X₆.

Further, the client terminal 3620 plays back a free-viewpoint moving image using the generated view image X₆ as a frame image.

Hereinafter, the selection unit 3703 repeats substantially the same processing until an end condition is transmitted from the client terminal 3620. The example of FIG. 49A indicates a state in which the time information T₁₀ is transmitted as the end condition from the client terminal 3620.

When the time information T₁₀ is transmitted as the end condition from the client terminal 3620, the selection unit 3703 identifies, as the last trained reconstruction model, the trained reconstruction model F_{θ10} corresponding to the time information T₁₀ transmitted as the end condition, and notifies the model transmitting unit 3704. With this, the model transmitting unit 3704 transmits the notified trained reconstruction model F_{θ10} to the client terminal 3620. As a result, the client terminal 3620 executes the trained key reconstruction model F_{θ10} based on the default viewpoint information (θ₀, φ₀), and generates the view image X₁₀ of the scene viewed from the viewpoint based on the default viewpoint information (θ₀, φ₀) in the time information T₁₀. Furthermore, the client terminal 3620 plays back a free-viewpoint moving image using the generated view image X₁₀ as a frame image.

### (2) Specific Example 2 of Processing by the Selection Unit

As described above, it is assumed that the trained key reconstruction model F_{θ1} to the trained key reconstruction model F_{θ10} from the time information T₃ included in the request to the time information T₁₀ corresponding to the end condition are transmitted to the client terminal 3620. Additionally, with this, it is assumed that the client terminal 3620 plays back the free-viewpoint moving image using the view images X₃ to X₁₀ as frame images. Further, accompanying this, it is assumed that the request including the time information is transmitted from the client terminal 3620, and the viewpoint information is input by the user 440 in the client terminal 3620. In this case, the request receiving unit 3702 receives the request and notifies the selection unit 3703 of the request.

Here, a specific example of the processing by the selection unit 3703 when the request receiving unit 3702 notifies the request (the time information) will be described. FIG. 49B is a second diagram illustrating a specific example of the processing by the server device according to the ninth embodiment, and illustrates a specific example of the processing by the selection unit 3703 when the request is notified by the request receiving unit 3702.

As illustrated in FIG. 49B, the selection unit 3703 identifies the trained key reconstruction model F_{θ1} corresponding to the time information (in the example of FIG. 49B, T₁) included in the request. Here, the trained key reconstruction model F_{θ1} has already been transmitted to the client terminal 3620. Therefore, the selection unit 3703 does not notify the model transmitting unit 3704 of the trained key reconstruction model F_{θ1}, and the trained key reconstruction model F_{θ1} is not transmitted to the client terminal 3620.

With respect to the above, the client terminal 3620 executes the trained key reconstruction model F_{θ1} based on the viewpoint information (in the example of FIG. 49B, (θₓ, φₓ)) input by the user 440. Additionally, the client terminal 3620 generates a view image (for example, view image X₁) of the scene viewed from the viewpoint based on the viewpoint information (θₓ, φₓ) in the time information T₁. Further, the client terminal 3620 plays back a free-viewpoint moving image using the generated view image X₁ as a frame image.

Subsequently, the selection unit 3703 identifies the trained difference reconstruction model ΔF_{θ1} corresponding to the next time information (the next time point) as the next trained reconstruction model. Here, the trained difference reconstruction model ΔF_{θ1} has already been transmitted to the client terminal 3620. Therefore, the selection unit 3703 does not notify the model transmitting unit 3704 of the trained difference reconstruction model ΔF_{θ1}, and the trained difference reconstruction model ΔF_{θ1} is not transmitted to the client terminal 3620.

With respect to the above, the client terminal 3620 executes the trained difference reconstruction model ΔF_{θ1} based on the viewpoint information (in the example of FIG. 49B, (θₓ, φₓ)) input by the user 440. Additionally, the client terminal 3620 generates a difference image ΔX₁ of the scene viewed from the viewpoint based on the viewpoint information (θₓ, φₓ) in the time information T₂. Additionally, the client terminal 3620 adds the difference image ΔX₁ to the generated view image X₁ to generate a view image X₂ of the scene viewed from the viewpoint based on the viewpoint information (θₓ, φₓ) in the time information T₂. Further, the client terminal 3620 plays back a free-viewpoint moving image using the generated view image X₂ as a frame image.

Subsequently, the selection unit 3703 identifies the trained difference reconstruction model ΔF_{θ2} corresponding to the next time information (the next time point) as the next trained reconstruction model. Here, the trained difference reconstruction model ΔF_{θ2} has already been transmitted to the client terminal 3620. Therefore, the selection unit 3703 does not notify the model transmitting unit 3704 of the trained difference reconstruction model ΔF_{θ2}, and the trained difference reconstruction model ΔF_{θ2} is not transmitted to the client terminal 3620.

With respect to the above, the client terminal 3620 executes the trained difference reconstruction model ΔF_{θ2} based on the viewpoint information (in the example of FIG. 49B, (θₓ, φₓ)) input by the user 440. Additionally, the client terminal 3620 generates a difference image ΔX₂ of the scene viewed from the viewpoint based on the viewpoint information (θₓ, φₓ) in the time information T₃. Additionally, the client terminal 3620 adds the difference image ΔX₂ to the generated view image X₂ to generate a view image X₃ of the scene viewed from the viewpoint based on the viewpoint information (θₓ, φₓ) in the time information T₃. Further, the client terminal 3620 plays back a free-viewpoint moving image using the generated view image X₃ as a frame image.

Hereinafter, the selection unit 3703 repeats substantially the same processing until an end condition is transmitted from the client terminal 3620. The example of FIG. 49B indicates a state in which the time information T₁₁ is transmitted as the end condition from the client terminal 3620.

When time information T₁₁ is transmitted as the end condition from the client terminal 3620, the selection unit 3703 identifies, as the last trained reconstruction model, the trained difference reconstruction model ΔF_{θ1} corresponding to the time information T₁₁ transmitted as the end condition. Additionally, the selection unit 3703 notifies the model transmitting unit 3704 of the identified trained difference reconstruction model ΔF_{θ1}. With this, the model transmitting unit 3704 transmits the notified trained difference reconstruction model ΔF_{θ1} to the client terminal 3620. As a result, the client terminal 3620 executes the trained difference reconstruction model ΔF_{θ1} based on the viewpoint information (θₓ, φₓ) input by the user 440. Additionally, the client terminal 3620 generates a difference image ΔX₁₀ of the scene viewed from the viewpoint based on the viewpoint information (θₓ, φₓ) in the time information T₁₁. Additionally, the client terminal 3620 adds the difference image ΔX₁₀ to the generated view image X₁₀ to generate a view image X₁₁ of the scene viewed from the viewpoint based on the viewpoint information (θₓ, φₓ) in the time information T₁₁. Further, the client terminal 3620 plays back a free-viewpoint moving image using the generated view image X₁₁ as a frame image.

### Flow of Free-Viewpoint Moving Image Rendering Process

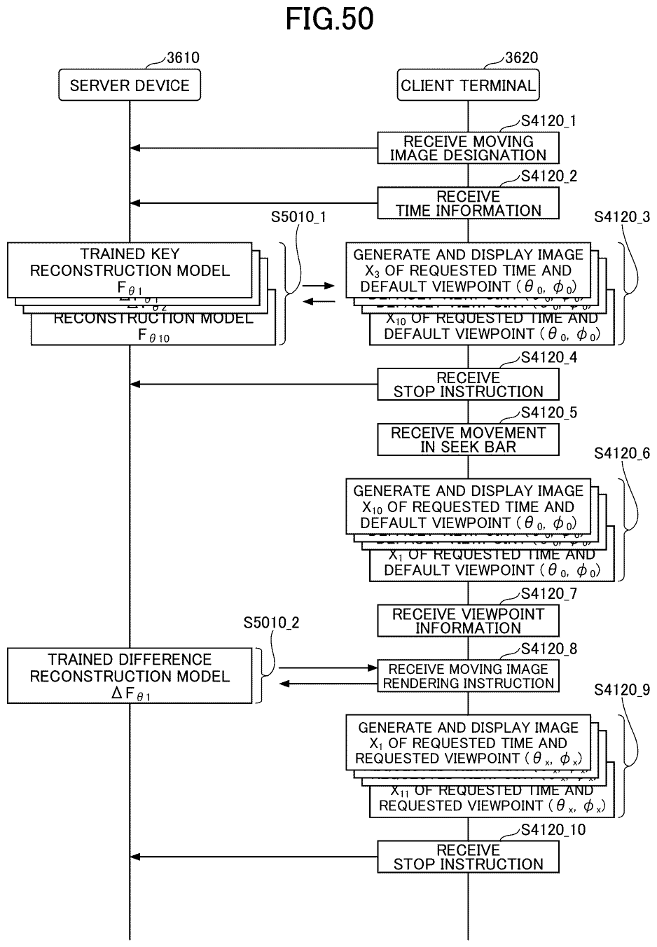

Next, a flow of a free-viewpoint moving image rendering process by the free-viewpoint moving image rendering system 3600 according to the ninth embodiment will be described. FIG. 50 is a sixth sequence diagram illustrating the flow of the free-viewpoint moving image rendering process by the free-viewpoint moving image rendering system. Here, differences from the third sequence diagram illustrated in FIG. 41 will be mainly described. The differences from the third sequence diagram illustrated in FIG. 41 are that, in the case of the sixth sequence diagram illustrated in FIG. 50:
the processing of step S5010_1 is included instead of the processing of step S4110_1; and
the processing of step S4110_2 is not included; and the processing of step S5010_2 is included instead of the processing of step S4110_3.

In step S5010_1, the server device 3610 reads the group of trained key reconstruction models and trained difference reconstruction models configured to generate the view images included in the designated free-viewpoint moving image.

Additionally, the server device 3610 identifies the trained key reconstruction model F_{θ1}, the trained difference reconstruction model ΔF_{θ1}, and the trained difference reconstruction model ΔF_{θ2} as the trained key reconstruction model and the trained difference reconstruction models associated with the time information T₃ included in the request among the read group of trained key reconstruction models and trained difference reconstruction models. Further, the server device 3610 sequentially transmits the trained key reconstruction model and the trained difference reconstruction models to the client terminal 3620. The server device 3610 stops transmitting the trained key reconstruction model and the trained difference reconstruction models after transmitting the trained key reconstruction model F_{θ10} to the client terminal 3620.

In the sixth sequence diagram of FIG. 50, the processing of step S4110_2 is not included for the following reasons.

That is, the trained key reconstruction model F_{θ1} and the trained difference reconstruction model ΔF_{θ1} configured to generate the view image corresponding to the time information T₁ and T₂ have already been transmitted to the client terminal 3620 in step S5010_1. Therefore, the selection unit 3703 does not notify the model transmitting unit 3704 of the trained key reconstruction model F_{θ1} and the trained difference reconstruction model ΔF_{θ1}. Additionally, the trained key reconstruction model F_{θ1} and the trained difference reconstruction model ΔF_{θ1} are not transmitted to the client terminal 3620.

In step S5010_2, the server device 3610 identifies the trained difference reconstruction model ΔF_{θ1} corresponding to the time information T₁₁ as the next trained reconstruction model, and transmits the identified trained difference reconstruction model ΔF_{θ1} to the client terminal 3620.

### Summary

As is apparent from the above description, one or more memories included in the server device 3610 according to the ninth embodiment:
hold the trained key reconstruction models for the time series of the third time interval (the fourth reconstruction models) configured to generate the view images of the time series of the third time interval that is longer than the first time interval.
hold the trained difference reconstruction models for the time series of the first time interval (the fourth difference reconstruction models) configured to generate difference images each representing a difference from the view image generated the first time interval earlier, for generating the view images of the time series of the first time interval.

Additionally, one or more processors included in the server device 3610 according to the ninth embodiment:
transmit the trained key reconstruction models for the time series of the third time interval (the fourth reconstruction models) from the trained key reconstruction model (the fourth reconstruction model) corresponding to the time information included in the request to the trained key reconstruction model (the fourth reconstruction model) corresponding to the predetermined end condition in a transmission format that can be executed by the client terminal 3620.
transmit the trained difference reconstruction models for the time series of the first time interval (the fourth difference reconstruction models) from the trained difference reconstruction model (the fourth difference reconstruction model) corresponding to the time information included in the request to the trained difference reconstruction model (the fourth difference reconstruction model) corresponding to the predetermined end condition in a transmission format that can be executed by the client terminal 3620.

With this, according to the ninth embodiment, as a mechanism for rendering a free-viewpoint moving image, a mechanism different from those of the sixth to eighth embodiments can be constructed.

### Tenth Embodiment

In the sixth embodiment described above, the case in which one imaging device images the three-dimensional scene 140 from the same viewpoint has been described. However, for example, two imaging devices may image the three-dimensional scene 140 from the same viewpoint. This can generate a trained reconstruction model that divides the three-dimensional scene 140 into two spaces and generates view images in the respective spaces. Hereinafter, a tenth embodiment will be described mainly with respect to differences from the sixth embodiment described above.

### Functional Configuration of Server Device

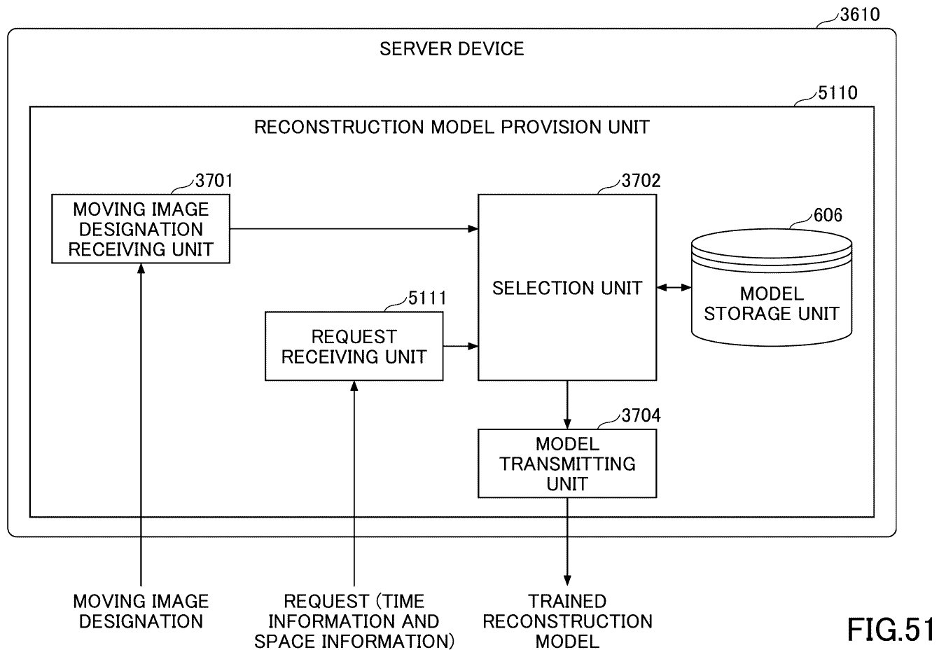

First, a functional configuration of the server device 3610 according to the tenth embodiment will be described. FIG. 51 is a third diagram illustrating an example of the functional configuration of the server device. The differences from the functional configuration illustrated in FIG. 37 are that, in the case of FIG. 51, a request receiving unit 5111 included in a reconstruction model provision unit 5110 of the server device 3610 has a function different from the request receiving unit 3702 included in the reconstruction model provision unit 3611 of the server device 3610 illustrated in FIG. 37.

Specifically, the request receiving unit 5111 included in the reconstruction model provision unit 5110 of the server device 3610 receives a request including time information and space information. Additionally, the request receiving unit 5111 included in the reconstruction model provision unit 5110 of the server device 3610 notifies the selection unit 3703 of the time information and the space information.

### Functional Configuration of Client Terminal

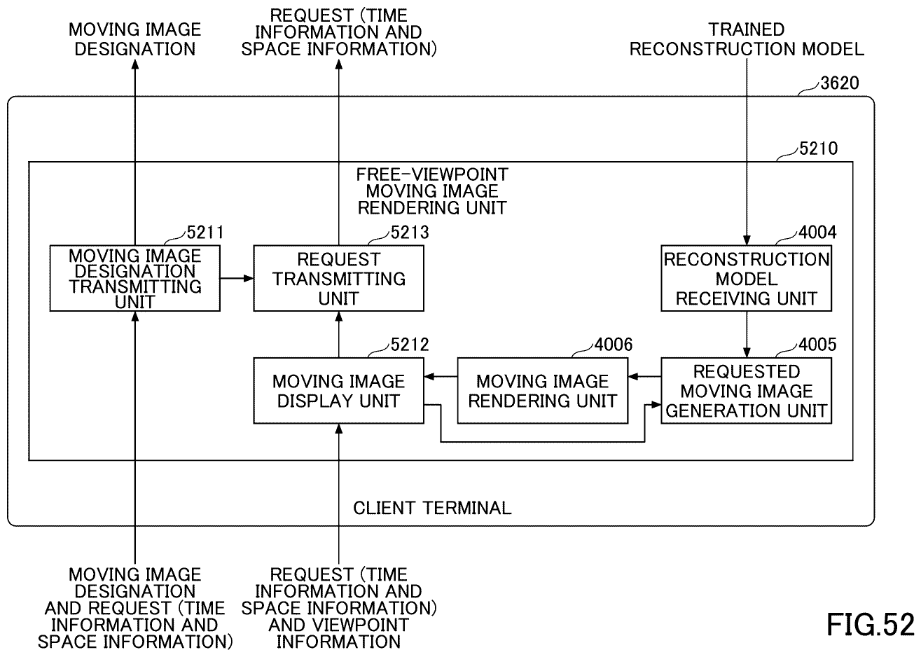

Next, a functional configuration of the client terminal 3620 will be described. FIG. 52 is a third diagram illustrating an example of the functional configuration of the client terminal. The differences from FIG. 40 are that, in the case of FIG. 52, a moving image designation transmitting unit 5211, a moving image display unit 5212, and a request transmitting unit 5213 of a free-viewpoint moving image rendering unit 5210 have functions different from those of the corresponding functional units of the client terminal 3620 illustrated in FIG. 40.

Specifically, the moving image designation transmitting unit 5211 and the moving image display unit 5212 of the free-viewpoint moving image rendering unit 5210 of the client terminal 3620 receive the input of the space information in addition to the time information. Additionally, the request transmitting unit 5213 is notified of the request including the time information and the space information from the moving image designation transmitting unit 5211 or the moving image display unit 5212, and transmits it to the server device 3610.

### Example of Trained Reconstruction Model

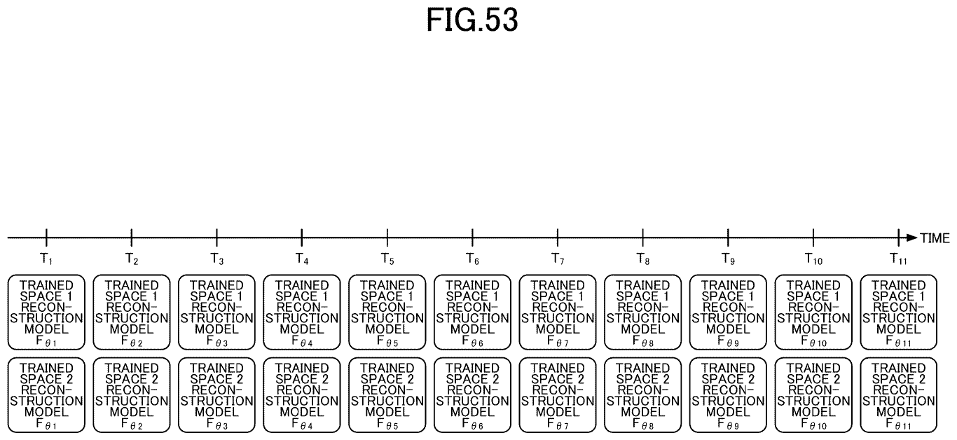

Next, the trained reconstruction model held by the model storage unit 606 in the server device 3610 according to the tenth embodiment will be described. FIG. 53 is a diagram illustrating an example of the trained reconstruction models held by the model storage unit of the server device according to the tenth embodiment.

As illustrated in FIG. 53, the trained reconstruction models held by the model storage unit 606 are associated with time information. Specifically, the trained space 1 reconstruction model F_{θ1} and the trained space 2 reconstruction model F_{θ1} are associated with the time information T₁, and the trained space 1 reconstruction model F_{θ2} and the trained space 2 reconstruction model F_{θ2} are associated with the time information T₂. Similarly, the example of FIG. 53 illustrates that the trained space 1 reconstruction model F_{θ3} and the trained space 2 reconstruction model F_{θ3} to the trained space 1 reconstruction model F_{θ11} and the trained space 2 reconstruction model F_{θ11} are associated with the time information T₃ to T₁₁, respectively. The association of the time information with the trained space 1 reconstruction models and the trained space 2 reconstruction models may be made by directly associating the time information with the trained space 1 reconstruction models and the trained space 2 reconstruction models, or by indirectly associating the time information with the trained space 1 reconstruction models and the trained space 2 reconstruction models through other data.

Here, the trained space 1 reconstruction models F_{θ1} to F_{θ11} and the trained space 2 reconstruction models F_{θ1} to F_{θ11} illustrated in FIG. 53 are the same as the space 1 reconstruction models F_{θ1} to F_{θ11} and the trained space 2 reconstruction models F_{θ1} to F_{θ11} illustrated in FIG. 33.

### Specific Example of Processing by Server Device

Next, a specific example of processing by the selection unit 3703 of the server device 3610 according to the tenth embodiment will be described.

### (1) Specific Example 1 of Processing by the Selection Unit

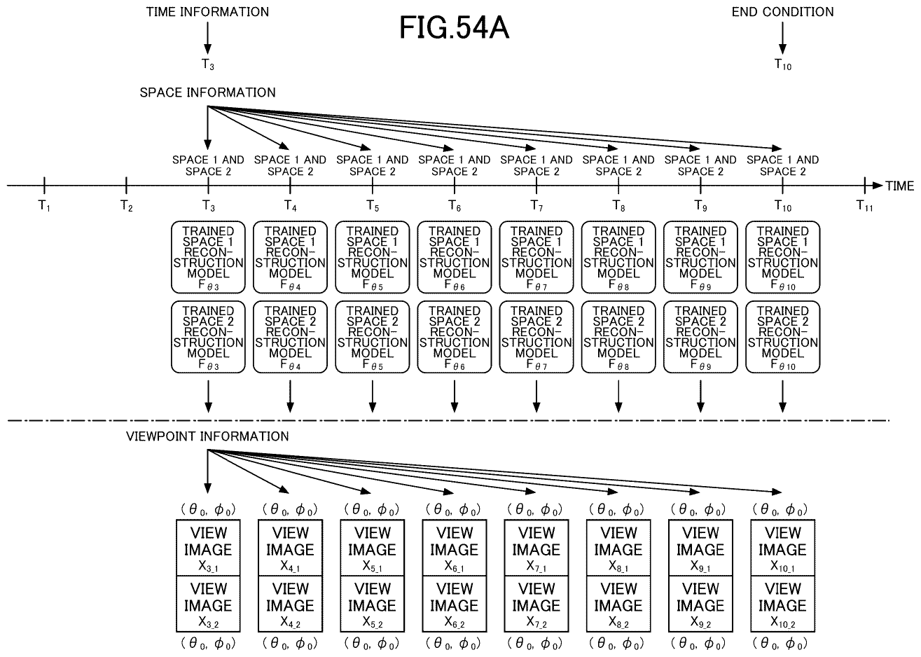

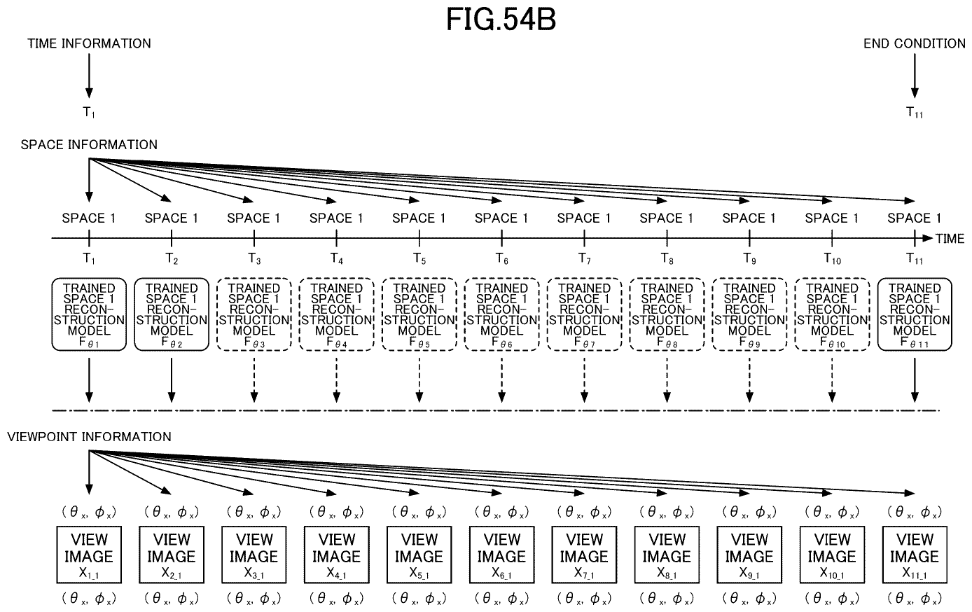

FIG. 54A is a first diagram illustrating a specific example of the processing by the server device according to the tenth embodiment. FIG. 54A illustrates a specific example of the processing when the selection unit 3703 is notified of the identification information of the designated free-viewpoint moving image from the moving image designation receiving unit 3701 and is notified of the time information T₃ included in the request from the request receiving unit 3702.

As illustrated in FIG. 54A, the selection unit 3703, having been notified of the identification information of the designated free-viewpoint moving image, reads, as trained reconstruction models configured to generate view images included in the designated free-viewpoint moving image, from a model storage unit 606:
the trained space 1 reconstruction models F_{θ1} to F_{θ11}; and
the trained space 2 reconstruction models F_{θ1} to F_{θ11}.

Additionally, the selection unit 3703 identifies the trained space 1 reconstruction model F_{θ3} and the trained space 2 reconstruction model F_{θ3} corresponding to time information T₃ and the default space information (the space 1 and the space 2) included in the request among the trained reconstruction models that have been read.

Additionally, the selection unit 3703 notifies the model transmitting unit 3704 of the trained space 1 reconstruction model F_{θ3} and the trained space 2 reconstruction model F_{θ3} that have been identified. With this, the model transmitting unit 3704 transmits, to the client terminal 3620, the trained space 1 reconstruction model F_{θ3} and the trained space 2 reconstruction model F_{θ3} that have been notified. As a result, the client terminal 3620 executes the trained space 1 reconstruction model F_{θ3} based on the default viewpoint information (in the example of FIG. 54A, (θ₀, φ₀)). Additionally, the client terminal 3620 generates a view image (for example, a view image X_{3_1}) of the space 1 of the scene viewed from the viewpoint based on the default viewpoint information (θ₀, φ₀) in the time information T₃. Similarly, the client terminal 3620 executes the trained space 2 reconstruction model F_{θ3} based on the default viewpoint information (in the example of FIG. 54A, (θ₀, φ₀)). Additionally, the client terminal 3620 generates a view image (for example, a view image X_{3_2}) of the space 2 of the scene viewed from the viewpoint based on the default viewpoint information (θ₀, φ₀) in the time information T₃. Further, the client terminal 3620 plays back a free-viewpoint moving image using the generated view images X_{3_1} and X_{3_2} as frame images.

Subsequently, the selection unit 3703 identifies, as the next trained reconstruction model, the trained space 1 reconstruction model F_{θ4} and the trained space 2 reconstruction model F_{θ4} corresponding to the next time information (the next time point), and notifies the model transmitting unit 3704. With this, the model transmitting unit 3704 transmits, to the client terminal 3620, the trained space 1 reconstruction model F_{θ4} and the trained space 2 reconstruction model F_{θ4} that have been notified. As a result, the client terminal 3620 executes the trained space 1 reconstruction model F_{θ4} based on the default viewpoint information (in the example of FIG. 54A, (θ₀, φ₀)). Additionally, the client terminal 3620 generates a view image (for example, a view image X_{4_1}) of the space 1 of the scene viewed from the viewpoint based on the default viewpoint information (θ₀, φ₀) in the time information T₄. Similarly, the client terminal 3620 executes the trained space 2 reconstruction model F_{θ4} based on the default viewpoint information (in the example of FIG. 54A, (θ₀, φ₀)). Additionally, the client terminal 3620 generates a view image (for example, view image X_{4_2}) of the space 2 of the scene viewed from the viewpoint based on the default viewpoint information (θ₀, φ₀) in the time information T₄. Further, the client terminal 3620 plays back a free-viewpoint moving image using the generated view images X_{4_1} and X_{4_2} as frame images.

Hereinafter, the selection unit 3703 repeats substantially the same processing until an end condition is transmitted from the client terminal 3620. The example of FIG. 54A indicates a state in which the time information T₁₀ is transmitted as the end condition from the client terminal 3620.

When the time information T₁₀ is transmitted as the end condition from the client terminal 3620, the selection unit 3703 identifies, as the last trained reconstruction models, the trained space 1 reconstruction model F_{θ10} and the trained space 2 reconstruction model F_{θ10} corresponding to the time information T₁₀ transmitted as the end condition, and notifies the model transmitting unit 3704. With this, the model transmitting unit 3704 transmits, to the client terminal 3620, the trained space 1 reconstruction model F_{θ10} and the trained space 2 reconstruction model F_{θ10} that have been notified. As a result, the client terminal 3620 executes the trained space 1 reconstruction model F_{θ10} based on the default viewpoint information (θ₀, φ₀). Additionally, the client terminal 3620 generates a view image (for example, a view image X_{10_1}) of the space 1 of the scene viewed from the viewpoint based on the default viewpoint information (θ₀, φ₀) in the time information T₁₀.

Similarly, the client terminal 3620 executes the trained space 2 reconstruction model F_{θ10} based on the default viewpoint information (θ₀, φ₀). Additionally, the client terminal 3620 generates a view image (for example, a view image X_{10_2}) of the space 2 of the scene viewed from the viewpoint based on the default viewpoint information (θ₀, φ₀) in the time information T₁₀.

Further, the client terminal 3620 plays back a free-viewpoint moving image using the generated view image X_{10_1} and view image X_{10_2} as frame images.

### (2) Specific Example 2 of Processing by the Selection Unit

As described above, it is assumed that the following models are transmitted, as the trained reconstruction models for the time information T₃ included in the request to the time information T₁₀ corresponding to the termination condition, to the client terminal 3620:
the trained space 1 reconstruction model F_{θ3} to the trained space 1 reconstruction model F_{θ10}; and
the trained space 2 reconstruction model F_{θ3} to the trained space 2 reconstruction model F_{θ10}.
   Additionally, with this, it is assumed that the client terminal 3620 plays back a free-viewpoint moving image using the view images X_{3_1} to X_{10_1} and the view images X_{3_2} to X_{10_2} as frame images. Further, accompanying this, it is assumed that the request including the time information and the space information is transmitted from the client terminal 3620, and the viewpoint information is input by the user 440 in the client terminal 3620. In this case, the request receiving unit 3702 receives the request and notifies the selection unit 3703 of the request.

Here, a specific example of the processing performed by the selection unit 3703 when the request receiving unit 3702 notifies the request (the time information and the space information) will be described. FIG. 54B is a second diagram illustrating a specific example of the processing performed by the server device according to the tenth embodiment, and illustrates a specific example of the processing performed by the selection unit 3703 when the request receiving unit 3702 notifies the request.

As illustrated in FIG. 54B, the selection unit 3703 identifies the trained space 1 reconstruction model F_{θ1} corresponding to the time information (in the example of FIG. 54B, T₁) and the space information (in the example of FIG. 54B, space 1) included in the request among the trained reconstruction models that have already been read.

Additionally, the selection unit 3703 notifies the model transmitting unit 3704 of the identified trained space 1 reconstruction model F_{θ1}. With this, the model transmitting unit 3704 transmits the notified trained space 1 reconstruction model F_{θ1} to the client terminal 3620. As a result, the client terminal 3620 executes the trained space 1 reconstruction model F_{θ1} based on the viewpoint information (θₓ, φₓ) input by the user 440. Additionally, the client terminal 3620 generates a view image (for example, view image X_{1_1}) of the space 1 of the scene viewed from the viewpoint based on the viewpoint information (θₓ, φₓ) in the time information T₁. Further, the client terminal 3620 plays back a free-viewpoint moving image using the generated view image X_{1_1} as a frame image.

Subsequently, the selection unit 3703 identifies the trained space 1 reconstruction model F_{θ2} corresponding to the next time information (the next time point) as the next trained reconstruction model and notifies the model transmitting unit 3704. With this, the model transmitting unit 3704 transmits the notified trained space 1 reconstruction model F_{θ2} to the client terminal 3620. As a result, the client terminal 3620 executes the trained space 1 reconstruction model F_{θ2} based on the viewpoint information (θₓ, φₓ) input by the user 440. Additionally, the client terminal 3620 generates a view image (for example, a view image X_{2_1}) of the space 1 of the scene viewed from the viewpoint based on the viewpoint information (θₓ, φₓ) in the time information T₂. Further, the client terminal 3620 plays back a free-viewpoint moving image using the generated view image X_{2_1} as a frame image.

Subsequently, the selection unit 3703 identifies the trained space 1 reconstruction model F_{θ3} corresponding to the next time information (the next time point) as the next trained reconstruction model. Here, the trained space 1 reconstruction model F_{θ3} has already been transmitted to the client terminal 3620. Therefore, the selection unit 3703 does not notify the model transmitting unit 3704 of the trained space 1 reconstruction model F_{θ3}, and the trained space 1 reconstruction model F_{θ3} is not transmitted to the client terminal 3620.

Hereinafter, the selection unit 3703 repeats substantially the same processing until an end condition is transmitted from the client terminal 3620. The example of FIG. 54B indicates a state in which the time information T₁₁ is transmitted as the end condition from the client terminal 3620.

When the time information T₁₁ is transmitted as the end condition from the client terminal 3620, the selection unit 3703 identifies, as the last trained reconstruction model, the trained space 1 reconstruction model F_{θ11} corresponding to the time information T₁₁ transmitted as the end condition, and notifies the model transmitting unit 3704. With this, the model transmitting unit 3704 transmits the notified trained space 1 reconstruction model F_{θ11} to the client terminal 3620. As a result, the client terminal 3620 executes the trained space 1 reconstruction model F_{θ11} based on the viewpoint information (θₓ, φₓ) input by the user 440. Additionally, the client terminal 3620 generates a view image (for example, view image X_{11_1}) of the scene viewed from the viewpoint based on the viewpoint information (θₓ, φₓ) in the time information T₁₁. Further, the client terminal 3620 plays back a free-viewpoint moving image using the generated view image X_{11_1} as a frame image.

### Flow of Free-Viewpoint Moving Image Rendering Processing

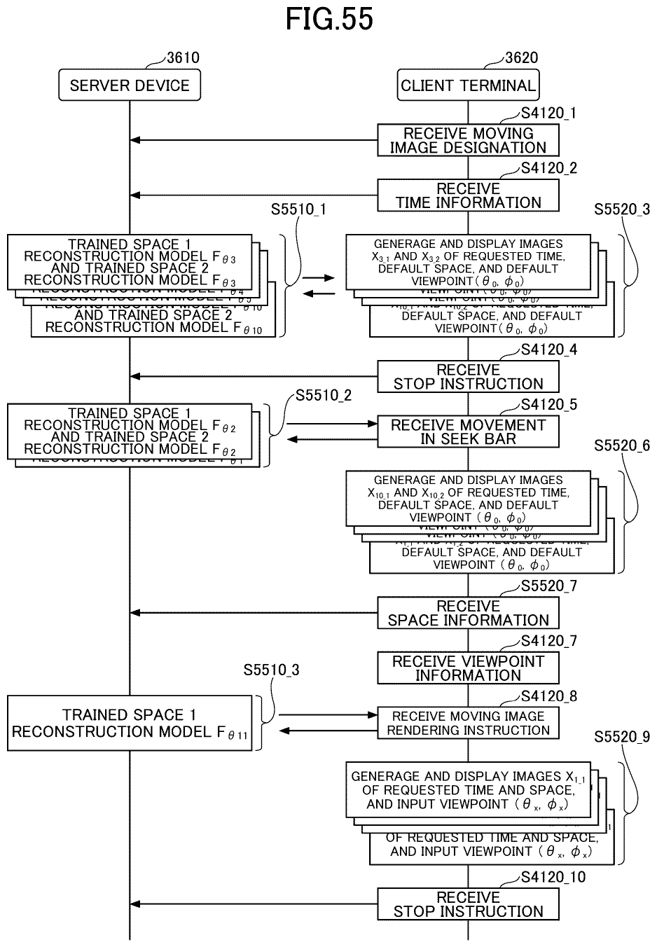

Next, a flow of a free-viewpoint moving image rendering process by the free-viewpoint moving image rendering system 3600 will be described. FIG. 55 is a seventh sequence diagram illustrating the flow of the free-viewpoint moving image rendering process by the free-viewpoint moving image rendering system.

In step S4120_1, the client terminal 3620 receives the designation of the free-viewpoint moving image to be displayed from the user 440, and transmits the identification information for uniquely identifying the designated free-viewpoint moving image to the server device 3610.

In step S4120_2, the client terminal 3620 receives the input of the time information T₃ and transmits the request including the input time information T₃ to the server device 3610.

In step S5510_1, the server device 3610 reads the group of trained space 1 reconstruction models and trained space 2 reconstruction models configured to generate the view images included in the designated free-viewpoint moving image. Additionally, the server device 3610 sequentially transmits, to the client terminal 3620, the trained space 1 reconstruction model F_{θ3} and the trained space 2 reconstruction model F_{θ3} corresponding to the time information T₃ and the default space information (the space 1 and the space 2) included in the request.

In step S5520_3, the client terminal 3620 receives the trained space 1 reconstruction model and the trained space 2 reconstruction model sequentially transmitted from the server device 3610 and inputs the default viewpoint information (θ₀, φ₀) into the received trained space 1 reconstruction model and the trained space 2 reconstruction model. With this, the client terminal 3620 sequentially generates the view images of the default space information (the space 1 and the space 2) and the default viewpoint information (θ₀, φ₀) corresponding to the time information T₃ included in the request.

In step S4120_4, the client terminal 3620 receives the stop instruction and transmits the received stop instruction to the server device 3610. With this, the server device 3610 stops the transmission of the trained reconstruction model after transmitting the trained space 1 reconstruction model F_{θ10} and the trained space 2 reconstruction model F_{θ10} to the client terminal 3620. As a result, the client terminal 3620 can play back the free-viewpoint moving image using the following images as frame images, as the view images according to the time information T_{3,} the default space information (the space 1 and the space 2), and the viewpoint information (θ₀, φ₀) included in the request:
the view images X_{3_1} to X_{10_1}; and
the view images X_{3_2} to X_{10_2}.

In step S4120_5, the client terminal 3620 receives the movement instruction of the indicator 1112′ in the seek bar 1112. The client terminal 3620 sequentially transmits the time information of each position of the moving indicator 1112′ to the server device 3610.

In step S5510_2, the server device 3610 transmits the trained space 1 reconstruction model and the trained space 2 reconstruction model corresponding to the time information of each position to the client terminal 3620 every time the time information of the position of the moving indicator 1112′ is received from the client terminal 3620. At this time, the server device 3610 does not transmit the trained space 1 reconstruction model and the trained space 2 reconstruction model that have already been transmitted to the client terminal 3620, but transmits the trained space 1 reconstruction model and the trained space 2 reconstruction model that have not been transmitted to the client terminal 3620. In the example of FIG. 55, because the indicator 1112′ of the seek bar 1112 is moved to the position of the time information T₁, the server device 3610 transmits the trained space 1 reconstruction models F_{θ2} and F_{θ1} and the trained space 2 reconstruction models F_{θ2} and F_{θ1} to the client terminal 3620.

In step S5520_7, the client terminal 3620 receives input of the space information (the space 1).

In step S4120_7, the client terminal 3620 receives input of the viewpoint information (θₓ, φₓ).

In step S4120_8, when the play button 1114 is pressed, the client terminal 3620 transmits the rendering instruction to the server device 3610.

In step S5510_3, the server device 3610 sequentially transmits, to the client terminal 3620, the trained space 1 reconstruction model F_{θ1} associated with the time information T₁ and the space information (the space 1) included in the request. However, the server device 3610 does not transmit the trained reconstruction model that has already been transmitted to the client terminal 3620, but transmits the trained reconstruction model that has not been transmitted to the client terminal 3620.

In step S5520_9, the client terminal 3620 inputs the viewpoint information (θₓ, φₓ) into the trained space 1 reconstruction model sequentially transmitted from the server device 3610 or the trained space 1 reconstruction model that has already received. With this, the client terminal 3620 sequentially generates view images of the input viewpoint information (θₓ, φₓ), corresponding to the time information T₁ and the space information (the space 1) included in the request.

In step S4120_10, the client terminal 3620 receives the stop instruction and transmits the received stop instruction to the server device 3610. With this, the server device 3610 stops transmitting the trained space 1 reconstruction model F_{θ11} after transmitting it to the client terminal 3620. As a result, the client terminal 3620 renders a free-viewpoint moving image using, as frame images, the view images X_{1_1} to X_{11_1} of the input viewpoint information (θₓ, φₓ), corresponding to the time information T₁ and the space information (the space 1) included in the request.

### Summary

As is apparent from the above description, the server device 3610 according to the tenth embodiment includes one or more memories and one or more processors. The one or more memories hold the trained space 1 reconstruction models or trained space 2 reconstruction models for the time series of the first time interval (first reconstruction models) configured to generate the view images of the time series of the first time interval for the specific space.

Additionally, the one or more processors included in the server device 3610 according to the tenth embodiment transmit the trained space 1 reconstruction models or trained space 2 reconstruction models for the time series of the first time interval (first reconstruction models) from the trained space 1 reconstruction model or the trained space 2 reconstruction model (the first reconstruction model) corresponding to the time information included in the request to the trained space 1 reconstruction model or the trained space 2 reconstruction model (the first reconstruction model) corresponding to the predetermined end condition in a transmission format that can be executed by the client terminal 3620. The trained space 1 reconstruction models or trained space 2 reconstruction models for the time series of the first time interval (first reconstruction models) are trained reconstruction models corresponding to the space information included in the request.

As described above, according to the tenth embodiment, a mechanism for rendering a free-viewpoint moving image with respect to a specific space can be constructed.

### Eleventh Embodiment

In the above first to fifth embodiments, when the free-viewpoint moving image is rendered by the client terminal 420, the server device 410 is configured to generate a view image in real time. However, the generation timing of the view image by the server device 410 is not limited to this. For example, while the client terminal 420 is rendering the free-viewpoint moving image, the server device 410 may be configured to generate, in advance, the view image corresponding to the time information ahead of the current time information.

Additionally, the first to fifth embodiments described above are configured to generate the view image corresponding to the position of the indicator or the position of the mouse pointer when the moving image display area is dragged:
in the middle of moving the indicator of the seek bar in the client terminal 420; or
in the middle of dragging the moving image display area by the mouse pointer.
   However, the generation timing of the view image by the server device 410 is not limited to this. For example, the position of the moving destination may be predicted according to the moving direction of the indicator or the moving direction of the dragged moving image display area in the client terminal 420, and the view image corresponding to the predicted position may be generated in advance.

Similarly, in the sixth to tenth embodiments, the server device 3610 is configured to transmit the trained reconstruction model in real time when the client terminal 3620 renders the free-viewpoint moving image. However, the transmission timing of the trained reconstruction model by the server device 3610 is not limited to this. For example, while the client terminal 3620 renders the free-viewpoint moving image, the server device 3610 may be configured to transmit in advance the trained reconstruction model corresponding to time information ahead of the current time information. Alternatively, the server device may be configured to transmit the trained reconstruction model corresponding to time information before and after the requested time information.

Additionally, in the sixth to tenth embodiments, while the indicator of the seek bar is being moved in the client terminal 3620, the trained reconstruction model corresponding to the position of the indicator is transmitted. However, the transmission timing of the trained reconstruction model by the server device 3610 is not limited to this. For example, according to the moving direction of the indicator in the client terminal 3620, the position of the moving destination may be predicted, and the trained reconstruction model corresponding to the predicted position may be transmitted in advance.

Additionally, in the first to tenth embodiments, the view image from the certain viewpoint is generated by performing the volume rendering process on the combination of color and opacity output from the reconstruction model. However, the method of generating the view image is not limited to this. For example, a feature image may be generated by performing a volume rendering process on a feature vector output from a reconstruction model, and an RGB image may be generated from the generated feature image by using a multilayer perceptron (MLP), a convolutional neural network (CNN), or the like to serve as the view image.

Additionally, in the fifth embodiment, the three-dimensional scene 140 is captured from the same viewpoint using two imaging devices, and the three-dimensional scene 140 is divided into two spaces to generate the trained reconstruction model configured to generate the view image in each of the spaces. However, the method of dividing the space is not limited to this. For example, the space may be divided into a background region and a region excluding the background region, and a trained reconstruction model configured to generate a view image in the background region and a trained reconstruction model configured to generate a view image in the region excluding the background region may be generated.

Additionally, the fifth embodiment is illustrated as a modification of the first embodiment, but may be a modification of any of the second to fourth embodiments. Similarly, the tenth embodiment is illustrated as a modification of the sixth embodiment, but may be a modification of any of the seventh to ninth embodiments.

Additionally, in the above embodiments, the system using the reconstruction model previously trained by the NeRF technique has been described. However, a system using a reconstruction model configured to generate a new viewpoint or a composite system may be used.

For example, a system using a reconstruction model previously trained by a 3D Gaussian Splatting technique may be used instead of the NeRF technique.

For example, a system using an image generation model previously trained by an Image-Based Rendering technique or a Transformer technique that does not explicitly reconstruct a three-dimensional scene may be used.

### Other Embodiments

In the present specification (including the claims), if the expression “at least one of a, b, and c” or “at least one of a, b, or c” is used (including similar expressions), any one of a, b, c, a-b, a-c, b-c, or a-b-c is included. Multiple instances may also be included in any of the elements, such as a-a, a-b-b, and a-a-b-b-c-c. Further, the addition of another element other than the listed elements (i.e., a, b, and c), such as adding d as a-b-c-d, is included.

In the present specification (including the claims), if the expression such as “in response to data being input”, “based on data”, “according to data”, or “in accordance with data” (including similar expressions) is used, unless otherwise noted, a case in which the various data itself is used as input and a case in which data obtained by processing the various data (e.g., data obtained by adding noise, normalized data, and intermediate representation of the various data) is used are included. If it is described that any result can be obtained “based on data”, “according to data”, or “in accordance with data”, a case in which the result is obtained based on only the data is included, and a case in which the result is obtained affected by another data other than the data, factors, conditions, states, and/or the like may be included. If it is described that “data is output”, unless otherwise noted, a case in which the various data itself is used as an output is included, and a case in which data obtained by processing the various data in some way (e.g., data obtained by adding noise, normalized data, a feature amount extracted from the data, and intermediate representation of the data) is used as an output is included.

In the present specification (including the claims), if the terms “connected” and “coupled” are used, the terms are intended as non-limiting terms that include any of directly, indirectly, electrically, communicatively, operatively, and physically connected/coupled. Such terms should be interpreted according to a context in which the terms are used, but a connected/coupled form that is not intentionally or naturally excluded should be interpreted as being included in the terms without being limited.

In the present specification (including the claims), if the expression “A configured to B” is used, a case in which a physical structure of the element A has a configuration that can perform the operation B, and a permanent or temporary setting/configuration of the element A is configured/set to actually perform the operation B may be included. For example, if the element A is a general purpose processor, the processor may have a hardware configuration that can perform the operation B and be configured to actually perform the operation B by setting a permanent or temporary program (i.e., an instruction). If the element A is a dedicated processor or a dedicated arithmetic circuit, a circuit structure of the processor may be implemented so as to actually perform the operation B irrespective of whether the control instruction and the data are actually attached.

In the present specification (including the claims), if a term indicating inclusion or possession (e.g., “comprising”, “including”, or “having”) is used, the term is intended as an open-ended term, including inclusion or possession of an object other than a target object indicated by the object of the term. If the object of the term indicating inclusion or possession is an expression that does not specify a quantity or that suggests a singular number (i.e., an expression using “a” or “an” as an article), the expression should be interpreted as being not limited to a specified number.

In the present specification (including the claims), even if an expression such as “one or more” or “at least one” is used in a certain description, and an expression that does not specify a quantity or that suggests a singular number (i.e., an expression using “a” or “an” as an article) is used in another description, it is not intended that the latter expression indicates “one”. Generally, an expression that does not specify a quantity or that suggests a singular number (i.e., an expression using “a” or “an” as an article) should be interpreted as being not necessarily limited to a particular number.

In the present specification, if it is described that a particular advantage/result is obtained in a particular configuration included in an embodiment, unless there is a particular reason, it should be understood that that the advantage/result may be obtained in another embodiment or other embodiments including the configuration. It should be understood, however, that the presence or absence of the advantage/result generally depends on various factors, conditions, states, and/or the like, and that the advantage/result is not necessarily obtained by the configuration. The advantage/result is merely an advantage/result that is obtained by the configuration described in the embodiment when various factors, conditions, states, and/or the like are satisfied, and is not necessarily obtained in the invention according to the claim that defines the configuration or a similar configuration.

In the present specification (including the claims), if multiple hardware performs predetermined processes, each of the hardware may cooperate to perform the predetermined processes, or some of the hardware may perform all of the predetermined processes. Additionally, some of the hardware may perform some of the predetermined processes while other hardware may perform the remainder of the predetermined processes. In the present specification (including the claims), if an expression such as “one or more hardware perform a first process and the one or more hardware perform a second process” is used, the hardware that performs the first process may be the same as or different from the hardware that performs the second process. That is, the hardware that performs the first process and the hardware that performs the second process may be included in the one or more hardware. The hardware may include an electronic circuit, a device including an electronic circuit, or the like.

In the present specification (including the claims), if multiple storage devices (memories) store data, each of the multiple storage devices (memories) may store only a portion of the data or may store an entirety of the data.

Although the embodiments of the present disclosure have been described in detail, the present disclosure is not limited to the above-described individual embodiments. Various additions, changes, substitutions, and partial deletions may be made within the scope that does not depart from the conceptual idea and purpose of the present invention derived from the contents defined in the claims and their equivalents.

For example, in all of the above-described embodiments, the numerical values used in the description are illustrated by way of example and are not limited to this. The order of operations in the embodiments is illustrated by way of example and is not limited to this.

Here, in the disclosed technique, forms described in the following Clauses can be considered.

(Clause 1) a Server Device Including:
one or more memories; and
one or more processors,
wherein the one or more memories are configured to hold one or more reconstruction models trained in advance to reconstruct a scene from a first time to a second time by using a time series of captured images from a plurality of viewpoints and configured to generate a time series of free-viewpoint images, the time series of captured images from the plurality of viewpoints being obtained by capturing the scene from each of the plurality of viewpoints continuously in time, and
wherein the one or more processors are configured to:
   receive a request including viewpoint information and time information for the scene from a client;
   generate a time series of images corresponding to the viewpoint information and the time information included in the request received from the client by using the one or more reconstruction models; and
   transmit the generated images in a transmission format that can be played back as a moving image on the client.

(Clause 2) The server device as described in Clause 1, wherein the one or more processors generate the time series of images corresponding to the viewpoint information by using one or more reconstruction models from a reconstruction model corresponding to the time information included in the request from the client to a reconstruction model corresponding to a predetermined end condition.

(Clause 3) The server device as described in Clause 2,
wherein the one or more memories hold first reconstruction models for a time series of a first time interval, the first reconstruction models being configured to generate free-viewpoint images of the time series of the first time interval, and
wherein the one or more processors generate the images of the time series of the first time interval, corresponding to the viewpoint information, by using the first reconstruction models for the time series of the first time interval from a first reconstruction model corresponding to the time information to a first reconstruction model corresponding to the predetermined end condition.

(Clause 4) The server device as described in Clause 2,
wherein the one or more memories hold second reconstruction models for a time series of a second time interval that is longer than a first time interval, the second reconstruction models being configured to generate free-viewpoint images of a time series of the first time interval,
wherein the one or more processors generate the images of the time series of the first time interval, corresponding to the viewpoint information, by using the second reconstruction models for the time series of the second time interval from a second reconstruction model corresponding to the time information to a second reconstruction model corresponding to the predetermined end condition.

(Clause 5) The server device as described in Clause 2,
wherein the one or more memories hold a third reconstruction model configured to generate free-viewpoint images of a time series of a first time interval, and
wherein the one or more processors generate the images of the time series of the first time interval, corresponding to the viewpoint information, from the time information to the predetermined end condition by using the third reconstruction model.

(Clause 6) The server device as described in Clause 1,
wherein the request includes space information, and
wherein the one or more processors generate the time series of images corresponding to the viewpoint information by using reconstruction models for a time series from a reconstruction model corresponding to the time information to a reconstruction model corresponding to the predetermined end condition, the reconstruction models corresponding to the space information.

(Clause 7) The server device as described in Clause 6, wherein a space specified by the space information is a predetermined region in the space or a region excluding a background in the space.

(Clause 8) The server device as described in any of Clauses 1 to 7, wherein the one or more processors, when a moving image is designated by the client, generate the time series of images corresponding to default viewpoint information by using reconstruction models for a time series from a reconstruction model corresponding to default time information to a reconstruction model corresponding to a predetermined end condition, the reconstruction models corresponding to the designated moving image, transmit the generated images in a transmission format that can be played back as a moving image by the client, and receive the request from the client in response to the transmission of the time series of images in the transmission format that can be played back as a moving image by the client.

(Clause 9) The server device as described in Clause 8, wherein the one or more processors generate, every time a request including time information is transmitted from the client during a stopped state, an image corresponding to the viewpoint information by using a reconstruction model corresponding to the time information included in the transmitted request, and generate, every time a request including viewpoint information is transmitted from the client during the stopped state, an image corresponding to the viewpoint information included in the transmitted request.

(Clause 10) The server device as described in Clause 9, wherein the one or more processors
start, when a request including time information based on a rendering instruction of a moving image is transmitted from the client during the stopped state, a process of generating the time series of images corresponding to the viewpoint information from a reconstruction model corresponding to the time information included in the transmitted request, and
stop, when a request including time information based on a stop instruction of the moving image is transmitted from the client rendering the moving image, a process of generating a time series of images corresponding to the viewpoint information included in the transmitted request.

(Clause 11) The server device as described in any of Clauses 1 to 10, wherein the one or more processors generate the images of the time series of a time interval corresponding to a frame period, a display mode, or both when the client renders a moving image, a communication load with the client, or a processing load when generating the time series of images.

(Clause 12) The server device as described in any of Clauses 1 to 11, wherein the one or more processors generate an image predicted based on an operation on the client by using the reconstruction model.

(Clause 13) a server device including:
one or more memories; and
one or more processors,
wherein the one or more memories are configured to hold one or more reconstruction models trained in advance to reconstruct a scene from a first time to a second time by using a time series of captured images from a plurality of viewpoints and configured to generate a time series of free-viewpoint images, the time series of captured images from the plurality of viewpoints being obtained by capturing the scene from each of the plurality of viewpoints continuously in time, and
wherein the one or more processors are configured to:
   receive a request including time information for the scene from a client; and
   transmit one or more reconstruction models corresponding to the time information included in the request received from the client in a transmission format that can be executed by the client, to cause the client to render a free-viewpoint moving image using a time series of images corresponding to the viewpoint information as frame images, the time series of images being generated by using the one or more reconstruction models.
a server device.

(Clause 14) The server device as described in Clause 13, wherein the one or more processors transmit reconstruction models for a time series from a reconstruction model corresponding to the time information included in the request from the client to a reconstruction model corresponding to a predetermined end condition in the transmission format that can be executed by the client.

(Clause 15) The server device as described in Clause 14,
wherein the one or more memories hold first reconstruction models for a time series of a first time interval, the first reconstruction models being configured to generate free-viewpoint images of the time series of the first time interval, and
wherein the one or more processors transmit the first reconstruction model for the time series of the first time interval from a first reconstruction model corresponding to the time information to a first reconstruction model corresponding to the predetermined end condition in the transmission format that can be executed by the client.

(Clause 16) The server device as described in Clause 14,
wherein the one or more memories hold second reconstruction models for a time series of a second time interval that is longer than a first time interval, the second reconstruction models being configured to generate free-viewpoint images of the time series of the first time interval, and
wherein the one or more processors transmit the second reconstruction models for the time series of the second time interval from a second reconstruction model corresponding to the time information to a second reconstruction model corresponding to the predetermined end condition in the transmission format that can be executed by the client.

(Clause 17) The server device as described in Clause 14,
wherein the one or more memories hold a third reconstruction model configured to generate free-viewpoint images of a time series of a first time interval, and
wherein the one or more processors transmit the third reconstruction model in the transmission format that can be executed by the client.

(Clause 18) The server device according as described in Clause 13,
wherein the request includes space information;
wherein the one or more processors transmit reconstruction models for a time series from a reconstruction model corresponding to the time information to a reconstruction model corresponding to the predetermined end condition in the transmission format that can be executed by the client, the reconstruction models corresponding to the space information.

(Clause 19) The server device as described in Clause 18, wherein a space specified by the space information is a predetermined region in the space or a region excluding a background in the space.

(Clause 20) The server device as described in any of Clauses 14 to 19, wherein the one or more processors transmit, every time a request including time information is transmitted from the client during a stopped state, a reconstruction model corresponding to the time information included in the transmitted request in the transmission format that can be executed by the client.

(Clause 21) The server device as described in any of Clauses 14 to 20, wherein the one or more processors transmit reconstruction models for a time series from a reconstruction model corresponding to the time information to a reconstruction model corresponding to the predetermined end condition, the reconstruction models for the time series being thinned in accordance with a frame period, a display mode, or both when the client displays a moving image and a communication load with the client, in the transmission format that can be executed by the client.

(Clause 22) The server device as described in Clause 16, wherein the one or more processors transmits, to the client, information for identifying the reconstruction model, the information including model parameters or hyperparameters of the reconstruction model.

(Clause 23) The server device as described in Clause 13, wherein the one or more processors transmit a reconstruction model predicted based on an operation performed on the client in the transmission format that can be executed by the client.

What is claimed is:

1. A server device comprising:
one or more memories; and
one or more processors,
wherein the one or more memories are configured to hold one or more reconstruction models for generating a time series of free-viewpoint images, the one or more reconstruction models having been trained in advance to reconstruct a scene from a first time to a second time by using a time series of captured images from a plurality of viewpoints, and the time series of captured images from the plurality of viewpoints being obtained by capturing the scene from each of the plurality of viewpoints continuously in time, and
wherein the one or more processors are configured to:
receive a request including viewpoint information and time information for the scene from a dedicated application or a browser;
generate, by using the one or more reconstruction models, the time series of free-viewpoint images corresponding to the viewpoint information and the time information included in the received request; and
transmit, to the dedicated application or the browser having transmitted the request, the generated time series of free-viewpoint images in a video format that is supported by the dedicated application or the browser.

2. The server device as claimed in claim 1, wherein the one or more processors generate the time series of free-viewpoint images corresponding to the viewpoint information, by using one or more reconstruction models from a reconstruction model corresponding to the time information included in the request to a reconstruction model corresponding to a predetermined end condition.

3. The server device as claimed in claim 2,
wherein the one or more memories hold first reconstruction models for a time series of a first time interval, the first reconstruction models being configured to generate free-viewpoint images of the time series of the first time interval, and
wherein the one or more processors generate the free-viewpoint images of the time series of the first time interval, corresponding to the viewpoint information, by using the first reconstruction models for the time series of the first time interval from a first reconstruction model corresponding to the time information to a first reconstruction model corresponding to the predetermined end condition.

4. The server device as claimed in claim 2,
wherein the one or more memories hold second reconstruction models for a time series of a second time interval that is longer than a first time interval, the second reconstruction models being configured to generate free-viewpoint images of a time series of the first time interval,
wherein the one or more processors generate the free-viewpoint images of the time series of the first time interval, corresponding to the viewpoint information, by using the second reconstruction models for the time series of the second time interval from a second reconstruction model corresponding to the time information to a second reconstruction model corresponding to the predetermined end condition.

5. The server device as claimed in claim 2,
wherein the one or more memories hold a third reconstruction model configured to generate free-viewpoint images of a time series of a first time interval, and
wherein the one or more processors generate the free-viewpoint images of the time series of the first time interval, corresponding to the viewpoint information, from the time information to the predetermined end condition by using the third reconstruction model.

6. The server device as claimed in claim 1,
wherein the request includes space information, and
wherein the one or more processors generate the time series of free-viewpoint images corresponding to the viewpoint information by using reconstruction models for a time series from a reconstruction model corresponding to the time information to a reconstruction model corresponding to the predetermined end condition, the reconstruction models corresponding to the space information.

7. The server device as claimed in claim 6, wherein the space information specifies a predetermined region in a space or a region excluding a background in the space.

8. The server device as claimed in claim 1, wherein the one or more processors, when a moving image is designated by the dedicated application or the browser, generate the time series of free-viewpoint images corresponding to default viewpoint information by using reconstruction models for a time series from a reconstruction model corresponding to default time information to a reconstruction model corresponding to a predetermined end condition, the reconstruction models corresponding to the designated moving image, transmit the generated time series of free-viewpoint images in a video format that is supported by the dedicated application or the browser, and receive the request from the dedicated application or the browser in response to the transmission of the time series of free-viewpoint images in the video format that is supported by the dedicated application or the browser.

9. The server device as claimed in claim 8, wherein the one or more processors generate, every time a request including time information is transmitted from the dedicated application or the browser during a stopped state, an image corresponding to the viewpoint information by using a reconstruction model corresponding to the time information included in the transmitted request, and generate, every time a request including viewpoint information is transmitted from the dedicated application or the browser during the stopped state, an image corresponding to the viewpoint information included in the transmitted request.

10. The server device as claimed in claim 9, wherein the one or more processors
start, when a request including time information based on a rendering instruction of a moving image is transmitted from the dedicated application or the browser during the stopped state, a process of generating the time series of free-viewpoint images corresponding to the viewpoint information from a reconstruction model corresponding to the time information included in the transmitted request, and
stop, when a request including time information based on a stop instruction of the moving image is transmitted from the dedicated application or the browser rendering the moving image, a process of generating a time series of free-viewpoint images corresponding to the viewpoint information included in the transmitted request.

11. The server device as claimed in claim 1, wherein the one or more processors generate the free-viewpoint images of the time series of a time interval corresponding to a frame period, a display mode, or both when the dedicated application or the browser renders a moving image, a communication load with the dedicated application or the browser, or a processing load when generating the time series of free-viewpoint images.

12. The server device as claimed in claim 1, wherein the one or more processors generate an image predicted based on an operation on the dedicated application or the browser by using the reconstruction models.

13. A client terminal configured to communicate with the server device as claimed in claim 1, the client terminal comprising:
one or more memories; and
one or more processors configured to:
receive the viewpoint information and the time information via the dedicated application or the browser;
transmit, to the server, the request including the viewpoint information and the time information for the scene; and
receive, from the server, the generated time series of free-viewpoint images in the video format that is supported by the dedicated application or the browser.

14. The client terminal as claimed in claim 13,
wherein the client terminal is different from the server device, and
wherein the dedicated application or the browser is installed in the client terminal.

15. A server device comprising:
one or more memories; and
one or more processors,
wherein the one or more memories are configured to hold one or more reconstruction models for generating a time series of free-viewpoint images, the one or more reconstruction models having been trained in advance to reconstruct a scene from a first time to a second time by using a time series of captured images from a plurality of viewpoints, and the time series of captured images from the plurality of viewpoints being obtained by capturing the scene from each of the plurality of viewpoints continuously in time, and
wherein the one or more processors are configured to:
receive a request including time information for the scene from a dedicated application or a browser; and
transmit, to the dedicated application or the browser having transmitted the request, one or more reconstruction models corresponding to the time information included in the request received from the dedicated application or the browser in a predetermined format that is supported by the dedicated application or the browser, to cause the dedicated application or the browser to render a free-viewpoint moving image using the time series of free-viewpoint images corresponding to viewpoint information as frame images, the time series of free-viewpoint images being generated by using the one or more reconstruction models.

16. The server device as claimed in claim 15, wherein the one or more processors transmit reconstruction models for a time series from a reconstruction model corresponding to the time information included in the request from the dedicated application or the browser to a reconstruction model corresponding to a predetermined end condition in the predetermined format that is supported by the dedicated application or the browser.

17. The server device as claimed in claim 16,
wherein the one or more memories hold first reconstruction models for a time series of a first time interval, the first reconstruction models being configured to generate free-viewpoint images of the time series of the first time interval, and
wherein the one or more processors transmit the first reconstruction models for the time series of the first time interval from a first reconstruction model corresponding to the time information to a first reconstruction model corresponding to the predetermined end condition in the predetermined format that is supported by the dedicated application or the browser.

18. The server device as claimed in claim 16,
wherein the one or more memories hold second reconstruction models for a time series of a second time interval that is longer than a first time interval, the second reconstruction models being configured to generate free-viewpoint images of the time series of the first time interval, and
wherein the one or more processors transmit the second reconstruction models for the time series of the second time interval from a second reconstruction model corresponding to the time information to a second reconstruction model corresponding to the predetermined end condition in the predetermined format that is supported by the dedicated application or the browser.

19. The server device as claimed in claim 16,
wherein the one or more memories hold a third reconstruction model configured to generate free-viewpoint images of a time series of a first time interval, and
wherein the one or more processors transmit the third reconstruction model in the predetermined format that is supported by the dedicated application or the browser.

20. The server device according as claimed in claim 15,
wherein the request includes space information;
wherein the one or more processors transmit reconstruction models for a time series from a reconstruction model corresponding to the time information to a reconstruction model corresponding to the predetermined end condition in the predetermined format that is supported by the dedicated application or the browser, the reconstruction models corresponding to the space information.

21. The server device as claimed in claim 20, wherein the space information specifies a predetermined region in a space or a region excluding a background in the space.

22. The server device as claimed in claim 16, wherein the one or more processors transmit, every time a request including time information is transmitted from the dedicated application or the browser during a stopped state, a reconstruction model corresponding to the time information included in the transmitted request in the predetermined format that is supported by the dedicated application or the browser.

23. The server device as claimed in claim 16, wherein the one or more processors transmit reconstruction models for a time series from a reconstruction model corresponding to the time information to a reconstruction model corresponding to the predetermined end condition, the reconstruction models for the time series being thinned in accordance with a frame period, a display mode, or both when the dedicated application or the browser displays a moving image or a communication load with the dedicated application or the browser, in the predetermined format that is supported by the dedicated application or the browser.

24. The server device as claimed in claim 18, wherein the one or more processors transmit, to the dedicated application or the browser, information for identifying the reconstruction models, the information including model parameters or hyperparameters of the reconstruction models.

25. The server device as claimed in claim 15, wherein the one or more processors transmit a reconstruction model predicted based on an operation performed on the dedicated application or the browser, in the predetermined format that is supported by the dedicated application or the browser.

26. A client terminal configured to communicate with the server device as claimed in claim 15, the client terminal comprising:
one or more memories; and
one or more processors configured to:
receive the viewpoint information and the time information via the dedicated application or the browser;
transmit, to the server, the request including the time information for the scene;
receive, from the server, one or more reconstruction models corresponding to the time information included in the request; and
generate, by using the one or more reconstruction models received from the server, the time series of free-viewpoint images corresponding to the view point information to render the free-viewpoint moving image using the time series of free-viewpoint images.

27. The client terminal as claimed in claim 26,
wherein the client terminal is different from the server device, and
wherein the dedicated application or the browser is installed in the client terminal.
